(19) United States
(12) Patent Application Publication
(10) Pub. No.: US 2017/0086467 A1
(43) Pub. Date: Mar. 30, 2017

(54) MOLLUSCICIDE COMPOSITIONS AND METHODS OF USE THEREOF

(71) Applicant: ECOFLORA AGRO SAS, Rionegro, Alto de las Palmas (CO)

(72) Inventors: Sandra ALCARAZ, Yuma, AZ (US); James Alberto JIMENEZ MARTINEZ, Medellin (CO); Juan Fernando GIL ROMERO, Medellin (CO)

(21) Appl. No.: 15/312,280

(22) PCT Filed: May 18, 2015
(86) PCT No.: PCT/US15/31416

§ 371 Date: Nov. 18, 2016

Related U.S. Application Data
(60) Provisional application No. 62/000,441, filed on May 19, 2014.

(51) Int. Cl. A01N 65/08; A01N 45/00; A01N 43/90

(52) U.S. Cl. CPC A01N 65/08; A01N 43/90; A01N 45/00

(57) ABSTRACT

The present disclosure relates to molluscicide compositions, (e.g., saponin and caffeine from a different source) that act synergistically as molluscicides. Also provided are methods comprising the disclosed molluscicide compositions to control, treat, prevent, and combinations thereof mollusk infestation.

### BACKGROUND

The present disclosure provides compositions of saponin and caffeine, from a different source, that act synergistically as molluscicides and methods for the use of such compositions to control, treat, and prevent mollusk infestation.

Some species of terrestrial mollusks, such as gastropods, snails, and slugs, are highly harmful to a large variety of crops throughout the world. Mollusks endanger prairies and fields of crops destined for human and animal consumption. Mollusks are also a problem in plant nurseries, where they damage a large variety of plants ranging from vegetable to ornamental. The group of commonly observed mollusks that are problematic e.g., in gardens, greenhouses and farmlands includes, but is not limited to Helix aspersa, Helix nemoralis, Cepaea nemoralis, Zonitoides arboreus, Theba pisana, Subolina octona, Helicella spp., Cepaea spp., Deroceras reticulatum, Deroceras leave, Umax poi\acute{η}eri, Milax gagates, Anon spp., Anion subfucus, Anion circumscriptus, Anion hortensis, Anion rufus, Anion ater, Anion lusitanicus, Umax maximus, L. flavus, Umax glavus, Umax tenellus, Agriolimax reticulatis, and Ariolimax columbianus. Mollusks cause damage during the whole season of vegetation. Sprouting or freshly planted plants, having poor growth rates, can die as a result of mollusk feedings. Mollusks are pests of all species of vegetables, berry-type plants (strawberries, wild strawberries, etc.), decorative plants and herbs. They attack almost all species of cultivable plants, e.g., rapeseed, winter wheat, vegetables and ornamental flowers. Damage caused by mollusk feedings can affect all plants organs, in particular, sprouting seeds, seedlings and fresh leaves.

Mollusk destruction can also be found in vegetable stores, which can greatly impact the price of crops poised for human or animal consumption.

Aquatic mollusks, including, but not limited to the groups Pulmonata, Basommatophona, and Sigmunethna, are also pests. Similar to terrestrial mollusks, aquatic mollusks cause great losses in agriculture and pose human health problems. The invasion of these aquatic mollusks in natural wetlands creates extreme health hazards to untreated water supplies. For example, there are several aquatic mollusks that transmit schistosomiasis, e.g., Biomphalaria ssp., which is after malaria, is the second most widespread tropical disease for humans, affecting more than 200 million people.

Additionally, the economic impact of aquatic mollusk feeding activity is comparable to that of terrestrial mollusks. For example, in rice fields aquatic mollusks reproduce extremely quickly and feed on young rice seedlings voraciously, causing significant economic loss to farmers. Further aquatic mollusk feedings in natural wetlands causes a loss of nutrients in the aquatic ecosystems resulting in dense algal blooms.

Usually, mollusk damage can be prevented by applying a molluscicide (e.g., a pesticide or a natural agent) directly to the crops and plants.

The application of molluscicides to crops and plants has several disadvantages. In the case of pesticides and molluscicides, their use is limited because of their toxicity to pets, non-target vertebrate species and the environment. See e.g., Gonzalez-Cruz, et al., Cien. Inv. Agr. 40(2):341-349 (2013) and Smith, et al., Florida Entomologist, 96(2):396-402 (2013). Accordingly, there is a need for efficient molluscicides with low toxicity.

### BRIEF SUMMARY OF THE DISCLOSURE

The present disclosure provides a molluscicide composition comprising a saponin-containing plant extract and a caffeine-containing plant extract from a different plant.

In some aspects, the saponin-containing plant extract is obtained from a Sapindaceae family plant. In some aspects, the Sapindaceae family plant is a member of the genus Sapindus. In some aspects, the member of the genus Sapindus is Sapindus saponaria.

In some aspects, the saponin-containing plant extract is obtained from tea (Camellia sinensis), lychee (Litchi chinensis), alfalfa (Medicago sativa), chickpeas (Cicer arietinum), soybeans (Glycine max), beans (Phaseolus vulgaris), quinoa (Chenopodium quinoa), alfombrilla (Drymaria arenaroides), Christmas rose (Helleborus niger), Horse Chestnut trees (Aesculus hippocastanum), Asparagus fern (Asparagus officinalis), licorice root (Glycyrrhiza leguminosae), soapberry (Shepherdia canadensis), soap nut (Sapindus mokorossi), Daisies (Bellis perennis), fique (Furcraea andina), agave (Agave sp.), Mojave yucca (Yucca schidigera), Quillay (Quillaja saponaria), Campions (Silene spp.), Ragged Robin (Lychnis flos-cuculi), Bracken (Pteridium aquilinum), Soap Lily (Chlorogalum pomeridianum), Ceanothus cuneatus, Yucca baccata, Yucca filamentosa, Yucca glauca, Yucca gloriosa, Yucca whipplei, Philadelphus lewisii, wild yam (Dioscorea villosa), Panax ginseng, Glycyrrhiza uralensis, or a combination thereof.

In some aspects, the saponin-containing plant extract comprises saponins and free sugars. In some aspects, the saponin-containing plant extract comprises hederagenin-derived saponins. In some aspects, the saponin-containing plant extract is obtained using a water-alcohol extraction method.

In some aspects, the saponin percentage of the dry weight of the saponin-containing plant extract is at least 10%. In some aspects, the saponin percentage of the dry weight of the saponin-containing plant extract is at least 20%. In some aspects, the saponin percentage of the dry weight of the saponin-containing plant extract is about 25%.

In some aspects, the caffeine-containing plant extract is obtained from a coffee bean plant, a tea plant, a verba mate plant, a cacao plant, a kola nut plant, a guarana plant, a guayusa plant, a yaupon holly plant, or a combination thereof. In some aspects, the coffee bean plant is a member of the genus Coffea. In some aspects, the member of the genus Coffea is from the species Coffea arabica. In some aspects, the member of the genus Coffea is from the species Coffea canephora.

In some aspects, the caffeine-containing plant extract is obtained using a liquid-liquid extraction method. In some aspects, the liquid-liquid extraction method comprises ethyl acetate.

In some aspects, the caffeine-containing plant extract is at least about 80% pure.

In some aspects, the caffeine-containing plant is at least about 90% pure. In some aspects, the caffeine-containing plant is about 97% pure.

In some aspects, the saponin-containing plant extract and the caffeine-containing plant extract are in solid form. In some aspects, the solid form comprises powder, pellet or granule formulations. In some aspects, the powder, pellet or granule formulations are dispersible. In some aspects, the powder, pellet or granule formulations are water-dispersible. In some aspects, the solid form comprises powder, dry flowable, bait, dust, nanoencapsulated, or microencapsulated formulations. In some aspects, the powder formulations are wettable powder formulations.

In some aspects, the saponin-containing plant extract and the caffeine-containing plant extract are in liquid form. In some aspects, the liquid form comprises liquid concentrate, emulsifiable concentrate, emulsion, suspension, liquid flowable, gel, ready-to-use, or aerosol formulations. In some aspects, the liquid concentrate comprises ultra-low-volume concentrate formulation.

In some aspects, the molluscicide composition has a concentration between about 0.1 grams/liter to about 15 grams/liter of saponin-containing plant extract and a concentration between about 0.1 grams/liter to about 15 grams/liter of caffeine-containing plant extract. In some aspects, the molluscicide composition has a concentration between about 2 grams/liter to about 12 grams/liter of saponin-containing plant extract and a concentration between about 2 grams/liter to about 12 grams/liter of caffeine-containing plant extract. In some aspects, the molluscicide composition has a concentration between about 3 grams/liter to about 10 grams/liter of saponin-containing plant extract and a concentration between about 3 grams/liter to about 10 grams/liter of caffeine-containing plant extract. In some aspects, the molluscicide composition has a concentration of about 7 grams/liter of saponin-containing plant extract and a concentration of about 7 grams/liter of caffeine-containing plant extract.

In some aspects, the molluscicide composition further comprises a carrier. In some aspects, the carrier is a neutral carrier edible for mollusks. In some aspects, the neutral carrier edible for mollusks is a composition of substances of vegetable origin and/or animal origin. In some aspects, the neutral carrier comprises a mixture of dried vegetables, porky greaves, osseous meal, sugar, molasses, egg powder, plant grains, or any combination thereof. In some aspects, the plant grains comprise wheaten bruised grain, whole grain, corn bruised grain, or any combination thereof. In some aspects, the carrier further comprises a dye, a pigment, a safety additive agent, an attractant, an agent improving rain-resistance, or any combination thereof.

In some aspects, the molluscicide composition comprises (A) a saponin-containing plant extract and (B) a caffeine-containing plant extract in a weight ratio of (A):(B) between 20:1 to 1:20. In some aspects, the molluscicide composition comprises (A) a saponin-containing plant extract and (B) a caffeine-containing plant extract in a weight ratio of (A):(B) between 15:1 to 1:15. In some aspects, the molluscicide composition comprises (A) a saponin-containing plant extract and (B) a caffeine-containing plant extract in a weight ratio of (A):(B) about 1:14.

The present disclosure provides an article of manufacture comprising a saponin-containing plant extract and a caffeine-containing plant extract of the molluscicide compositions disclosed herein and packaging material.

The present disclosure provides a method for controlling mollusk damage to plants, comprising treating plants or the locus surrounding the plants with a molluscicidally effective amount of the molluscicide compositions disclosed herein.

The present disclosure provides a method for controlling gastropods, comprising exposing the gastropods to a composition comprising a molluscicidally effective amount of the molluscicide compositions disclosed herein.

In some aspects, the gastropods are from the subclass Pulmonata. In some aspects the gastropods are selected from the group consisting of Helix spp., Agriolimax spp., Limax spp., Milax spp., Anion spp., Pomacea spp., or Deroceras spp.

The present disclosure provides a method for preventing mollusk infestation, comprising treating plants or the locus surrounding the plants with a molluscicidally effective amount of the molluscicide compositions disclosed herein.

The present disclosure provides a method to treat a surface with a molluscicidally effective amount of the molluscicide compositions disclosed herein to prevent mollusk infestation. In some aspects, the surface is in an agricultural, a horticultural, a garden or an aquatic environment.

In some aspects, the molluscicide composition used in the methods disclosed herein further comprises a dose regimen. In some aspects, the dose regimen comprises at least one daily dose. In some aspects, the dose regimen comprises at least one weekly dose. In some aspects, the dose regimen comprises at least one monthly dose.

In some aspects, the concentration of the molluscicide composition used in the methods disclosed herein is between about 0.1 grams/liter to about 15 grams/liter of saponin-containing plant extract and a concentration between about 0.1 grams/liter to about 15 grams/liter of caffeine-containing plant extract. In some aspects, the concentration of the molluscicide composition used in the methods disclosed herein is between about 2 grams/liter to about 12 grams/liter of saponin-containing plant extract and a concentration between about 2 grams/liter to about 12 grams/liter of caffeine-containing plant extract. In some aspects, the concentration of the molluscicide composition used in the methods disclosed herein is between about 3 grams/liter to about 10 grams/liter of saponin-containing plant extract and a concentration between about 3 grams/liter to about 10 grams/liter of caffeine-containing plant extract. In some aspects, the concentration of the molluscicide composition used in the methods disclosed herein is about 7 grams/liter of saponin-containing plant extract and a concentration is about 7 grams/liter of caffeine-containing plant extract.

In some aspects, the weight ratio of the molluscicide composition used in the methods disclosed herein comprises (A) a saponin-containing plant extract and (B) a caffeine-containing plant extract in a weight ratio of (A):(B) between 20:1 to 1:20. In some aspects, the weight ratio of the molluscicide composition used in the methods disclosed herein comprises (A) a saponin-containing plant extract and (B) a caffeine-containing plant extract in a weight ratio of (A):(B) between 15:1 to 1:15. In some aspects, the weight ratio of the molluscicide composition used in the methods disclosed herein comprises (A) a saponin-containing plant extract and (B) a caffeine-containing plant extract in a weight ratio of (A):(B) about 1:14.

### BRIEF DESCRIPTION OF THE DRAWINGS/FIGURES

FIG. 1 is a photograph of a test container used to evaluate molluscicide compounds. The container has a 1 L volume capacity and contains 400 mL of a single molluscicide compound.

FIG. 2A shows a graph of the percent mollusk mortality for caffeine extract alone at concentrations of 0.087 mg/mL, 0.218 mg/mL, 0.273 mg/mL, 0.328 mg/mL, 0.437 mg/mL, and 0.874 mg/mL.

FIG. 2B shows a graph of the percent mollusk mortality for Sapindus saponaria extract at concentrations of 0.01 mg/mL, 0.02 mg/mL, 0.03 mg/mL, 0.04 mg/mL, and 0.05 mg/mL.

FIG. 3 shows a graph depicting the percent mollusk mortality for three different compounds, compound A, compound B, and compound C, against Control (caffeine extract formulation) five days after forced ingestion. Compound A contained 33.0% caffeine extract, 61.2% calcium lignosulphonate, 3.0% carboxymethyl cellulose, 2.0% sodium chloride and 0.5% Sapindus saponaria extract. Compound B contained 32.5% caffeine extract, 59.8% calcium lignosulphonate, 2.9% carboxymethyl cellulose, 2.4% sodium chloride and 2.3% Sapindus saponaria extract. Compound C contained 32.5% caffeine extract, 59.8% calcium lignosulphonate, 2.9% carboxymethyl cellulose, 0.0% sodium chloride and 4.8% Sapindus saponaria extract. Control (caffeine extract formulation) contained 33.0% caffeine extract, 61.2% calcium lignosulphonate, 3.0% carboxymethyl cellulose, 2.5% sodium chloride and no Sapindus saponaria extract. Each compound was independently administered to the mollusks by forced ingestion at concentrations of 12.5 g/L, 6.25 g/L, 3.125 g/L, 1.56 g/L, and 0.78 g/L (compound B only).

FIG. 4A shows the percentage of mollusk feeding damage five days after forced ingestion of caffeine extract formulation at concentrations of 12.5 g/L, 9.375 g/L, 6.25 g/L, 3.125 g/L, 2.34 g/L, and 1.56 g/L.

FIG. 4B shows the percentage of mollusk feeding damage five days after forced ingestion of compound A at concentrations of 12.5 g/L, 6.25 g/L, 3.125 g/L, 1.56 g/L, and 0.78 g/L.

FIG. 4C shows the percentage of mollusk feeding damage five days after forced ingestion of compound B at concentrations of 12.5 g/L, 9.375 g/L, 6.25 g/L, 3.125 g/L, 2.34 g/L, and 1.56 g/L.

FIG. 4D shows the percentage of mollusk feeding damage five days following forced ingestion of compound C at concentrations of 12.5 g/L, 6.25 g/L, 3.125 g/L, and 1.56 g/L.

FIG. 5A shows the calculated variance between caffeine extract alone, and compounds B and C and caffeine extract formulation, undertaken at the 95% confidence interval.

FIG. 5B shows the calculated variance between compound A, and compounds B and C and caffeine extract alone, undertaken at the 95% confidence interval.

FIG. 5C shows the calculated variance between compound B, and compounds A and C and caffeine extract alone, undertaken at the 95% confidence interval.

FIG. 5D shows the calculated variance between compound C, and compounds A and B and caffeine extract alone, undertaken at the 95% confidence interval.

FIG. 6 is a photograph of a test container containing 200 mL of compound A at 6.25 g/L, 12.5 g/L, 25 g/L, and 40 g/L.

FIG. 7 is a photograph of the aquatic environment test containers and the aeration apparatus used to determine the toxicity of compound A on aquatic mollusks.

FIG. 8A is a photograph of the clean water containers the aquatic mollusks were transferred to following a 24 hour exposure to compound A.

FIG. 8B is a photograph of the clean water containers, aeration tubing and pump the aquatic mollusks were transferred to following a 48 hours exposure to compound A.

FIG. 9A is a photograph of affected aquatic mollusks floating on the surface of the aquatic environment test container.

FIG. 9B is a photograph of an affected mollusk with a sagging operculum.

FIG. 9C is a photograph of the discolored water in the clean water container due to the discharge of compound A from the aquatic mollusks 72 hours after exposure to compound A.

FIG. 10 shows HPLC traces of control caffeine (A) and purified caffeine (B).

FIG. 11 shows an NMR spectrum of purified caffeine extract, indicating the peaks corresponding to caffeine and the peaks corresponding to contaminants. Experimental conditions are shown on the table above the spectrum.

FIG. 12 shows HPLC traces indicating the presence of caffeine, caffeic acid and protocatechuic acid in the caffeine extracts.

FIG. 13 shows TLC separation of saponins from Sapindus saponaria extract (SS), and HPLC fractions enriched in saponins SP1, SP2 and SP3 (panel A). Panel shows the development of the TLC plate in panel using vanillin reagent.

FIG. 14 shows an ¹H spectrum corresponding to the SP1 fraction from Sapindus saponaria extract. The structure of SP1 is shown. Experimental conditions are shown on the table above the spectrum.

FIG. 15 shows a ¹³C spectrum corresponding to the SP1 fraction from Sapindus saponaria extract. The structure of SP1 is shown. Experimental conditions are shown on the table above the spectrum.

FIG. 16 shows the chemical structures of saponins SP2 and SP3.

FIG. 17 shows HPLC calibration curves for SP1 (A), SP2 (B) and SP3 (C).

FIG. 18 shows an HPLC chromatogram showing the location of the peaks corresponding to SP1, SP2, and SP3.

FIG. 19 shows an HPLC chromatogram showing the location of the peaks corresponding to the major saponins presents in Sapindus saponaria extracts as well as their chemical structures.

FIG. 20 shows mortality rates for banana tree snails (African snails) treated with Compound A (composition comprising Sapindus saponaria extract and caffeine). The effect of Compound A was compared to that BROMOREX® and metaldehyde. No molluscicide was present in the control samples.

FIG. 21 shows percentage of dead and affected after application of two compositions comprising Sapindus saponaria extract and caffeine (Compound A and Compound B). METAREX® (chemical molluscicide) was used as a control molluscicide. No molluscicide was present in the control samples.

FIG. 22 shows percentage of feeding damage to leaf disks (lettuce) following exposure of D. reticulatum to test pellets comprising two compositions comprising Sapindus saponaria extract and caffeine (Compound A and Compound B). METAREX® (chemical molluscicide) was used as a control molluscicide. No molluscicide was present in the control samples.

FIG. 23 shows percentage of damaged plants (lettuce) per plot after treatment with Compound A. SLUGCLEAR® liquid metaldehyde was used as a control molluscicide. No molluscicide was present in the control samples.

FIG. 24 shows percentage of feeding damage per plant (lettuce) per plot after treatment with Compound A. SLUGCLEAR® liquid metaldehyde was used as a control molluscicide. No molluscicide was present in the control samples.

FIG. 25 shows relative toxicity of Compound A against Pomacea spp. as number of affected/dead snails. SLUGCLEAR® liquid metaldehyde was used as a control molluscicide. No molluscicide was present in the control samples.

FIG. 26 shows average pest incidence per treatment (indicated by number of buds damaged) after applying Compound A to Alstromeria plants (3 applications) as dry powder, wettable powder foliar treatment, and wettable powder drench treatment. Metaldehyde was used as a control molluscicide. No molluscicide was present in the control samples (UTC=untreated control).

FIG. 27 shows average pest incidence per treatment (indicated by number of buds damaged) after applying Compound A to Alstromeria plants (3 applications) as wettable powder foliar treatment, and wettable powder drench treatment. Metaldehyde was used as a control molluscicide. No molluscicide was present in the control samples (UTC=untreated control).

FIG. 28 shows average number of dead slugs after lettuce seedlings were treated with Compound A (3 applications) via foliar application with dry powder, drench application with wettable power, and foliar application with wettable powder. Metaldehyde was used as a control molluscicide. No molluscicide was present in the control samples (UTC=untreated control).

FIG. 29 shows percentage of damage per plant after lettuce seedlings were treated with Compound A (3 applications) via foliar application with dry powder, drench application with wettable power, and foliar application with wettable powder. Metaldehyde was used as a control molluscicide. No molluscicide was present in the control samples (UTC=untreated control).

### DETAILED DESCRIPTION

The present disclosure is directed to molluscicide compositions, methods of making and methods of use of such molluscicide compositions, and articles of manufacture and kits comprising such molluscicide compositions. In order to provide a clear understanding of the specification and claims, the following definitions are provided below.

### 1. DEFINITIONS

As used herein, the singular terms “a,” “an” and “the” include plural referents unless the context clearly dictates otherwise. The terms “a” (or “an”), as well as the terms “one or more,” and “at least one” can be used interchangeably herein.

Furthermore, “and/or” where used herein is to be taken as specific disclosure of each of the two specified features or components with or without the other. Thus, the term “and/or” as used in a phrase such as “A and/or B” herein is intended to include “A and B,” “A or B,” “A” (alone), and “B” (alone). Likewise, the term “and/or” as used in a phrase such as “A, B, and/or C” is intended to encompass each of the following aspects: A, B, and C; A, B, or C; A or C; A or B; B or C; A and C; A and B; B and C; A (alone); B (alone); and C (alone).

As used herein, the term “comprising” means including, made up of, and composed of. Wherever aspects are described herein with the language “comprising,” otherwise analogous aspects described in terms of “consisting of” and/or “consisting essentially of” are also provided

All numbers in this description indicating amounts, ratios of materials, physical properties of materials, and/or use are to be understood as modified by the word “about,” except as otherwise explicitly indicated.

The term “about” as used in connection with a numerical value throughout the specification and the claims denotes an interval of accuracy, familiar and acceptable to a person skilled in the art. In general, such interval of accuracy is ±10%. Thus, “about ten” means 9 to 11.

Unless defined otherwise, all technical and scientific terms used herein have the same meaning as commonly understood by one of ordinary skill in the art to which this disclosure is related. For example, the Concise Dictionary of Biomedicine and Molecular Biology, Juo, Pei-Show, 2nd ed., 2002, CRC Press; The Dictionary of Cell and Molecular Biology, 3rd ed., 1999, Academic Press; and the Oxford Dictionary Of Biochemistry And Molecular Biology, Revised, 2000, Oxford University Press, provide one of skill with a general dictionary of many of the terms used in this disclosure.

Units, prefixes, and symbols are denoted in their Système International de Unites (SI) accepted form. Numeric ranges are inclusive of the numbers defining the range. Unless otherwise indicated, amino acid sequences are written left to right in amino to carboxy orientation. The headings provided herein are not limitations of the various aspects or aspects of the disclosure, which can be had by reference to the specification as a whole. Accordingly, the terms defined immediately below are more fully defined by reference to the specification in its entirety.

The term “plant” as used herein refers to a living organism exemplified by, for example, trees, shrubs, grasses, ferns, flowering plant, vegetables, legumes, grains, algae. In some aspects, the plant is, for example, a vegetable, a legume, a grain, or a flowering plant. The term plant encompasses any part of a plant, for example fruits, leaves, stems, branches, bark, roots, shoots, seeds, flowers, The term “plant” as used herein encompasses whole plants, ancestors and progeny of the plants and plant parts, including seeds, shoots, stems, leaves, roots (including tubers), fruits, stalk, seedlings, tubers, flowers, and tissues and organs. The term “plant” also encompasses plant cells, suspension cultures, callus tissue, embryos, meristematic regions, gametophytes, sporophytes, pollen, and microspores.

The phrase “saponin-containing plant” as used herein refers to plants, for example, a plant that naturally contains saponins (e.g., Sapindus saponaria). In some aspects, the saponin-containing plant is for example, tea (Camellia sinensis), lychee (Litchi chinensis), alfalfa (Medicago sativa), chickpeas (Cicer arietinum), soybeans (Glycine max), beans (Phaseolus vulgaris), quinoa (Chenopodium quinoa), alfombrilla (Drymaria arenaroides), Christmas rose (Helleborus niger), horse chestnut trees (Aesculus hippocastanum), asparagus fern (Asparagus officinalis), licorice root (Glycyrrhiza leguminosae), soapberry (Shepherdia canadensis), soap nut (Sapindus mokorossi), Daisies (Bellis perennis), fique (Furcraea andina), agave (Agave sp.), Mojave yucca (Yucca schidigera), Quillay (Quillaja saponaria), Campions (Silene spp.), Ragged Robin (Lychnis flos-cuculi), Bracken (Pteridium aquilinum), Soap Lily (Chlorogalum pomeridianum), Ceanothus cuneatus, Yucca baccata, Yucca filamentosa, Yucca glauca, Yucca gloriosa, Yucca whipplei, Philadelphus lewisii, wild yam (Dioscorea villosa), Panax ginseng, Glycyrrhiza uralensis or combinations thereof. In some aspects, the saponin-containing plant is, for example, a Sapindaceae family plant. In some aspects, the Sapindaceae family plant is a member of the genus Sapindus. In some aspects, the member of the genus Sapindus include, for example, the species Sapindus delavayi, Sapindus detergens, Sapindus emarginatus, Sapindus laurifolius, Sapindus marginatus, Sapindus mukorossi, Sapindus oahuensis, Sapindus rarak, Sapindus saponaria, Sapindus tomentosus, Sapindus trifoliatus, and Sapindus vitiensis. In some aspects, the member of the genus Sapindus is Sapindus saponaria.

The phrase “caffeine-containing plant” as used herein refers to plants, e.g., a coffee bean plant that naturally contains caffeine. In some aspects, the caffeine-containing plant is, for example, a coffee bean plant. In some aspects, the coffee bean plant is a member of the genus Coffea. In some aspects, the member of the genus Coffea includes, for example, the species Coffea abbayesii, Coffea affinis, Coffea alleizettii, Coffea ambanjensis, Coffea ambongenis, Coffea andrambovatensis, Coffea ankaranensis, Coffea anthonyi, Coffea arabica, Coffea arenesiana, Coffea augagneurii, Coffea bakossii, Coffea benghalensis, Coffea bertrandii, Coffea betamponensis, Coffea bissetiae, Coffea boinensis, Coffea boiviniana, Coffea boiviniana, Coffea brassii, Coffea brevipes, Coffea bridsoniae, Coffea buxifolia, Coffea canephora, Coffea carrissoi, Coffea cochinchinensis, Coffea commersoniana, Coffea congensis, Coffea costatifructa, Coffea coursiana, Coffea dactylifera, Coffea decaryana, Coffea dubardii, Coffea ebracteolata, Coffea eugenioides, Coffea fadenii, Coffea farafanganensis, Coffea floresiana, Coffea fotsoana, Coffea fragilis, Coffea fragrans, Coffea gallienii, Coffea grevei, Coffea heimii, Coffea×heterocalyx, Coffea homollei, Coffea horsfieldiana, Coffea humilis, Coffea jumellei, Coffea kapakata, Coffea kianjavatensis, Coffea kihansiensis, Coffea kimbozensis, Coffea kivuensis, Coffea kivuensis, Coffea labatii, Coffea lancifolia, Coffea lebruniana, Coffea leonimontana, Coffea leroyi, Coffea liaudii, Coffea liberica, Coffea ligustroides, Coffea littoralis, Coffea lulandoensis, Coffea mabesae, Coffea macrocarpa, Coffea madurensis, Coffea magnistipula, Coffea malabarica, Coffea mangoroensis, Coffea manombensis, Coffea mapiana, Coffea mauritiana, Coffea canombensis, Coffea mcphersonii, Coffea melanocarpa, Coffea merguensis, Coffea millotii, Coffea minutiflora, Coffea mogenetii, Coffea mongensis, Coffea montekupensis, Coffea montis-sacri, Coffea moratii, Coffea mufindiensis, Coffea myrtifolia, Coffea namorokensis, Coffea neobridsoniae, Coffea neoleroya, Coffea perrieri, Coffea pervilleana, Coffea pocsii, Coffea pseudozanguebariae, Coffea pterocarpa, Coffea racemosa, Coffea rakotonasoloi, Coffea ratsimamangae, Coffea resinosa, Coffea rhamnifolia, Coffea richardii, Coffea sahafaryensis, Coffea sakarahae, Coffea salvatrix, Coffea sambavensis, Coffea sapinii, Coffea schliebenii, Coffea semsei, Coffea sessiliflora, Coffea stenophylla, Coffea tetragons, Coffea togoensis, Coffea toshii, Coffea travancorensis, Coffea tricalysioides, Coffea tsirananae, Coffea vatovavyensis, Coffea vavateninensis, Coffea vianneyi, Coffea vohemarensis, Coffea wightiana, Coffea zanguebariae or combinations thereof. In some aspects, the member of the genus Coffea is from the species Coffea arabica. In some aspects, the member of the genus Coffea is from the species Coffea canephora.

The term “plant extract” as used herein, e.g., as in “a saponin-containing plant extract” and “a caffeine-containing plant extract,” refers to an extract or concentrate that can be obtained from any part of the plant, e.g., seeds, leaves, fruit, stems, bark, roots, or parts thereof (e.g., seed husks, fruit skins, etc.), or combinations thereof, and contains an appreciable amount by weight of the total weight of the extract of a molluscicidally active substance, e.g., a saponin or caffeine. In some aspects, the plant extract is, for example, obtained from the entire fruit (e.g., coffee berries). In some aspects, the plant extract is, for example, obtained from seeds (e.g., coffee seeds). In some aspects, a plants extract is enriched in a molluscicidally active substance, e.g., a saponin or caffeine, with respect to the original parts of the plant. The enrichment in a molluscicidally active substance can be achieved by a process that increase amounts of one or more components of the plant relative to the percentages that occur naturally in the plant, for example, via extraction (e.g., using solvents) or by concentration. In some aspects, the plant extract is a “juice.” The term “juice” as used herein refers to a liquid obtained from the crushing, mashing, pulverizing, grinding, smashing or any combination thereof, plant materials, such as the plant fruit. In some aspects, the term plant extract encompasses purified saponins extracted from Sapindus saponaria, e.g., the saponins designated SP1, SP2, and SP3 in the Examples section or combinations thereof. SP1 is hederagenin-3-O-(3,4-O-diacetyl-beta-D-xylapyranosyl-(1→3)-alpha-L-rhamnopyranosyl-(1→2)-alpha-L-arabinopyranoside, SP2 is hederagenin-3-O-(3,4-O-diacetyl-alpha-D-arabinopyranosyl)-(1→3)-alpha-L-rhamnopyranosyl-(1→2)-alpha-L-arabinopyranoside, and SP3 is hederagenin-3-O-(4-O-acetyl-beta-D-xylopyranosyl)-(1→3)-alpha-L-rhamnopyranosyl-(1→2)-alpha-L-arabinopyranoside. SP1, SP2 and SP3 are the major saponin components in Sapindus saponaria extracts, but other saponins are also present. Accordingly, the purified saponin fractions disclosed herein can contain SP1, SP2, and SP3 alone or in combination with other saponins present in Sapindus saponaria extracts. In some aspects, the saponins present in the compositions disclosed herein are saponins comprising a hederagenin aglycone moiety not obtained from Sapindus saponaria.

The term “saponin” as used herein refers to glycosides of steroids, steroid alkaloids or triterpenes present in plants, for example, in the plant skins where they a form a waxy protective coating. Numerous saponins, as well as methods for their extraction, purification, and characterization are known in the art. See, e.g., Hostettmann et. al., British Journal of Nutrition, 88 (6):587-605 (1995); U.S. Pat. No. 8,298,590, and Xu et al., Advances in Experimental Medicine and Biology, 404:371-82 (1996). In some aspects, the term saponin refers to, for example, triterpenic saponin, steroidal saponin, alkaloid saponin or any combination thereof depending on the chemical structure of the sapogenin. In some aspects, a saponin can dissolve in water to form a stable soapy froth due to their amphiphilic nature. The biological and chemical activities of saponins are directly related to the number of sugar chains bound to the sapogenin, for example, saponins that have one sugar chain attached to the sapogenin are called mono-desmosidic saponins and show molluscicidal and fungal activity; saponins with sapogenins that have two sugar chains are called bi-desmosidic saponins and show an overall decrease in activity. See e.g., Waller, G. R. et. al., “Saponins used in Traditional and Modern Medicine, Advances in Experimental Medicine and Biology”, Vol. 404, 1996, New York: Plenum Press and Springer. Saponins are effective in the control of numerous mollusks including members of the family Ampullariidae, Pilidae, Biomphalaria ssp., Isidorella ssp., and Lymnaea ssp. See San Martins, et. al., Nat. Prod. Commun. 4(10):1327-30 (2009); San Martins, et. al., Crop Protection 27(3-5):310-319 (2008); U.S. Pat. No. 5,290,557. Saponins can also be used for the control of aquatic mollusks, zebra mussels, Dreissena polymorpha, Dreissenoidea family, and Heterodonta subclass. See U.S. Application No. 2007/0196517 A1; WO2008134510A2; U.S. Pat. No. 5,252,330; U.S. Pat. No. 2,034,414; and U.S. Pat. No. 5,334,386. As used herein, the term saponin refers to saponins obtained from natural sources, synthetic saponins, semisynthetic saponins (e.g., saponins chemically and/or enzymatically modified), and combinations thereof. In some aspects, the saponin-containing plant extract contains, for example, hederagenin-derived saponins, solid phase-derived saponins, or liquid-phase extracted-saponins. In some aspects, the saponin-containing plant extract contains hederagenin-derived saponins. In some aspects, the saponin-containing plant extract containing hederagenin-derived saponins and the caffeine-containing plant extract act synergistically as molluscicides. In some aspects, the term saponin refers to a single saponin species, whereas in other cases (especially when referring to saponins from plant extracts), the term saponin can refer to combinations of saponins.

In some aspects, the compositions disclosed herein can comprise a purified SP1 saponin, a purified SP2 saponin, a purified SP3 saponin, or a combination thereof. In some aspects, the purified saponin used to prepare a composition disclosed herein is a solid or liquid preparation containing at least about 75%, at least about 80%, at least 85%, at least about 90%, at least about 95%, at least 98%, or at least about 99% of SP1, SP2, SP3, or a combination thereof expressed as weight/weight (w/w) or weight/volume (w/v).

In some aspects, a saponin used in a composition disclosed herein can be a modified saponin (e.g., chemically or enzymatically) or a saponin derivative. See, e.g., U.S. Pat. No. 5,443,829; U.S. Pat. No. 6,262,029; Wie et al. J. Agric. Food Chem., 2007, 55:8908-8913; which are herein incorporated by reference in their entireties.

The term “caffeine” as used herein refers to 3,7-dihydro-1,3,7-trimethyl-1H-purine-2,6-dione (1,3,7-trimethylxanthine). In some aspects, the terms caffeine encompasses other xanthine alkaloids, for example, theobromine, theophylline, paraxanthine, 8-chlorotheophylline, trimethylxanthine, theine, mateine, guaranine, and methyltheobromine. In some aspects, the caffeine is, for example, natural, synthetic, semi-synthetic (e.g., a caffeine chemically and/or enzymatically modified), or a combination thereof. In some aspects, natural caffeine is from, for example, a caffeine-containing plant, wherein the caffeine is in the seeds, leaves, or fruit. Caffeine is synthesized in plants from the purine nucleotides, adenosine monophosphate, guanosine monophosphate, and inosinic acid, to xanthosine and then theobromine, the latter being the penultimate precursor of caffeine. Methods of caffeine extraction, purification, synthesis and characterization are known in the art. See e.g., U.S. Pat. No. 4,364,965, Peker, et al., AlChE Journal 35(5):761-770 (1992); Zajac, et al., Synthetic Communications: An International Journal for Rapid Communication of Synthetic Organic Chemistry, 33(19):3291-3297 (2003); and Espinoza-Perez, et al., Journal of Food Engineering 81(1):72-78 (2002). Caffeine is effective in the control of mollusks. See U.S. Pat. No. 6,565,867; Hollingsworth, et al., Annals Of Applied Biology, 142(1):91-97 (2003); and Hollingsworth, et al., Nature, 417 (6892):915-916 (2002).

The term “mollusks” as used herein refers collectively to terrestrial and aquatic mollusks. In general, the term mollusks refers to members of the phylum Mollusca. In some aspects, the class of the phylum Mollusca include, for example, Aplacophora, Bivalvia, Cephalopoda, Polylacophora, Gastropoda, Monoplacophora, Pleistomollusca, Polyplacophora, Rostroconchia, Scaphopoda and Incetae sedis. The group of mollusks that are agriculturally problematic, e.g., in gardens, greenhouses and farmlands includes, but is not limited to the genus Helix (e.g., H. aspersa, H. nemoralis), Cepaea (e.g., C. nemoralis), Zonitoides (e.g., Z. arboreus), Theba (e.g., T. pisana), Subolina (e.g., S. octona), Helicella, Deroceras (e.g., D. reticulatum, D. leave), Umax (e.g., U. poi\acute{η}eri, U. glavus, U. tenellus, U. maximus), Milax (e.g., M. gagates), Anon, Anion (e.g., A. subfucus, A. circumscriptus, A. hortensis, A. rufus, A. ater, A. lusitanicus), Agriolimax (e.g., A. reticulatis, and A. columbianus), etc. Examples of aquatic mollusks, are zebra mussels (e.g., Dreissena polymorpha) and in particular members of the Dreissenoidea family. In some aspects, the mollusks have shells (e.g., snails, mussels). In some aspects, the mollusks do not have a shell (e.g., slugs). In some aspects, the mollusks are found for example, in freshwater, saltwater, terrestrial environments, and any combinations thereof. Most terrestrial mollusks are herbivorous and many aquatic mollusks are omnivores or carnivores, which can influence the choice of bait for the preparation of commercial formulations of molluscicide compositions.

### 2. MOLLUSCICIDE COMPOSITIONS COMPRISING SAPONINS AND CAFFEINE

The present disclosure provides molluscicidal compositions comprising saponins (e.g., from plant origin, synthetic, or semisynthetic) and caffeine (e.g., from plant origin, synthetic, or semisynthetic), wherein the saponins and caffeine function synergistically as molluscicides. In some aspects, in addition to increasing the efficacy of caffeine as a molluscicide, the presence of saponins in the compositions disclosed herein also increases the solubility of caffeine. In some aspects, the solubility of caffeine can be increase by about 10%, about 20%, about 30%, about 40%, about 50%, about 60%, about 70%, about 80%, about 90%, or about 100% with respect to the solubility of caffeine in a solvent in the absence of saponin-containing plant extract, e.g., an extract from a Sapindacea family plant (such as Sapindus saponaria). In some aspects, the molluscicidal compositions disclosed herein can exert their action by contact, ingestion, or both. In some aspects, the molluscicide compositions disclosed herein are applied at concentrations that are no phytotoxic. In some aspects, the molluscicide compositions disclosed herein are highly stable, with a shelf life of at least 1 year or at least 2 years, and a field residuality of at least 1 week, 2 weeks, 3 weeks or 4 weeks under dry conditions.

In some aspects, the molluscicidal compositions disclosed herein comprise saponin and caffeine from a different source, wherein the different source can be a plant. In some aspects, the saponins and caffeine from a different source function synergistically as molluscicides. In some aspects, the molluscicidal composition comprises a saponin-containing plant extract, e.g., an extract from a Sapindacea family plant (such as Sapindus saponaria), and a caffeine-containing plant extract, e.g., an extract from a coffee plant (such a Coffea arabica), which can be used, for example for the control, treatment and prevention of mollusk infestation. In some aspects, the molluscicidal composition comprises a saponin-containing plant extract (e.g., a saponin-containing plant extract from Sapindus saponaria) and a caffeine-containing plant extract (e.g., a caffeine-containing plant extract from a coffee plant) which act synergistically as molluscicides.

Natural agents can be used as an alternative to pesticides to control mollusks. Saponins are natural molluscicides effective in both terrestrial and aquatic environments are. See e.g., Huang et al., Journal of Agricultural and Food Chemistry 51:4916-19 (2003); U.S. Pat. No. 6,565,867; U.S. Publ. No. 2007/0196517; Europe Publ. No. EP2002721; Ribeiro et al., Pharmaceutical Biology 33:177-180 (1995). Caffeine can also be used as a molluscicide. See e.g., Hollingsworth et al., Nature 417:915-916 (2002); Hollingsworth et al., Annals of Applied Biology 142:91-97 (2003); Jeong, et al., Horticulture, Environment, and Biotechnology 53:123-128 (2012); and González-Cruz et al., Cien. Inv. Agr. 40:341-349 (2013). High concentrations of saponins are generally used to achieve the desired molluscicidal effect, which can also result in toxicity to other invertebrates and increase the cost associated with the molluscicide. Similarly, the efficacy of caffeine as a molluscicide is low. Therefore, high concentrations of caffeine are generally used to achieve the desired molluscicidal effect, resulting in toxicity to other invertebrates and increased cost associated with the molluscicide. See González-Cruz, D. et al. The present disclosure proves that plant extracts comprising saponin and caffeine can act synergistically to achieve the desired molluscicidal effects, therefore overcoming the need to use high concentrations of either saponin or caffeine in molluscicides.

The phrase “molluscicide composition” as used herein refers to a composition comprising a saponin obtained from a first source (e.g., a plant extract from a member of the Sapindacea family such as S. saponaria) and caffeine obtained from a second source (e.g., a plant extract from a coffee plant). In some aspects the different sources can be different plant sources (e.g., plants from different genera, for example a plant from the genus Sapindus and a plant from the genus Coffea). When referring to plant extracts, e.g., as in “a saponin-containing plant extract and a caffeine-containing plant extract from a different plant,” the term different plant can indicate that each plant is a separate plant species or variety, e.g., the saponin-containing plant would be obtained from a Sapindaceae family plant, whereas the caffeine-containing plant would be obtained from a coffee plant. In some aspects, an extract can be prepared from a single plant source (e.g., Coffea arabica), or from different plants sources, which can belong to the same species, genus, or family, or can belong to different species, genus, or families. For example, a saponin-containing plant extract could be obtained from Sapindus saponaria, or from Sapindus saponaria and at least one additional source (e.g., quina). Similarly, a caffeine-containing plant extract could be obtained from Coffea ssp., or from Coffea ssp. and at least one additional source (e.g., tea or hierba mate).

In some aspects, the saponin-containing plant extract can be obtained from a plant, and can be used in extract, concentrate, or purified form. Similarly, in some aspects, the caffeine-containing plant extract can be obtained from a plant, and can be used in extract, concentrate, or purified form. The saponins in the molluscicide compositions can be natural, synthetic, semisynthetic, or a combination thereof. Similarly, the caffeine in the molluscicide composition can be natural, synthetic, semisynthetic, or a combination thereof. As used herein the term semisynthetic refers to a molecule that is the result of a chemical or enzymatic modification of a molecule obtained from a natural source (e.g., a saponin obtained from a plant can be subsequently modified, either chemically or enzymatically to yield a semisynthetic saponin).

In some aspects, the molluscicide composition comprises (i) a saponin-containing plant extract (e.g., an extract from Sapindacea) and (ii) a caffeine-containing plant extract from a different plant (e.g., from a coffee plant). In some aspects, the saponin-containing plant extract and the caffeine-containing plant extract can act synergistically as molluscicides. In some aspects, the molluscicide composition comprises a (i) saponin-containing plant extract and (ii) pure caffeine (natural caffeine, semisynthetic caffeine, synthetic caffeine, or a combination thereof). In some aspects, the saponin-containing plant extract and the pure caffeine can act synergistically as molluscicides. In other aspects, the molluscicide composition comprises (i) pure saponin(s) (e.g., natural saponin(s), semisynthetic saponin(s), synthetic saponin(s), or a combination thereof) and (ii) a caffeine-containing plant extract. In some aspects, the pure saponin(s) and the caffeine-containing plant extract can act synergistically as molluscicides. In yet other aspects, the molluscicide composition comprises pure (i) saponin(s) (e.g., natural saponin(s), semisynthetic saponin(s), synthetic saponin(s), or a combination thereof) and (ii) pure caffeine (e.g., natural caffeine, semisynthetic caffeine, synthetic caffeine, or a combination thereof). In some aspects, the pure saponin(s) and the pure caffeine can act synergistically as molluscicides.

In some aspects, the saponin percentage of the dry weight of the saponin-containing plant extract (e.g., a saponin-containing plant extract from Sapindus saponaria) is, for example, at least about 1%, at least about 2%, at least about 4%, at least about 5%, at least about 6%, at least about 7%, at least about 8%, at least about 9%, at least about 10%, at least about 15%, at least about 20%, at least about 25%, at least about 30%, at least about 35%, at least about 40%, at least about 45%, at least about 50%, at least about 55%, at least about 60%, at least about 65%, at least 70%, at least 75%, at least 80%, at least about 90%, at least about 95%, at least about 96%, at least about 97%, at least about 98%, or at least about 99%. In some aspects, the saponin percentage of the dry weight of the saponin-containing plant extract (e.g., a saponin-containing plant extract from Sapindus saponaria) is at least about 10%. In some aspects, the saponin percentage of the dry weight of the saponin-containing plant extract (e.g., a saponin-containing plant extract from Sapindus saponaria) is at least about 20%. In some aspects, the saponin percentage of the dry weight of the saponin-containing plant extract (e.g., a saponin-containing plant extract from Sapindus saponaria) is about 25%.

In some aspects, the caffeine concentration in the molluscicide composition is a percentage of the dry weight of the caffeine-containing plant extract (e.g., a caffeine-containing plant extract from a coffee plant). In some aspects, the caffeine percentage of the dry weight of the caffeine-containing plant extract (e.g., a caffeine-containing plant extract from a coffee plant) is, for example, at least about 1%, at least about 2%, at least about 4%, at least about 5%, at least about 6%, at least about 7%, at least about 8%, at least about 9%, at least about 10%, at least about 15%, at least about 20%, at least about 25%, at least about 30%, at least about 35%, at least about 40%, at least about 45%, at least about 50%, at least about 55%, at least about 60%, at least about 65%, at least 70%, at least 75%, at least 80%, at least about 90%, at least about 95%, at least about 96%, at least about 97%, at least about 98%, or at least about 99%. In some aspects, the caffeine percentage of the dry weight of the caffeine-containing plant extract (e.g., a caffeine-containing plant extract from a coffee plant) is at least about 10%. In some aspects, the caffeine percentage of the dry weight of the caffeine-containing plant extract (e.g., a caffeine-containing plant extract from a coffee plant) is at least about 20%. In some aspects, the caffeine percentage of the dry weight of the caffeine-containing plant extract (e.g., a caffeine-containing plant extract from a coffee plant) is at least about 25%. In some aspects, the caffeine percentage of the dry weight of the caffeine-containing plant extract (e.g., a caffeine-containing plant extract from a coffee plant) is about 30%. In some aspects, the caffeine percentage of the dry weight of the caffeine-containing plant extract (e.g., a caffeine-containing plant extract from a coffee plant) is about 33%.

In some aspects, the molluscicide composition comprises (i) a saponin-containing plant extract (e.g., a saponin-containing plant extract from Sapindus saponaria) wherein the saponin percentage is at least about 10% of the dry weight of the extract, and (ii) a caffeine-containing plant extract (e.g., a caffeine-containing plant extract from a coffee plant), wherein the saponin-containing plant extract and the caffeine-containing plant extract synergistically as molluscicides. In some aspects, the molluscicide composition comprises (i) a saponin-containing plant extract (e.g., a saponin-containing plant extract from Sapindus saponaria) wherein the saponin percentage is at least about 20% of the dry weight of the extract, and (ii) a caffeine-containing plant extract (e.g., a caffeine-containing plant extract from a coffee plant), wherein the saponin-containing plant extract and the caffeine-containing plant extract synergistically as molluscicides. In some aspects, the molluscicide composition comprises (i) a saponin-containing plant extract (e.g., a saponin-containing plant extract from Sapindus saponaria) wherein the saponin percentage is at least about 25% of the dry weight of the extract, and (ii) a caffeine-containing plant extract (e.g., a caffeine-containing plant extract from a coffee plant), wherein the saponin-containing plant extract and the caffeine-containing plant extract synergistically as molluscicides.

In some aspects, the molluscicide composition comprises (i) a saponin-containing plant extract (e.g., a saponin-containing plant extract from Sapindus saponaria), and (ii) a caffeine-containing plant extract (e.g., a caffeine-containing plant extract from a coffee plant) wherein the caffeine percentage is at least about 10% of the dry weight of the extract, wherein the saponin-containing plant extract and the caffeine-containing plant extract synergistically as molluscicides. In some aspects, the molluscicide composition comprises (i) a saponin-containing plant extract (e.g., a saponin-containing plant extract from Sapindus saponaria), and (ii) a caffeine-containing plant extract (e.g., a caffeine-containing plant extract from a coffee plant) wherein the caffeine percentage is at least about 20% of the dry weight of the extract, wherein the saponin-containing plant extract and the caffeine-containing plant extract synergistically as molluscicides. In some aspects, the molluscicide composition comprises (i) a saponin-containing plant extract (e.g., a saponin-containing plant extract from Sapindus saponaria), and (ii) a caffeine-containing plant extract (e.g., a caffeine-containing plant extract from a coffee plant) wherein the caffeine percentage is at least about 30% of the dry weight of the extract, wherein the saponin-containing plant extract and the caffeine-containing plant extract synergistically as molluscicides. In some aspects, the molluscicide composition comprises (i) a saponin-containing plant extract (e.g., a saponin-containing plant extract from Sapindus saponaria), and (ii) a caffeine-containing plant extract (e.g., a caffeine-containing plant extract from a coffee plant) wherein the caffeine percentage is at least about 33% of the dry weight of the extract, wherein the saponin-containing plant extract and the caffeine-containing plant extract synergistically as molluscicides.

The term “pure” as used herein refers to a composition (e.g., a saponin-containing plant extract or a caffeine-containing plant extract) comprising at least 80% of active principle (e.g., saponin or caffeine) in dry weight. Numerous methods are known in the art to determine purity. See e.g., L. R. Snyder, J. J. Kirkland, and J. W. Dolan, “Introduction to Modern Liquid Chromatography,” John Wiley & Sons, New York, (2009) and Rabi, et al., Physical Review 53 (4): 318-327 (1938). In some aspects, a pure composition comprises at least about 80%, at least about 85%, at least about 90%, at least about 95%, at least about 96%, at least about 97%, at least about 98%, or at least about 99% of active principle (e.g., saponin and/or caffeine) pure. In some aspects, the composition is 97% pure. In other aspects, the composition is less than 80% pure.

In some aspects, the saponin-containing plant extract (e.g., a saponin-containing plant extract from Sapindus saponaria) has a purity of, for example, at least about 5%, at least about 10%, at least about 15%, at least about 20%, at least about 25%, at least about 30%, at least about 35%, at least about 40%, at least about 45%, at least about 50%, at least about 55%, at least about 60%, at least about 65%, at least about 70%, at least about 75%, at least about 80%, at least about 85%, at least about 90%, at least about 95%, at least about 96%, at least about 97%, at least about 98%, or at least about 99%. In some aspects, the saponin-containing plant extract (e.g., a saponin-containing plant extract from Sapindus saponaria) has a purity of at least about 61%. In some aspects, the saponin-containing plant extract (e.g., a saponin-containing plant extract from Sapindus saponaria) has a purity of about 62%, i.e., about 62% of the dry weight of the saponin-containing plant extract is pure saponin.

In some aspects, the molluscicide composition comprises a saponin-containing plant extract (e.g., a saponin-containing plant extract from Sapindus saponaria) with a purity of about 62%, and a caffeine-containing plant extract (e.g., a caffeine-containing plant extract from a coffee plant), wherein the saponin-containing plant extract and the caffeine-containing plant extract synergistically as molluscicides.

In some aspects, the caffeine-containing plant extract (e.g., a caffeine-containing plant extract from a coffee plant) has a purity of, for example, at least about 5%, at least about 10%, at least about 15%, at least about 20%, at least about 25%, at least about 30%, at least about 35%, at least about 40%, at least about 45%, at least about 50%, at least about 55%, at least about 60%, at least about 65%, at least about 70%, at least about 75%, at least about 80%, at least about 85%, at least about 90%, at least about 95%, at least about 96%, at least about 97%, at least about 98%, or at least about 99%. In some aspects, the caffeine-containing plant extract (e.g., a caffeine-containing plant extract from a coffee plant) is at least about 80% pure. In some aspects, the caffeine-containing plant extract (e.g., a caffeine-containing plant extract from a coffee plant) is at least about 90% pure. In some aspects, the caffeine-containing plant extract (e.g., a caffeine-containing plant extract from a coffee plant) is about 97% pure, e.g., about 97% of the dry weight of the caffeine-containing plant extract is pure caffeine.

In some aspects, the molluscicide composition comprises a saponin-containing plant extract (e.g., a saponin-containing plant extract from Sapindus saponaria), and a caffeine-containing plant extract (e.g., a caffeine-containing plant extract from a coffee plant) with a purity of about 80%, wherein the saponin-containing plant extract and the caffeine-containing plant extract synergistically as molluscicides. In some aspects, the molluscicide composition comprises a saponin-containing plant extract (e.g., a saponin-containing plant extract from Sapindus saponaria), and a caffeine-containing plant extract (e.g., a caffeine-containing plant extract from a coffee plant) with a purity of about 90%, wherein the saponin-containing plant extract and the caffeine-containing plant extract synergistically as molluscicides. In some aspects, the molluscicide composition comprises a saponin-containing plant extract (e.g., a saponin-containing plant extract from Sapindus saponaria), and a caffeine-containing plant extract (e.g., a caffeine-containing plant extract from a coffee plant) with a purity of about 97%, wherein the saponin-containing plant extract and the caffeine-containing plant extract synergistically as molluscicides.

In some aspects, the saponin-containing plant extract (e.g., a saponin-containing plant extract from Sapindus saponaria) contains, for example, saponins, free sugars, and at least one additional impurity. In some aspects, the saponin-containing plant extract (e.g., a saponin-containing plant extract from Sapindus saponaria) contains saponins and free sugars. In some aspects, the molluscicide composition comprises a saponin-containing plant extract (e.g., a saponin-containing plant extract from Sapindus saponaria) which contains saponins and free sugars, and a caffeine-containing plant extract (e.g., a caffeine-containing plant extract from a coffee plant), wherein the saponin-containing plant extract and the caffeine-containing plant extract synergistically as molluscicides.

In some aspects, the caffeine-containing plant extract (e.g., a caffeine-containing plant extract from a coffee plant) contains, for example, caffeine and at least one additional impurity. In some aspects, the impurity is, for example, protocatechuic acid, caffeic acid, chlorogenic acid, polyphenols, or any combination thereof. Thus, in some aspects, the molluscicide composition comprises a saponin-containing plant extract (e.g., a saponin-containing plant extract from Sapindus saponaria), and a caffeine-containing plant extract (e.g., a caffeine-containing plant extract from a coffee plant) containing caffeine and at least one additional impurity, wherein the saponin-containing plant extract and the caffeine-containing plant extract synergistically as molluscicides.

In some aspects, the molluscicide composition comprises a saponin-containing plant extract (e.g., a saponin-containing plant extract from Sapindus saponaria), and a caffeine-containing plant extract (e.g., a caffeine-containing plant extract from a coffee plant), with a concentration between about 0.1 grams/liter to about 15 grams/liter of saponin-containing plant extract and a concentration between about 0.1 grams/liter to about 15 grams/liter of caffeine-containing plant extract, a concentration between about 0.1 grams/liter to about 12 grams/liter of saponin-containing plant extract and a concentration between about 0.1 grams/liter to about 12 grams/liter of caffeine-containing plant extract, a concentration between about 0.1 grams/liter to about 10 grams/liter of saponin-containing plant extract and a concentration between about 0.1 grams/liter to about 10 grams/liter of caffeine-containing plant extract, a concentration between about 0.1 grams/liter to about 8 grams/liter of saponin-containing plant extract and a concentration between about 0.1 grams/liter to about 8 grams/liter of caffeine-containing plant extract, a concentration between about 0.1 grams/liter to about 6 grams/liter of saponin-containing plant extract and a concentration between about 0.1 grams/liter to about 6 grams/liter of caffeine-containing plant extract, a concentration between about 0.1 grams/liter to about 4 grams/liter of saponin-containing plant extract and a concentration between about 0.1 grams/liter to about 4 grams/liter of caffeine-containing plant extract, a concentration between about 0.1 grams/liter to about 2 grams/liter of saponin-containing plant extract and a concentration between about 0.1 grams/liter to about 2 grams/liter of caffeine-containing plant extract, a concentration between about 2 grams/liter to about 15 grams/liter of saponin-containing plant extract and a concentration between about 2 grams/liter to about 15 grams/liter of caffeine-containing plant extract, a concentration between about 2 grams/liter to about 12 grams/liter of saponin-containing plant extract and a concentration between about 2 grams/liter to about 12 grams/liter of caffeine-containing plant extract, a concentration between about 2 grams/liter to about 10 grams/liter of saponin-containing plant extract and a concentration between about 2 grams/liter to about 10 grams/liter of caffeine-containing plant extract, a concentration between about 2 grams/liter to about 8 grams/liter of saponin-containing plant extract and a concentration between about 2 grams/liter to about 8 grams/liter of caffeine-containing plant extract, a concentration between about 2 grams/liter to about 6 grams/liter of saponin-containing plant extract and a concentration between about 2 grams/liter to about 6 grams/liter of caffeine-containing plant extract, a concentration between about 2 grams/liter to about 4 grams/liter of saponin-containing plant extract and a concentration between about 2 grams/liter to about 4 grams/liter of caffeine-containing plant extract, a concentration between about 3 grams/liter to about 15 grams/liter of saponin-containing plant extract and a concentration between about 3 grams/liter to about 15 grams/liter of caffeine-containing plant extract, a concentration between about 3 grams/liter to about 12 grams/liter of saponin-containing plant extract and a concentration between about 3 grams/liter to about 12 grams/liter of caffeine-containing plant extract, a concentration between about 3 grams/liter to about 10 grams/liter of saponin-containing plant extract and a concentration between about 3 grams/liter to about 10 grams/liter of caffeine-containing plant extract, a concentration between about 3 grams/liter to about 9 grams/liter of saponin-containing plant extract and a concentration between about 3 grams/liter to about 9 grams/liter of caffeine-containing plant extract, a concentration between about 3 grams/liter to about 8 grams/liter of saponin-containing plant extract and a concentration between about 3 grams/liter to about 8 grams/liter of caffeine-containing plant extract, a concentration between about 3 grams/liter to about 7 grams/liter of saponin-containing plant extract and a concentration between about 3 grams/liter to about 7 grams/liter of caffeine-containing plant extract, a concentration between about 3 grams/liter to about 6 gram/liter of saponin-containing plant extract and a concentration between about 3 grams/liter to about 6 grams/liter of caffeine-containing plant extract, a concentration between about 3 grams/liter to about 5 grams/liter of saponin-containing plant extract and a concentration between about 3 grams/liter to about 5 grams/liter of caffeine-containing plant extract, a concentration between about 3 grams/liter to about 5 grams/liter of saponin-containing plant extract and a concentration between about 3 grams/liter to about 4 grams/liter of caffeine-containing plant extract, a concentration between about 5 grams/liter to about 10 grams/liter of saponin-containing plant extract and a concentration between about 5 grams/liter to about 10 grams/liter of caffeine-containing plant extract, a concentration between about 5 grams/liter to about 9 grams/liter of saponin-containing plant extract and a concentration between about 5 grams/liter to about 9 grams/liter of caffeine-containing plant extract, a concentration between about 5 grams/liter to about 8 grams/liter of saponin-containing plant extract and a concentration between about 5 grams/liter to about 8 grams/liter of caffeine-containing plant extract, or a concentration between about 5 grams/liter to about 7 grams/liter of saponin-containing plant extract and a concentration between about 5 grams/liter to about 7 grams/liter of caffeine-containing plant extract.

In some aspects, the molluscicide composition comprises a saponin-containing plant extract (e.g., a saponin-containing plant extract from Sapindus saponaria), and a caffeine-containing plant extract (e.g., a caffeine-containing plant extract from a coffee plant), wherein the concentration of saponin-containing plant extract is between about 0.1 grams/liter to about 15 grams/liter and the concentration of caffeine-containing plant extract is between about 0.1 grams/liter to about 15 grams/liter, and wherein the saponin-containing plant extract and the caffeine-containing plant extract act synergistically as molluscicides. In some aspects, the molluscicide composition comprises a saponin-containing plant extract (e.g., a saponin-containing plant extract from Sapindus saponaria), and a caffeine-containing plant extract (e.g., a caffeine-containing plant extract from a coffee plant), wherein the concentration of saponin-containing plant extract is between about 2 grams/liter to about 12 grams/liter and the concentration of caffeine-containing plant extract is between about 2 grams/liter to about 12 grams/liter, and wherein the saponin-containing plant extract and the caffeine-containing plant extract act synergistically as molluscicides. In some aspects, the molluscicide composition comprises a saponin-containing plant extract (e.g., a saponin-containing plant extract from Sapindus saponaria), and a caffeine-containing plant extract (e.g., a caffeine-containing plant extract from a coffee plant), wherein the concentration of saponin-containing plant extract is between about 3 grams/liter to about 10 grams/liter and the concentration of caffeine-containing plant extract is between about 3 grams/liter to about 10 grams/liter, and wherein the saponin-containing plant extract and the caffeine-containing plant extract act synergistically as molluscicides. In some aspects, the molluscicide composition comprises a saponin-containing plant extract (e.g., a saponin-containing plant extract from Sapindus saponaria), and a caffeine-containing plant extract (e.g., a caffeine-containing plant extract from a coffee plant), wherein the concentration of saponin-containing plant extract is about 7 grams/liter and the concentration of caffeine-containing plant extract is about 7 grams/liter, and wherein the saponin-containing plant extract and the caffeine-containing plant extract act synergistically as molluscicides.

In some aspects, the molluscicide composition comprises a saponin-containing plant extract (e.g., a saponin-containing plant extract from Sapindus saponaria), and pure caffeine, with a concentration between about 0.1 grams/liter to about 15 grams/liter of saponin-containing plant extract and a concentration between about 0.1 grams/liter to about 15 grams/liter of pure caffeine, a concentration between about 0.1 grams/liter to about 12 grams/liter of saponin-containing plant extract and a concentration between about 0.1 grams/liter to about 12 grams/liter of pure caffeine, a concentration between about 0.1 grams/liter to about 10 grams/liter of saponin-containing plant extract and a concentration between about 0.1 grams/liter to about 10 grams/liter of pure caffeine, a concentration between about 0.1 grams/liter to about 8 grams/liter of saponin-containing plant extract and a concentration between about 0.1 grams/liter to about 8 grams/liter of pure caffeine, a concentration between about 0.1 grams/liter to about 6 grams/liter of saponin-containing plant extract and a concentration between about 0.1 grams/liter to about 6 grams/liter of pure caffeine, a concentration between about 0.1 grams/liter to about 4 grams/liter of saponin-containing plant extract and a concentration between about 0.1 grams/liter to about 4 grams/liter of pure caffeine, a concentration between about 0.1 grams/liter to about 2 grams/liter of saponin-containing plant extract and a concentration between about 0.1 grams/liter to about 2 grams/liter of pure caffeine, a concentration between about 2 grams/liter to about 15 grams/liter of saponin-containing plant extract and a concentration between about 2 grams/liter to about 15 grams/liter of pure caffeine, a concentration between about 2 grams/liter to about 12 grams/liter of saponin-containing plant extract and a concentration between about 2 grams/liter to about 12 grams/liter of pure caffeine, a concentration between about 2 grams/liter to about 10 grams/liter of saponin-containing plant extract and a concentration between about 2 grams/liter to about 10 grams/liter of pure caffeine, a concentration between about 2 grams/liter to about 8 grams/liter of saponin-containing plant extract and a concentration between about 2 grams/liter to about 8 grams/liter of pure caffeine, a concentration between about 2 grams/liter to about 6 grams/liter of saponin-containing plant extract and a concentration between about 2 grams/liter to about 6 grams/liter of pure caffeine, a concentration between about 2 grams/liter to about 4 grams/liter of saponin-containing plant extract and a concentration between about 2 grams/liter to about 4 grams/liter of pure caffeine, a concentration between about 3 grams/liter to about 15 grams/liter of saponin-containing plant extract and a concentration between about 3 grams/liter to about 15 grams/liter of pure caffeine, a concentration between about 3 grams/liter to about 12 grams/liter of saponin-containing plant extract and a concentration between about 3 grams/liter to about 12 grams/liter of pure caffeine, a concentration between about 3 grams/liter to about 10 grams/liter of saponin-containing plant extract and a concentration between about 3 grams/liter to about 10 grams/liter of pure caffeine, a concentration between about 3 grams/liter to about 9 grams/liter of saponin-containing plant extract and a concentration between about 3 grams/liter to about 9 grams/liter of pure caffeine, a concentration between about 3 grams/liter to about 8 grams/liter of saponin-containing plant extract and a concentration between about 3 grams/liter to about 8 grams/liter of pure caffeine, a concentration between about 3 grams/liter to about 7 grams/liter of saponin-containing plant extract and a concentration between about 3 grams/liter to about 7 grams/liter of pure caffeine, a concentration between about 3 grams/liter to about 6 gram/liter of saponin-containing plant extract and a concentration between about 3 grams/liter to about 6 grams/liter of pure caffeine, a concentration between about 3 grams/liter to about 5 grams/liter of saponin-containing plant extract and a concentration between about 3 grams/liter to about 5 grams/liter of pure caffeine, a concentration between about 3 grams/liter to about 5 grams/liter of saponin-containing plant extract and a concentration between about 3 grams/liter to about 4 grams/liter of pure caffeine, a concentration between about 5 grams/liter to about 10 grams/liter of saponin-containing plant extract and a concentration between about 5 grams/liter to about 10 grams/liter of pure caffeine, a concentration between about 5 grams/liter to about 9 grams/liter of saponin-containing plant extract and a concentration between about 5 grams/liter to about 9 grams/liter of pure caffeine, a concentration between about 5 grams/liter to about 8 grams/liter of saponin-containing plant extract and a concentration between about 5 grams/liter to about 8 grams/liter of pure caffeine, or a concentration between about 5 grams/liter to about 7 grams/liter of saponin-containing plant extract and a concentration between about 5 grams/liter to about 7 grams/liter of pure caffeine.

In some aspects, the molluscicide composition comprises a saponin-containing plant extract (e.g., a saponin-containing plant extract from Sapindus saponaria), and pure caffeine, wherein the concentration of saponin-containing plant extract is between about 0.1 grams/liter to about 15 grams/liter and the concentration of pure caffeine is between about 0.1 grams/liter to about 15 grams/liter, and wherein the saponin-containing plant extract and the pure caffeine act synergistically as molluscicides. In some aspects, the molluscicide composition comprises a saponin-containing plant extract (e.g., a saponin-containing plant extract from Sapindus saponaria), and pure caffeine, wherein the concentration of saponin-containing plant extract is between about 2 grams/liter to about 12 grams/liter and the concentration of pure caffeine is between about 2 grams/liter to about 12 grams/liter, and wherein the saponin-containing plant extract and the pure caffeine act synergistically as molluscicides. In some aspects, the molluscicide composition comprises a saponin-containing plant extract (e.g., a saponin-containing plant extract from Sapindus saponaria), and pure caffeine, wherein the concentration of saponin-containing plant extract is between about 3 grams/liter to about 10 grams/liter and the concentration of pure caffeine is between about 3 grams/liter to about 10 grams/liter, and wherein the saponin-containing plant extract and the pure caffeine act synergistically as molluscicides. In some aspects, the molluscicide composition comprises a saponin-containing plant extract (e.g., a saponin-containing plant extract from Sapindus saponaria), and pure caffeine, wherein the concentration of saponin-containing plant extract is about 7 grams/liter and the concentration of pure caffeine is about 7 grams/liter, and wherein the saponin-containing plant extract and the pure caffeine act synergistically as molluscicides. In some aspects, the molluscicide composition comprises a saponin-containing plant extract (e.g., a saponin-containing plant extract from Sapindus saponaria), and pure caffeine, wherein the concentration of saponin-containing plant extract is between about 3 grams/liter to about 10 grams/liter and the concentration of pure caffeine is between about 3 grams/liter to about 10 grams/liter, and wherein the saponin-containing plant extract and the pure caffeine act synergistically as molluscicides.

In some aspects, the molluscicide composition comprises pure saponin, and a caffeine-containing plant extract (e.g., a caffeine-containing extract from a coffee plant), with a concentration between about 0.1 grams/liter to about 15 grams/liter of pure saponin and a concentration between about 0.1 grams/liter to about 15 grams/liter of caffeine-containing plant extract, a concentration between about 0.1 grams/liter to about 12 grams/liter of pure saponin and a concentration between about 0.1 grams/liter to about 12 grams/liter of caffeine-containing plant extract, a concentration between about 0.1 grams/liter to about 10 grams/liter of pure saponin and a concentration between about 0.1 grams/liter to about 10 grams/liter of caffeine-containing plant extract, a concentration between about 0.1 grams/liter to about 8 grams/liter of pure saponin and a concentration between about 0.1 grams/liter to about 8 grams/liter of caffeine-containing plant extract, a concentration between about 0.1 grams/liter to about 6 grams/liter of pure saponin and a concentration between about 0.1 grams/liter to about 6 grams/liter of caffeine-containing plant extract, a concentration between about 0.1 grams/liter to about 4 grams/liter of pure saponin and a concentration between about 0.1 grams/liter to about 4 grams/liter of caffeine-containing plant extract, a concentration between about 0.1 grams/liter to about 2 grams/liter of pure saponin and a concentration between about 0.1 grams/liter to about 2 grams/liter of caffeine-containing plant extract, a concentration between about 2 grams/liter to about 15 grams/liter of pure saponin and a concentration between about 2 grams/liter to about 15 grams/liter of caffeine-containing plant extract, a concentration between about 2 grams/liter to about 12 grams/liter of pure saponin and a concentration between about 2 grams/liter to about 12 grams/liter of caffeine-containing plant extract, a concentration between about 2 grams/liter to about 10 grams/liter of pure saponin and a concentration between about 2 grams/liter to about 10 grams/liter of caffeine-containing plant extract, a concentration between about 2 grams/liter to about 8 grams/liter of pure saponin and a concentration between about 2 grams/liter to about 8 grams/liter of caffeine-containing plant extract, a concentration between about 2 grams/liter to about 6 grams/liter of pure saponin and a concentration between about 2 grams/liter to about 6 grams/liter of caffeine-containing plant extract, a concentration between about 2 grams/liter to about 4 grams/liter of pure saponin and a concentration between about 2 grams/liter to about 4 grams/liter of caffeine-containing plant extract, a concentration between about 3 grams/liter to about 15 grams/liter of pure saponin and a concentration between about 3 grams/liter to about 15 grams/liter of caffeine-containing plant extract, a concentration between about 3 grams/liter to about 12 grams/liter of pure saponin and a concentration between about 3 grams/liter to about 12 grams/liter of caffeine-containing plant extract, a concentration between about 3 grams/liter to about 10 grams/liter of pure saponin and a concentration between about 3 grams/liter to about 10 grams/liter of caffeine-containing plant extract, a concentration between about 3 grams/liter to about 9 grams/liter of pure saponin and a concentration between about 3 grams/liter to about 9 grams/liter of caffeine-containing plant extract, a concentration between about 3 grams/liter to about 8 grams/liter of pure saponin and a concentration between about 3 grams/liter to about 8 grams/liter of caffeine-containing plant extract, a concentration between about 3 grams/liter to about 7 grams/liter of pure saponin and a concentration between about 3 grams/liter to about 7 grams/liter of caffeine-containing plant extract, a concentration between about 3 grams/liter to about 6 gram/liter of pure saponin and a concentration between about 3 grams/liter to about 6 grams/liter of caffeine-containing plant extract, a concentration between about 3 grams/liter to about 5 grams/liter of pure saponin and a concentration between about 3 grams/liter to about 5 grams/liter of caffeine-containing plant extract, a concentration between about 3 grams/liter to about 5 grams/liter of pure saponin and a concentration between about 3 grams/liter to about 4 grams/liter of caffeine-containing plant extract, a concentration between about 5 grams/liter to about 10 grams/liter of pure saponin and a concentration between about 5 grams/liter to about 10 grams/liter of caffeine-containing plant extract, a concentration between about 5 grams/liter to about 9 grams/liter of pure saponin and a concentration between about 5 grams/liter to about 9 grams/liter of caffeine-containing plant extract, a concentration between about 5 grams/liter to about 8 grams/liter of pure saponin and a concentration between about 5 grams/liter to about 8 grams/liter of caffeine-containing plant extract, or a concentration between about 5 grams/liter to about 7 grams/liter of pure saponin and a concentration between about 5 grams/liter to about 7 grams/liter of caffeine-containing plant extract.

In some aspects, the molluscicide composition comprises a pure saponin, and a caffeine-containing plant extract (e.g., a caffeine-containing plant extract from a coffee plant), wherein the concentration of pure saponin is between about 0.1 grams/liter to about 15 grams/liter and the concentration of caffeine-containing plant extract is between about 0.1 grams/liter to about 15 grams/liter, and wherein the pure saponin and the caffeine-containing plant extract act synergistically as molluscicides. In some aspects, the molluscicide composition comprises a pure saponin, and a caffeine-containing plant extract (e.g., a caffeine-containing plant extract from a coffee plant), wherein the concentration of pure saponin is between about 2 grams/liter to about 12 grams/liter and the concentration of caffeine-containing plant extract is between about 2 grams/liter to about 12 grams/liter, and wherein the pure saponin and the caffeine-containing plant extract act synergistically as molluscicides. In some aspects, the molluscicide composition comprises a pure saponin, and a caffeine-containing plant extract (e.g., a caffeine-containing plant extract from a coffee plant), wherein the concentration of pure saponin is between about 3 grams/liter to about 10 grams/liter and the concentration of caffeine-containing plant extract is between about 3 grams/liter to about 10 grams/liter, and wherein the pure saponin and the caffeine-containing plant extract act synergistically as molluscicides. In some aspects, the molluscicide composition comprises a pure saponin, and a caffeine-containing plant extract (e.g., a caffeine-containing plant extract from a coffee plant), wherein the concentration of pure saponin is about 7 grams/liter and the concentration of caffeine-containing plant extract is about 7 grams/liter, and wherein the pure saponin and the caffeine-containing plant extract act synergistically as molluscicides.

In some aspects, the molluscicide composition comprises (i) pure saponin, and (ii) pure caffeine, with a concentration between about 0.1 grams/liter to about 15 grams/liter of pure saponin and a concentration between about 0.1 grams/liter to about 15 grams/liter of pure caffeine, a concentration between about 0.1 grams/liter to about 12 grams/liter of pure saponin and a concentration between about 0.1 grams/liter to about 12 grams/liter of pure caffeine, a concentration between about 0.1 grams/liter to about 10 grams/liter of pure saponin and a concentration between about 0.1 grams/liter to about 10 grams/liter of pure caffeine, a concentration between about 0.1 grams/liter to about 8 grams/liter of pure saponin and a concentration between about 0.1 grams/liter to about 8 grams/liter of pure caffeine, a concentration between about 0.1 grams/liter to about 6 grams/liter of pure saponin and a concentration between about 0.1 grams/liter to about 6 grams/liter of pure caffeine, a concentration between about 0.1 grams/liter to about 4 grams/liter of pure saponin and a concentration between about 0.1 grams/liter to about 4 grams/liter of pure caffeine, a concentration between about 0.1 grams/liter to about 2 grams/liter of pure saponin and a concentration between about 0.1 grams/liter to about 2 grams/liter of pure caffeine, a concentration between about 2 grams/liter to about 15 grams/liter of pure saponin and a concentration between about 2 grams/liter to about 15 grams/liter of pure caffeine, a concentration between about 2 grams/liter to about 12 grams/liter of pure saponin and a concentration between about 2 grams/liter to about 12 grams/liter of pure caffeine, a concentration between about 2 grams/liter to about 10 grams/liter of pure saponin and a concentration between about 2 grams/liter to about 10 grams/liter of pure caffeine, a concentration between about 2 grams/liter to about 8 grams/liter of pure saponin and a concentration between about 2 grams/liter to about 8 grams/liter of pure caffeine, a concentration between about 2 grams/liter to about 6 grams/liter of pure saponin and a concentration between about 2 grams/liter to about 6 grams/liter of pure caffeine, a concentration between about 2 grams/liter to about 4 grams/liter of pure saponin and a concentration between about 2 grams/liter to about 4 grams/liter of pure caffeine, a concentration between about 3 grams/liter to about 15 grams/liter of pure saponin and a concentration between about 3 grams/liter to about 15 grams/liter of pure caffeine, a concentration between about 3 grams/liter to about 12 grams/liter of pure saponin and a concentration between about 3 grams/liter to about 12 grams/liter of pure caffeine, a concentration between about 3 grams/liter to about 10 grams/liter of pure saponin and a concentration between about 3 grams/liter to about 10 grams/liter of pure caffeine, a concentration between about 3 grams/liter to about 9 grams/liter of pure saponin and a concentration between about 3 grams/liter to about 9 grams/liter of pure caffeine, a concentration between about 3 grams/liter to about 8 grams/liter of pure saponin and a concentration between about 3 grams/liter to about 8 grams/liter of pure caffeine, a concentration between about 3 grams/liter to about 7 grams/liter of pure saponin and a concentration between about 3 grams/liter to about 7 grams/liter of pure caffeine, a concentration between about 3 grams/liter to about 6 gram/liter of pure saponin and a concentration between about 3 grams/liter to about 6 grams/liter of pure caffeine, a concentration between about 3 grams/liter to about 5 grams/liter of pure saponin and a concentration between about 3 grams/liter to about 5 grams/liter of pure caffeine, a concentration between about 3 grams/liter to about 5 grams/liter of pure saponin and a concentration between about 3 grams/liter to about 4 grams/liter of pure caffeine, a concentration between about 5 grams/liter to about 10 grams/liter of pure saponin and a concentration between about 5 grams/liter to about 10 grams/liter of pure caffeine, a concentration between about 5 grams/liter to about 9 grams/liter of pure saponin and a concentration between about 5 grams/liter to about 9 grams/liter of pure caffeine, a concentration between about 5 grams/liter to about 8 grams/liter of pure saponin and a concentration between about 5 grams/liter to about 8 grams/liter of pure caffeine, or a concentration between about 5 grams/liter to about 7 grams/liter of pure saponin and a concentration between about 5 grams/liter to about 7 grams/liter of pure caffeine.

In some aspects, the molluscicide composition comprises pure saponin and pure caffeine, wherein the concentration of pure saponin is between about 0.1 grams/liter to about 15 grams/liter and the concentration of pure caffeine is between about 0.1 grams/liter to about 15 grams/liter, and wherein the pure saponin and the pure caffeine act synergistically as molluscicides. In some aspects, the molluscicide composition comprises pure saponin and pure caffeine, wherein the concentration of pure saponin is between about 2 grams/liter to about 12 grams/liter and the concentration of pure caffeine is between about 2 grams/liter to about 12 grams/liter, and wherein the pure saponin and the pure caffeine act synergistically as molluscicides. In some aspects, the molluscicide composition comprises pure saponin and pure caffeine, wherein the concentration of pure saponin is between about 3 grams/liter to about 10 grams/liter and the concentration of pure caffeine is between about 3 grams/liter to about 10 grams/liter, and wherein the pure saponin and the pure caffeine act synergistically as molluscicides. In some aspects, the molluscicide composition comprises pure saponin and pure caffeine, wherein the concentration of pure saponin is about 7 grams/liter and the concentration of pure caffeine is about 7 grams/liter, and wherein the pure saponin and the pure caffeine act synergistically as molluscicides.

In some aspects, the molluscicide composition comprises (A) a saponin-containing plant extract (e.g., a saponin-containing plant extract from Sapindus saponaria), and (B) a caffeine-containing plant extract (e.g., a caffeine-containing plant extract from a coffee plant) in a weight ratio of (A):(B), for example, between 100:1 to 1:100, between 100:1 to 1:75, between 100:1 to 1:50, between 100:1 to 1:25, between 100:1 to 1:10, between 100:1 to 1:5, between 100:1 to 1:1, between 75:1 to 1:75, between 75:1 to 1:50, between 75:1 to 1:25, between 75:1 to 1:10, between 75:1 to 1:5, between 75:1 to 1:1, between, 50:1 to 1:50, between 50:1 to 1:10, between 50:1 to 1:5, between 50:1 to 1:1, between 15:1 to 1:15, between 15:1 to 1:10, between 15:1 to 1:5, between 15:1 to 1:1, between 10:1 to 1:10, between 10:1 to 1:5, between 10:1 to 1:1, between 5:1 to 1.1 or combinations thereof, wherein the saponin-containing plant extract and the caffeine-containing plant extract act synergistically as molluscicides. In some aspects, the molluscicide composition comprises (A) a saponin-containing plant extract (e.g., a saponin-containing plant extract from Sapindus saponaria), and (B) a caffeine-containing plant extract (e.g., a caffeine-containing plant extract from a coffee plant) in a weight ratio of (A):(B) between 20:1 to 1:20, wherein the saponin-containing plant extract, and the caffeine-containing plant extract act synergistically as molluscicides. In some aspects, the molluscicide composition comprises (A) a saponin-containing plant extract (e.g., a saponin-containing plant extract from Sapindus saponaria), and (B) a caffeine-containing plant extract (e.g., a caffeine-containing plant extract from a coffee plant) in a weight ratio of (A):(B) between 15:1 to 1:15, wherein the saponin-containing plant extract, and the caffeine-containing plant extract act synergistically as molluscicides. In some aspects, the molluscicide composition comprises (A) a saponin-containing plant extract (e.g., a saponin-containing plant extract from Sapindus saponaria), and (B) a caffeine-containing plant extract (e.g., a caffeine-containing plant extract from a coffee plant) in a weight ratio of (A):(B) about 1:14, wherein the saponin-containing plant extract and the caffeine-containing plant extract act synergistically as molluscicides.

In some aspects, the molluscicide composition comprises (A) a saponin-containing plant extract (e.g., a saponin-containing plant extract from Sapindus saponaria), and (B) pure caffeine in a weight ratio of (A):(B), for example, between 100:1 to 1:100, between 100:1 to 1:75, between 100:1 to 1:50, between 100:1 to 1:25, between 100:1 to 1:10, between 100:1 to 1:5, between 100:1 to 1:1, between 75:1 to 1:75, between 75:1 to 1:50, between 75:1 to 1:25, between 75:1 to 1:10, between 75:1 to 1:5, between 75:1 to 1:1, between, 50:1 to 1:50, between 50:1 to 1:10, between 50:1 to 1:5, between 50:1 to 1:1, between 15:1 to 1:15, between 15:1 to 1:10, between 15:1 to 1:5, between 15:1 to 1:1, between 10:1 to 1:10, between 10:1 to 1:5, between 10:1 to 1:1, between 5:1 to 1.1 or combinations thereof, wherein the saponin-containing plant extract and the pure caffeine act synergistically as molluscicides.

In some aspects, the molluscicide composition comprises (A) a saponin-containing plant extract (e.g., a saponin-containing plant extract from Sapindus saponaria), and (B) pure caffeine in a weight ratio of (A):(B) between 20:1 to 1:20, wherein the saponin-containing plant extract and the pure caffeine act synergistically as molluscicides. In some aspects, the molluscicide composition comprises (A) a saponin-containing plant extract (e.g., a saponin-containing plant extract from Sapindus saponaria) and (B) pure caffeine in a weight ratio of (A):(B) between 15:1 to 1:15, wherein the saponin-containing plant extract and the pure caffeine act synergistically as molluscicides. In some aspects, the molluscicide composition comprises (A) a saponin-containing plant extract (e.g., a saponin-containing plant extract from Sapindus saponaria) and (B) pure caffeine in a weight ratio of (A):(B) about 1:14, wherein the saponin-containing plant extract and the pure caffeine act synergistically as molluscicides.

In some aspects, the molluscicide composition comprises (A) pure saponin and (B) a caffeine-containing plant extract (e.g., a caffeine-containing plant extract from a coffee plant) in a weight ratio of (A):(B), for example, between 100:1 to 1:100, between 100:1 to 1:75, between 100:1 to 1:50, between 100:1 to 1:25, between 100:1 to 1:10, between 100:1 to 1:5, between 100:1 to 1:1, between 75:1 to 1:75, between 75:1 to 1:50, between 75:1 to 1:25, between 75:1 to 1:10, between 75:1 to 1:5, between 75:1 to 1:1, between, 50:1 to 1:50, between 50:1 to 1:10, between 50:1 to 1:5, between 50:1 to 1:1, between 15:1 to 1:15, between 15:1 to 1:10, between 15:1 to 1:5, between 15:1 to 1:1, between 10:1 to 1:10, between 10:1 to 1:5, between 10:1 to 1:1, between 5:1 to 1.1 or combinations thereof, wherein the pure saponin and the caffeine-containing plant extract act synergistically as molluscicides. In some aspects, the molluscicide composition comprises (A) pure saponin and (B) a caffeine-containing plant extract (e.g., a caffeine-containing plant extract from a coffee plant) in a weight ratio of (A):(B) between 20:1 to 1:20, wherein the pure saponin and the caffeine-containing plant extract act synergistically as molluscicides. In some aspects, the molluscicide composition comprises (A) pure saponin and (B) a caffeine-containing plant extract (e.g., a caffeine-containing plant extract from a coffee plant) in a weight ratio of (A):(B) between 15:1 to 1:15, wherein the pure saponin and the caffeine-containing plant extract act synergistically as molluscicides. In some aspects, the molluscicide composition comprises (A) pure saponin and (B) a caffeine-containing plant extract (e.g., a caffeine-containing plant extract from a coffee plant) in a weight ratio of (A):(B) about 1:14, wherein the pure saponin and the caffeine-containing plant extract act synergistically as molluscicides.

In some aspects, the molluscicide composition comprises (A) pure saponin and (B) pure caffeine in a weight ratio of (A):(B), for example, between 100:1 to 1:100, between 100:1 to 1:75, between 100:1 to 1:50, between 100:1 to 1:25, between 100:1 to 1:10, between 100:1 to 1:5, between 100:1 to 1:1, between 75:1 to 1:75, between 75:1 to 1:50, between 75:1 to 1:25, between 75:1 to 1:10, between 75:1 to 1:5, between 75:1 to 1:1, between, 50:1 to 1:50, between 50:1 to 1:10, between 50:1 to 1:5, between 50:1 to 1:1, between 15:1 to 1:15, between 15:1 to 1:10, between 15:1 to 1:5, between 15:1 to 1:1, between 10:1 to 1:10, between 10:1 to 1:5, between 10:1 to 1:1, between 5:1 to 1.1 or combinations thereof, wherein the pure saponin and the pure caffeine act synergistically as molluscicides. In some aspects, the molluscicide composition comprises (A) pure saponin and (B) pure caffeine in a weight ratio of (A):(B) between 20:1 to 1:20, wherein the pure saponin and the pure caffeine act synergistically as molluscicides. In some aspects, the molluscicide composition comprises (A) pure saponin and (B) pure caffeine in a weight ratio of (A):(B) between 15:1 to 1:15, wherein the pure saponin and the pure caffeine act synergistically as molluscicides. In some aspects, the molluscicide composition comprises (A) pure saponin and (B) pure caffeine in a weight ratio of (A):(B) about 1:14, wherein the pure saponin and the pure caffeine act synergistically as molluscicides.

In a specific aspect, the molluscicide composition comprises:
(a) a saponin-containing plant extract from Sapindus saponaria, wherein the saponin-containing plant extract comprises hederagenin-derived saponins, and wherein the saponins are about 25% of the dry weight of the saponin-containing plant extract; and
(b) a caffeine-containing plant extract obtained from a coffee plant, wherein the coffee plant is a member of the genus Coffea, and wherein the caffeine content in the caffeine-containing plant extract is at least about 97% (i.e., it is at least about 97% pure),
wherein the saponin-containing plant extract and the caffeine-containing plant extract act synergistically as molluscicides.

### 3. METHODS OF MAKING MOLLUSCICIDE COMPOSITIONS COMPRISING SAPONINS AND CAFFEINE

The instant disclosure also provides methods of making molluscicide compositions comprising saponins (e.g., from plant origin, synthetic, or semisynthetic) and caffeine (e.g., from plant origin, synthetic, or semisynthetic), wherein the saponins and caffeine function synergistically as molluscicides.

Saponins can be extracted from saponin-containing plants by a number of methods known in the art, e.g. water-alcohol extraction. See e.g., Majinda, Methods Mol. Biol. 864:415-426 (2012); Zhao, et al., Asian Journal of Traditional Medicines 7(1):14-17 (2012); U.S. Publication No. 346972 A. In some aspects, the saponin-containing plant extract (e.g., a saponin-containing plant extract from Sapindus saponaria) contains saponins derived under any of the methods in the cited references (e.g., hederagenin-derived) or other forms generally known in the art. See e.g., U.S. Pat. Nos. 8,298,590; 3,464,972; Odell, et al., Biological Sciences, 5-9 (1965). Saponin content in plant extracts can be determined, e.g., by bioassay, by gas liquid chromatography analysis, or any method known in the art. See e.g., Ridout et al., J. Sci. Food Agric. 54:165-176 (1991).

Caffeine extracted from a caffeine-containing plant can be extracted by a number of different methods known in the art. See e.g., U.S. Pat. Nos. 4,255,458, 4,411,923, 4,364,965, King, et al., “Extraction of Natural Products Using Near Critical Solvents,” New York, N.Y.: Chapman and Hall (1993), and Pavia, et al., “Introduction to Organic Laboratory Techniques: A Small Scale Approach,” New York, N.Y.: Thomson (2005).

In some aspects, the saponin-containing plant extracts (e.g., a saponin-containing plant extract from Sapindus saponaria) and/or the caffeine-containing plant extracts (e.g., a caffeine-containing plant extract from a coffee plant) disclosed herein can be obtained using extraction methods using a polar solvent. In some aspects, the polar solvent is water. In some aspects, the saponin-containing plant (e.g., a saponin-containing plant extract from Sapindus saponaria) and/or the caffeine-containing plant extract (e.g., a caffeine-containing plant extract from a coffee plant) can be obtained using extraction methods using an organic solvent. In some aspects, the organic solvent is water miscible. In some aspects, the organic solvent is not water miscible.

In some aspects, the solvents used in the extraction process are, for example, acetic acid, acetone, acetonitrile, benzene, 1-butanol, 2-butanol, 3-butanone, t-butyl alcohol, carbon tetrachloride, chlorobenzene, chloroform, cyclohexane, 1,2-dichloroethane, diethyl ether, diethylene glycol, dimethylether, dioxane, ethyl acetate, ethylene glycol, glycerin, heptane, hexane, methanol, methyl t-butyl ether, pentane, toluene, triethyl amine, o-xylene, m-xylene, p-xylene, pentane, cyclopentane, cyclohexane, 1,4-dioxane, dichloromethane, tetrahydrofuran, dimethylformamide, dimethyl sulfoxide, propylene carbonate, formic acid, n-butanol, isopropanol, n-propanol, ethanol, nitromethane, water or any combination thereof.

In some aspects, the saponin-containing plant extract can obtained by using extraction methods known in the art (e.g., liquid extraction) using a combination of water and, for example, at least one, at least two, at least three, at least four organic solvents. In some aspects, the saponin-containing plant extract (e.g., a saponin-containing plant extract from Sapindus saponaria) can be obtained by using one extraction method. In some aspects, the saponin-containing plant extract (e.g., a saponin-containing plant extract from Sapindus saponaria) can be obtained by using sequentially more than one extraction method. In some aspects, the sequential extraction methods are all of the same extraction method, e.g., the plant material can be extracted with water in combination with one or more organic solvents (e.g., ethanol or methanol), and after removing the solvent, the remaining plant material can be re-extracted with the same solvent mixture. In other aspects, the saponin-containing plant extract (e.g., a saponin-containing plant extract from Sapindus saponaria) can be obtained using sequentially different extraction methods. In some aspects, the saponin-containing plant extract (e.g., a saponin-containing plant extract from Sapindus saponaria) can be obtained using at least one extraction method that is different than all of the other extraction methods. In other aspects, the saponin-containing plant extract (e.g., a saponin-containing plant extract from Sapindus saponaria) can be obtained, for example, using a water-alcohol extraction method. In some aspects, the alcohol in the water-alcohol extraction method is selected from the group consisting of methanol, ethanol, isopropanol, or combinations thereof. In some particular aspects, the alcohol in the water-alcohol extraction method is methanol. In specific aspects, the saponin-containing plant extract used in the compositions and methods disclosed herein is a water-alcohol extract from Sapindus saponaria.

In some specific aspects, the saponin-containing plant extract for use in the compositions disclosed herein is obtained by water-alcohol extraction from Sapindus saponaria, wherein the saponin-containing plant extract comprises hederagenin-derived saponins. In some aspects, the saponins are about 25% of the dry weight of the saponin-containing plant extract.

In some aspects, the caffeine-containing plant extract can be obtained by using extraction methods known in the art (e.g., liquid extraction) using a combination of water and, for example, at least one, at least two, at least three, at least four organic solvents. In some aspects, the caffeine-containing plant extract (e.g., a caffeine-containing plant extract from a coffee plant) can be obtained by using one extraction method. In some aspects, the caffeine-containing plant extract (e.g., a caffeine-containing plant extract from a coffee plant) can be obtained by using sequentially more than one extraction method. In some aspects, the sequential extraction methods are all of the same extraction method, e.g., the plant material can be extracted with water in combination with one or more organic solvents (e.g., ethanol or methanol), and after removing the solvent, the remaining plant material can be re-extracted with the same solvent mixture. In other aspects, the caffeine-containing plant extract (e.g., a caffeine-containing plant extract from a coffee plant) can be obtained using sequentially different extraction methods. In some aspects, the caffeine-containing plant extract (e.g., a caffeine-containing plant extract from a coffee plant) can be obtained using at least one extraction method that is different than all of the other extraction methods. In other aspects, the caffeine-containing plant extract (e.g., a caffeine-containing plant extract from a coffee plant) can be obtained, for example, using a water-alcohol extraction method. In some aspects, the alcohol in the water-alcohol extraction method is selected from the group consisting of methanol, ethanol, isopropanol, or combinations thereof. In some particular aspects, the alcohol in the water-alcohol extraction method is methanol. In specific aspects, the caffeine-containing plant extract used in the compositions and methods disclosed herein is a water-alcohol extract from Coffea ssp.

In some aspects, the caffeine-containing plant extract (e.g., a caffeine-containing plant extract from a coffee plant) can be obtained, for example, using a liquid-liquid extraction method. A liquid-liquid extraction method is the extraction of a substance from one liquid phase to another liquid phase. In some aspects, the liquid-liquid extraction method comprises, for example, water and an organic solvent. In some aspects, the organic solvent is, for example, methanol, ethanol, isopropanol, methyl acetate, ethyl acetate, isopropyl acetate, n-butyl acetate, isobutyl acetate, acetone, methyl ethyl ketone, methyl isobutyl ketone, dibutyl ether, anisole, toluene, heptane, supercritical CO₂, or combinations thereof. In some aspects, liquid-liquid extraction method comprises ethyl acetate.

In some specific aspects, the caffeine-containing plant extract for use in the compositions disclosed herein is obtained by liquid-liquid extraction from a coffee plant, wherein the coffee plant is a member of the genus Coffea. In some aspects, caffeine-containing plant extract is at least about 97% pure.

Other materials used in the manufacture of the compositions disclosed herein, e.g., the production and purification of pure saponins, or the production and purification of pure caffeine are known in the art.

### 4. FORMULATIONS COMPRISING MOLLUSCICIDE COMPOSITIONS COMPRISING SAPONINS AND CAFFEINE

The present disclosure also provides formulations comprising molluscicide compositions comprising saponins (e.g., from plant origin, synthetic, or semisynthetic) and caffeine (e.g., from plant origin, synthetic, or semisynthetic), wherein the saponins and caffeine function synergistically as molluscicides.

In a specific aspect, the formulations disclosed herein comprise a molluscicide composition comprising:
(a) a saponin-containing plant extract from Sapindus saponaria, wherein the saponin-containing plant extract comprises hederagenin-derived saponins, and wherein the saponins are about 25% of the dry weight of the saponin-containing plant extract; and
(b) a caffeine-containing plant extract obtained from a coffee plant, wherein the coffee plant is a member of the genus Coffea, and wherein the caffeine content in the caffeine-containing plant extract is at least about 97% (i.e., it is at least about 97% pure),
wherein the saponin-containing plant extract and the caffeine-containing plant extract act synergistically as molluscicides.

Numerous molluscicide formulations for both terrestrial and aquatic environments, e.g., to control populations of mollusks are known in the art. See e.g., WO2000011948A1, WO2000015033A1, WO2006026698A1, WO2012045682A1, WO1986001076A1, WO2002034046A1, WO1992022205A1, WO2014016640A1, WO2009048345A1, US20060045898, US20020010156, US20130129804, US20100129338, US20130287749, U.S. Pat. No. 2,363,852, U.S. Pat. No. 6,384,082, and EP2237668B1.

In some aspects, the molluscicide compositions disclosed herein comprise saponins (e.g., saponins from a saponin-containing plant extract from Sapindus saponaria) and caffeine (e.g., caffeine from caffeine-containing plant extract from a coffee plant), and further comprise excipients. The molluscicide compositions disclosed herein can comprise any of the excipients disclosed in the cited references, other molluscicidally acceptable excipients known in the art, and combinations thereof. Accordingly, in some aspects, the molluscicide composition comprises a saponin-containing plant extract (e.g., an extract from Sapindacea) and a caffeine-containing plant extract from a different plant (e.g., from a coffee plant), and further comprises excipients.

In some aspects, the excipients include, for example, acacia gum, acacia gum modified with ocetenyl succinic anhydride, acetylated monoclycerides, acetylated tartaric acid esters of mono- and di-glycerides, agar, algin, alginic acid, ammonium alginate, ammonium carrageenan, ammonium furcelleran, ammonium salt of phosphorylated glyceride, arabino-galactan, baker's yeast glycan, calcium alginate, calcium carbonate, calcium carrageenan, calcium citrate, calcium furcelleran, calcium gluconate, calcium glycerophosphate, calcium hypophosphite, calcium lignosulphonate, calcium phosphate, calcium sulphate, calcium tartrate, carboxymethyl cellulose, carob bean gum, carrageenan, cellulose gum, citric acid esters of mono- and di-glycerides, gurcelleran, gelatin, gellan gum, guar gum, gum Arabic, hydroxylated lecithin, hydroxypropyl cellulose, irish moss gelose, karaya gum, lactylated mono- and di-glycerides, lactylic esters of fatty acids, lecithin, locust bean gum, magnesium chloride, methylcellulose, methyl ethyl cellulose, monoglycerides, mono- and di-glycerides, monosodium salts of phosphorylated mono- and di-glycerides, oat gum, pectin, polyglycerol esters of interesterified castor oil fatty acids, polyoxyethylene, sorbitan monooleate, polyoxyethylene, sorbitan monostearate, polyoxyethylene, sorbitan tristearate, polyoxyethylene stearate, potassium alginate, potassium carrageenan, potassium chloride, potassium citrate, potassium furcelleran, potassium phosphate (dibasic), propylene glycerol alginate, propylene glycol ether of methylcellulose, propylene glycol mono fatty acid esters, sodium acid pyrophosphate, sodium alginate, sodium aluminum phosphate, sodium carboxymethyl cellulose, sodium carrageenan, sodium cellulose glycolate, sodium chloride, sodium citrate, sodium furcelleran, sodium gluconate, sodium hexametaphosphate, sodium phosphate (dibasic), sodium phosphate (monobasic), sodium phosphate (tribasic), sodium potassium tartrate, sodium pyrophosphate (tetrabasic), sodium stearoyl-2-lactylate, sodium stearate, sodium tartrate, sodium tripolyphosphate, sorbitan monostearate, sorbitan trioleate, sorbitan tristearate, stearyl monoglyceridyl citrate, sucrose esters of fatty acids, tragacanth gum, xanthan gum, calcium silicate, belite calcium orthosilicate, grammite, micro-cell, silene, silicic acid calcium salt, and combinations thereof. In some aspects, the excipient is calcium lignosulphonate. In some aspects, the excipient is carboxymethyl cellulose. In some aspects, the excipient is sodium chloride. In some aspects, the excipient is calcium silicate. In some aspects, the use of excipients in a molluscicide composition is for the purpose other than the molluscicide effect, for example, a stabilizing compound, a buffering compound, an emulsifying compound, a bulking agent or a combination thereof.

The molluscicide compositions disclosed herein can be formulated in any of the formats disclosed in the cited references (e.g., granules, pellets, etc.) or other forms generally known in the art.

In some aspects, the molluscicide compositions disclosed herein can be formulated in a solid form. In some aspects, the solid form comprises, for example, powder, pellet, or granule formulations. In some aspects, the powder, pellet, or granule formulations are dispersible. In some aspects, the dispersible powder, pellet, or granule formulations are water-dispersible. In some aspects, the solid form formulation is, for example, a pellet, a granule, a powder, a dry flowable, a bait, dust, a nanoencapsulated formulation, a microencapsulated formulation, or a combination thereof. In some aspects, the powder formulations are wettable powder formulations.

In some aspects, the molluscicide compositions disclosed herein can be formulated in liquid form. In some aspects, the liquid form is, for example, a liquid concentrate formulation, an emulsifiable concentrate, an emulsion, a suspension, a liquid flowable, a gel, a ready-to-use formulation, an oil dispersion, an aerosol formulation, or combinations thereof. In some aspects, the liquid concentrate is an ultra-low-volume concentrate formulation. In some aspects, the liquid formulations disclosed herein are emulsifiable concentrates (EC), emulsions in water (EW), or oil dispersions (OD).

In some aspects, the emulsifiable concentrate (EC) contains an organic solvent and a surfactant in addition to the active ingredients. In some aspects, the liquid formulation is an emulsion in water (EW).

In some aspects, the organic solvent can be replaced by an oil (e.g., vegetable or mineral), lowering the volatilization of volatile compounds—VOC—and reducing the risks of phytotoxicity and flammability. These formulations are known as Oil dispersions (OD). In some aspects, the OD formulation uses an oil, for example, a vegetable oil as solvent. In some aspects, the OD formulation comprises additional components, e.g., co-solvents with high polarity and/or adjuvants. In some aspects, such co-solvents and/or adjuvants confer sticky (adhering) properties to the sprayed plants.

In some aspects, the EC, EW and OD formulations disclosed herein can maintain the active ingredients in solution in a temperature range from about −20° C. to 70° C. In other aspects, the EC, EW and OD formulations disclosed herein can maintain the active ingredients in solution in a temperature range from about −10° C. to 54° C. In some aspects, EC, EW and OD formulations disclosed herein can maintain the active ingredients without aggregation (e.g., crystallization) in a temperature range from about −20° C. to 70° C. In other aspects, EC, EW and OD formulations disclosed herein can maintain the active ingredients without aggregation (e.g., crystallization) in a temperature range from about −10° C. to 54° C.

In some aspects, EC, EW and OD formulations disclosed herein can maintain the active ingredients without aggregation (e.g., crystallization) at about −20° C., about −18° C., about −16° C., about −14° C., about −12° C., about −10° C., about −8° C., about −6° C., about −4° C., about −2° C., about 0° C., about 2° C., about 5° C., about 10° C., about 15° C., about 20° C., about 25° C., about 30° C., about 35° C., about 40° C., about 45° C., about 50° C., about 55° C., about 60° C., about 65° C. or about 70° C.

In some aspects, EC, EW and OD formulations disclosed herein can maintain the active ingredients in solution at about −20° C., about −18° C., about −16° C., about −14° C., about −12° C., about −10° C., about −8° C., about −6° C., about −4° C., about −2° C., about 0° C., about 2° C., about 5° C., about 10° C., about 15° C., about 20° C., about 25° C., about 30° C., about 35° C., about 40° C., about 45° C., about 50° C., about 55° C., about 60° C., about 65° C. or about 70° C.

In some aspects, the EC, EW and OD formulations disclosed herein comprise a caffeine-containing plant extract obtained from a coffee plant (Coffea sp.) wherein the concentration of caffeine is between 25% and 99%. In other aspects, the concentration of caffeine is between 60% and 95%. In some aspects, the concentration of caffeine is about 10%, about 15%, about 20%, about 25%, about 30%, about 35%, about 40%, about 45%, about 50%, about 55%, about 60%, about 65%, about 70%, about 75%, about 80%, about 85%, about 90%, about 95%, about 97%, or about 99%.

In some aspects, the EC, EW and OD formulations disclosed herein comprise a saponin-containing plant extract obtained from a Sapindus plant (e.g., S. saponaria) wherein the concentration of saponins is between 10% and 99%. In other aspects, the concentration of saponins is between 20% and 80%. In some aspects, the concentration of saponins is about 10%, about 15%, about 20%, about 25%, about 30%, about 35%, about 40%, about 45%, about 50%, about 55%, about 60%, about 65%, about 70%, about 75%, about 80%, about 85%, about 90%, about 95%, about 97%, or about 99%.

Exemplary EW formulations are disclosed in TABLE 1.

TABLE 1
Example of Emulsions in water (EW) formulations

| Ingredient | Percentage | Function |
|---|---|---|
| Coffea sp. Extract | 5-30% | Active ingredient |
| Sapindus saponaria extract | 0.1-5% | Active ingredient |
| Sodium chloride | 0.1-2% | Inert |
| Carboxymethyl cellulose | 0.1-0.5% | Stabilizer |
| (CMC-Na and/or CMC) | | |
| Sodium benzoate | 0-10% | Preservative |
| Citric acid | 0-10% | Preservative |
| Water | 42.5-94% | Solvent |

The trade names presented in TABLES 2, 3, 4, 6, 7 and 8 are not limiting and are provided only as examples corresponding to the chemical families presented in the right column of each table. In other words, the disclosure of Alkamuls T/85-V as an ethoxylated sorbitan trioleate in TABLE 2 does not mean that Alkamuls T/85-V is the only ethoxylated sorbitan trioleate contemplated for the EW formulations disclosed herein. Instead, it indicates that any ethoxylated sorbitan trioleate can be used in the EW compositions disclosed herein, and that in specific formulations such ethoxylated sorbitan trioleate could be Alkamuls T/85-V. The same interpretation would apply to every single entry in TABLES 2, 3, 4, 6, 7 and 8.

Suitable surfactants, rheology modifiers, and solvents for use in the EW formulations disclosed herein are shown in TABLES 2, 3, and 4, respectively.

TABLE 2
Surfactants for use in EW formulations

| Trade name | Chemical family |
|---|---|
| Alkamuls 14/R | Ethoxylated Castor Oils |
| Alkamuls B | Ethoxylated Castor Oils |
| Alkamuls BR | Ethoxylated Castor Oils |
| Alkamuls OR/36 | Ethoxylated Castor Oils |
| Alkamuls T/80 | Ethoxylated Sorbitan monooleate |
| Alkamuls T/85-V | Ethoxylated Sorbitan trioleate |
| Geronol FF/4 | Blend Nonionics + Anionic |
| Geronol FF/6 | Blend Nonionics + Anionic |
| Geronol M0E/02-K | Blend Nonionics + Anionic |
| Geronol MS | Blend Nonionics + Anionic |
| Geronol RE/70 | Blend Nonionics + Anionic |
| Rhodacal 60/BE | Dodecylbenzene (linear) Sulphonate Ca |
| Rhodacal 70 | Dodecylbenzene (branched) Sulphonate Ca |
| Rhodacal 70/B | Dodecylbenzene (linear) Sulphonate Ca |
| Rhodasurf ROX | Ethoxylated Alcohol |
| Soprophor BSU | Ethoxylated TSP |
| Soprophor CY/8 | Ethoxylated TSP |
| Soprophor S/25 | Ethoxylated TSP |
| Soprophor TS/10 | Ethoxylated TSP |
| Tween 20 | Polysorbate 20 |
| Tween 80 | Polysorbate |
| Tween 85 | Polysorbate |
| Span 20 | Sorbitan laurate |
| Span 80 | Sorbitane monooleate |
| Span 85 | Sorbitan stearate |

TABLE 3
Rheology modifiers for use in EW formulations

| Trade name | Chemical family |
|---|---|
| Rheozan | Succinoglycan gum |
| Rhodopol 23 | Xanthan gum |
| Rhodopol 50 MC | Xanthan gum |
| Rhodopol 50 MD | Xanthan gum |
| Rhodopol G | Xanthan gum |
| Carboximethyl cellulose | CMC |
| Carboximethyl cellulose Sodium Salt | CMc + Na |

TABLE 4
Solvents for use in EW formulations

| Trade name | Chemical family |
|---|---|
| Acetophenone | Phenyl Methyl Ketone |
| Amesolv ADMA 10 | N,N-Diemethyl decanamide |
| Amesolv ADMA 810 | N,N-Dimethyl octanamide and |
| | N,N-Diemethyl decanamide |
| Amoil BH | Rapeseed Oil refined |
| Amoil Sun F | Sunflower Oil refined |
| Corn Oil | Corn Oil refined |
| Dimethylsulphoxide | Dimethylsulphoxide |
| Phytorob 810.01 | Methyl Ester C8-C10 |
| Phytorob 926.65 | Methyl Oleate |
| Propylene Carbonate | Propylene Carbonate |
| Rhodiasolv Green 21 | Solvents mixture |
| Rhodiasolv Green 25 | Solvents mixture |
| Soja Oil | Soybean Oil refined |
| Glycerine | Glycerine |

Exemplary OD formulations are disclosed in TABLE 5.

TABLE 5
Example of Oil dispersion (OD) formulations

| Ingredient | Percentage | Function |
|---|---|---|
| Coffea sp. Extract | 5-30% | Active ingredient |
| Sapindus saponaria extract | 0.1-5% | Active ingredient |
| Wintergreen Oil (sticky adjuvant) | 1-15% | Stabilizer, adjuvant |
| Glycerin, ethylene glycol, | 1-15% | Stabilizer, adjuvant |
| isopropanol, butanol or others. | | |
| Tween | 5-15% | Emulsifier, surfactant |
| Sodium benzoate | 0-10% | Preservative |
| Oil | 10%-87.9% | Solvent |

Suitable surfactants, rheology modifiers, and solvents for use in the OD formulations disclosed herein are shown in TABLES 6, 7, and 8, respectively.

TABLE 6
Surfactants for use in OD formulations

| Trade name | Chemical family |
|---|---|
| Alkamuls VO/2003 | Ethoxylated Fatty Acids |
| Rhodasurf LA/30 | Ethoxylated Alcohol |
| Rhodasurf LA/40 | Ethoxylated Alcohol |
| Tween 20 | Polysorbate 20 |
| Tween 80 | Polysorbate 80 |
| Tween 85 | Polysorbate 85 |
| Span 20 | Sorbitan laurate |
| Span 80 | Sorbitane monooleate |
| Span 85 | Sorbitan stearate |

TABLE 7
Rheology modifiers for use in OD formulations

| Trade name | Chemical family |
|---|---|
| Attagel 40 | Attapulgite gelling grade |
| Bentonite AG/8 | Montmorillonite and other Al-silicates |

TABLE 8
Solvents for use in OD formulations

| Trade name | Chemical family |
|---|---|
| oil BH | Rapeseed Oil refined |
| Amoil Sun F | Sunflower Oil refined |
| Corn Oil | Corn Oil refined |
| Phytorob 810.01 | Methyl Ester C8-C10 |
| Phytorob 926.65 | Methyl Oleate |
| Soja Oil | Soybean Oil refined |
| Canola oil | Canola oil |
| Glycerine | Glycerine |

In some aspects, the molluscicide compositions disclosed can further comprise a carrier. In some aspects, the carrier is, for example, a neutral carrier edible for mollusks. In some aspects, the neutral carrier edible for mollusks is, for example, a composition of substances of vegetable origin, animal origin, a mixture of dried vegetables, raw vegetables, fresh vegetables, porky greaves, osseous meal, sugar, egg powder, plant grains, or a combination thereof. In some aspects, the plant grains are wheaten bruised grain, whole grain, corn bruised grain, or combinations thereof. In some aspects, the carrier further comprises, for example, a dye, a pigment, a safety additive agent, an attractant, bait, an agent improving rain-resistance, or combinations thereof.

The term “bait” as used herein includes products readily consumed by mollusks. In some aspects, the bait is, for example, agar, potato dextrose agar, sugar beet, gelatin, oil cake, pet food, wheat, soya, oats, corn, rice, fruits, fish by-products, sugars, coated vegetable and cereal seeds, casein, blood meal, bone meal, yeast, paper products, clays, fats, a variety of cereals, including wheat cereal or combinations thereof. A molluscicide can be comprised of a bait edible for mollusk. See e.g., Garavano, et al., “RIA, 39 (1):1-13 (2013).

Baits, in general, are agrochemical formulation, in which the active ingredient is mixed with some inert substances with attractant effect, such as food, syrups, and pheromones among others. This kind of formulations can be solids, liquids, gels or arranged physical traps, however for mollusks solid baits are preferred, for this is important to elaborate pellets, small uniform granules, containing an attractant material and adding the active ingredients, this pellets should be prepared in small size, in order to allow the mollusk's ingestion.

In the present invention a number of pellets with molluscicidal effect have been elaborated, containing as active ingredients Coffea sp. Extract and Sapindus saponaria extract, both in free form and encapsulated (capsules, microcapsules and nanocapsules), dispersed into an attractive agent suitable for slugs and a filler component, which could be prepared using flour from different origins, such as oats, wheat, beans, soybeans, chickpeas and other cereals and legumes, a mineral or vegetal oil could be added to avoid water inside the pellet. Exemplary molluscicide pellet formulations are disclosed in TABLE 9.

TABLE 9
Molluscicide pellet formulations

| Ingredient | Percentage | Function |
|---|---|---|
| Coffea sp. Extract | 5-30% | Active ingredient |
| Sapindus Saponaria extract | 0.1-5% | Active ingredient |
| Sodium chloride | 0-2% | Inert |
| Lettuce extract or oil | 0.1-0.5% | Attractant |
| Brassicas extract | 0.1-0.5% | Attractant |
| Vegetable oil | 0-2% | Water repellent* |
| Flour | 62-92.6% | Binder** |

*Vegetable oil can be, e.g., from soybeans, canola, castor, etc. or an ester of a long chain acid level. Mineral oils could also be used.
**Flour as raw material for the production of pellets can come from grains such as wheat, oats, chickpeas, lentils, etc.

In some aspects, the molluscicide formulations disclosed herein comprise saponins (e.g., saponins from a saponin-containing plant extract from Sapindus saponaria) and caffeine (e.g., caffeine from caffeine-containing plant extract from a coffee plant), and additional products such as inert components, attractants, water repellents, binders, preservatives, surfactants, rheology modifiers, emulsifiers, adjuvants, stabilizers, or combinations thereof. In some aspects, a product added to the active ingredients (saponin-containing plant extract, and caffeine containing plant extract) in a molluscicide formulation disclosed herein can have multiple functions, e.g., glycerin can function as both stabilizer and adjuvant, or Tween can function as both emulsifier and surfactant.

### 5. METHODS OF USE OF MOLLUSCICIDE COMPOSITIONS COMPRISING SAPONINS AND CAFFEINE

The present disclosure also provides methods to control, prevent, or treat mollusk infestation by using any of the compositions disclosed herein, and combinations thereof. The compositions and formulations disclosed herein can also be used to as repellants. The molluscicide compositions disclosed herein can act by contact, by ingestion, or simultaneously by both mechanisms of action. The disclosed compositions can have toxic effects, i.e., the can interfere with the mollusk nervous system once they make contact with the mollusk's tissue or when treated plant tissue is ingested by the mollusk. The disclosed compositions can also act as anti-feedants, i.e., the disclosed compositions can prevent damage cause by feeding on plant tissue (e.g., leaves, fruits, seeds, etc.) not through toxic mechanism but by discouraging mollusks from feeding on plant tissue by making it non-palatable. Thus, in some aspects, the disclosed compositions prevent damage caused by mollusks through a toxicity-based mechanism of action. In other aspects, the disclosed compositions prevent damage caused by mollusks through an anti-feeding-based mechanism of action. In other aspects, the disclosed compositions prevent damage caused by mollusks by both mechanisms of action.

In a specific aspect, the molluscicide composition used in the methods disclosed herein comprises:
(a) a saponin-containing plant extract from Sapindus saponaria, wherein the saponin-containing plant extract comprises hederagenin-derived saponins, and wherein the saponins are about 25% of the dry weight of the saponin-containing plant extract; and
(b) a caffeine-containing plant extract obtained from a coffee plant, wherein the coffee plant is a member of the genus Coffea, and wherein the caffeine content in the caffeine-containing plant extract is at least about 97% (i.e., it is at least about 97% pure),
wherein the saponin-containing plant extract and the caffeine-containing plant extract act synergistically as molluscicides.

Mollusk infestation can occur both in an agricultural, horticultural, garden, aquatic environment or any combination thereof. See e.g., U.S. App. No. 2007/0196517 A1. Accordingly, the molluscicide compositions disclosed herein can be applied, for example, in agricultural, horticultural, garden, aquatic fresh water environments, aquatic saltwater environments, or any combination thereof. In some aspects, the compositions disclosed herein can be used to control, prevent, and treat infestation by mollusks from the subclasses Pulmonata, Prosobranchia, Gymnomorpha, Opisthobranchia, or combinations thereof. In some aspects, the compositions disclosed herein can be used to control, prevent, treat infestation by mollusks from the group consisting of, for example, Helix spp., Agriolimax spp., Limax spp., Milax spp., Anion spp., Pomacea spp., Deroceras spp., or combinations thereof.

The term “treat” as used herein encompasses any beneficial effect derived from the application of a molluscicidally effective amount of any of the compositions disclosed herein, including the eradication, control, or prevention of mollusk infestations. Eradication refers to the complete removal of mollusks from a certain space or plant population. As used herein, the term “control” and grammatical variants of the term refers to actions that result in a reduction in the number of mollusks or damage caused by mollusks in a certain area after the application of a molluscicidally effective amount of any of the molluscicide compositions disclosed herein. Such actions can be for example an increase in mollusk mortality, a reduction in mollusk longevity, a reduction in mollusk reproduction rate, physiological and/or metabolic changes that reduce the ingestion rate of plant material by the mollusks, repellant effect that discourages the movement of mollusks to a certain area or their movement onto treated surfaces or their attachment to treated surfaces, etc. In some aspects, the compositions and/or formulations disclosed herein can be applied to a certain area, in the absence of a mollusk infestation, to prevent the occurrence of mollusk infestations, or to prevent mollusk re-infestations after an area has been cleared of mollusks after the application of any of the compositions disclosed herein or the application of any other molluscicide compositions known in the art.

The phrase “molluscicidally effective amount” as used herein refers to the amount of the molluscicide composition that, when ingested or sensed by mollusks, is sufficient to achieve a desired mollusk effect, e.g., killing, repelling, preventing, or any combination thereof. For example, concentrations of the compositions disclosed herein, for example, molluscicide compositions and formulations are, for example, effective for treating the infestation of mollusks in an afflicted area. The effective amount is that amount of the compositions disclosed herein, necessary and/or sufficient to perform its intended function within a mollusk, e.g., to cause expiration, to cause the mollusk to repel, to prevent the mollusk from entering, or any combination thereof. An effective amount of the composition can vary according to factors, for example, the amount of the causative agent already present in the mollusk, the weight of the mollusk, the health of the mollusk, or any combination thereof. One of ordinary skill in the art would be able to study the aforementioned factors and make a determination regarding the effective amount of the compositions without undue experimentation. In some aspects, an in vitro or in vivo assay also can be used to determine a “molluscicidally effective amount” of the compositions disclosed herein.

In some aspects, the effective amount of the compositions of the disclosure preferably eliminates at least about 10%, at least about 15%, at least about 20%, at least about 25%, at least about 30%, at least about 35%, at least about 40%, at least about 45%, at least about 50%, at least about 55%, at least about 60%, at least about 65%, at least about 70%, at least about 75%, at least about 80%, at least about 85%, at least about 90%, at least about 95%, at least about 97%, at least about 99%, or 100% of the mollusks relative to untreated areas.

In some aspects, control, prevent, and/or treat mollusk infestation is reducing the number of mollusks. In some aspects, control, prevent, and/or treat mollusk infestation is reducing the amount of mollusk damage. In some aspects, control, prevent, and/or treat mollusk infestation is reducing the number of mollusks in a certain area. In some aspects, control, prevent, and/or treat mollusk infestation is increasing the percent mollusk mortality. In some aspects, the number of mollusks is reduced by about 5%, by about 10%, by about 20%, by about 30%, by about 40%, by about 50%, by about 60%, by about 70%, by about 80%, by about 90% by about 95%, or by about 100%. In some aspects, the reduction of mollusk damage is by about 5%, by about 10%, by about 20%, by about 30%, by about 40%, by about 50%, by about 60%, by about 70%, by about 80%, by about 90% by about 95%, or by about 100%. In some aspects, the number of mollusks reduced in a certain area is about 5%, about 10%, about 20%, about 30%, about 40%, about 50%, about 60%, about 70%, about 80%, about 90% about 95%, or about 100%. In some aspects, the percent mortality of mollusks is increased by about 5%, by about 10%, by about 20%, by about 30%, by about 40%, by about 50%, by about 60%, by about 70%, by about 80%, by about 90% by about 95%, or by about 100%.

In some aspects, the method for controlling, treating, and/or preventing mollusk damage to plants according to the compositions disclosed herein is, for example, treating the plants or the locus surrounding the plants with a molluscicidally effective amount of any of the compositions disclosed herein. In some aspects, the locus surrounding the plants can be treated. Such locus can be, for example, an area of known mollusk infestation, an area of unknown mollusk infestation, an area with the potential for mollusk infestation or combinations thereof. In some aspects, the molluscicide compositions disclosed herein can be used to treat a surface, for example, soil, fresh water lakes, streams, ponds, rivers, grass, flower beds, sidewalks, driveways, crates, containers, fields, crops, pipes (e.g., cooling pipes of power plants), underwater boat surfaces, pier pillars, or combinations thereof. In some aspects, the soil adjacent to the base of a plant can be treated. In other aspects, the plant itself, for example the stems, leaves, fruits, roots, bark, flowers, etc. can be treated.

In some aspects, the molluscicide compositions disclosed herein can be administered, for example, by spreading, shaking, dispersing, scattering, distributing, strewing, scattering, throwing, casting, littering, low pressure spraying, high pressure spraying, brushing, misting, vaporizing, volatilizing, fogging, fumigating, immersing, injecting, vapor treating, pressure treating, drenching, drip irrigating, atomizing, broadcasting, foaming, or combinations thereof. In some aspects, the molluscicide composition can be administered, for example, using a fogger, a sprayer, a mister, a diffusor, a box, an envelope, a paper, gloves, a shovel, a rake, a bait trap, a hose-end sprayer, a hand-powered applicator, a rotary and drop spreader, hand distribution, sprinkler, a container, or combinations thereof.

In some aspects, the molluscicide compositions used in the methods disclosed herein are applied according to a certain dose regimen. The phrase “dose regimen” as used herein refers the frequency of administration of the molluscicide composition that is sufficient to achieve mollusk control, treatment, prevention, or any combination thereof. In some aspects, the treatment comprises a single dose. In other aspects, the treatment comprises more than one dose.

In some aspects, the dose regimen consists in daily, weekly, or monthly applications of the molluscicide compositions. In some cases, one or more doses can be applied in a single day. In some aspects, the dose regimen consists of one daily dose, two daily doses, three daily doses, four daily doses, or more than four daily doses. In some aspect, the dose regimen consists of one weekly dose, two weekly doses, three weekly doses, four weekly doses, five weekly doses, six weekly doses, or more than six weekly doses. In some aspects, the dose regimen consists of one monthly dose, two monthly doses, three monthly doses, four monthly doses, five monthly doses, six monthly doses, seven monthly doses, eight monthly doses, nine monthly doses, ten monthly doses, eleven monthly doses, twelve monthly doses, or more than twelve monthly doses. In some aspects, the molluscicide compositions disclosed herein are administered yearly.

In specific aspects, the molluscicide compositions disclosed herein are administered in weekly doses. In other specific aspects, the molluscicide compositions disclosed herein are administered in monthly doses. In some aspects, when multiple doses are administered, the same amount of molluscicide composition is administered in each dose. In other aspects, the amount of molluscicide administered in each dose varies. For example, in some cases it can be desirable to administer a larger first dose or initial series of doses, followed by maintenance doses which are smaller than the initial (loading) dose or series of doses. In some aspects, when multiple doses are administered, such doses are evenly spaced. For example, the molluscicide composition can be administered once every week. In other cases, multiple doses are not evenly spaced. For example, it can be desirable to administered the molluscicide composition daily during the first week of treatment, and after the first week of treatment administer the molluscicide composition only once per week.

The molluscicide compositions, formulations, and methods disclosed herein can be used to control gastropods such as Anion spp. (e.g. A. ater, A. circumscriptus, A. distinctus, A. fasciatus, A. hortensis, A. intermedins, A. rufus, A. subfuscus, A. silvaticus, A. lusitanicus), Bradybaena spp. (e.g. B. fruticum), Cantareus spp. (e.g. C. asperses), Cepaea spp. (e.g. C. hortensis, C. nemoralis), Cochlodina spp. (e.g. C. laminata), Deroceras spp. (e.g. D. agrestis, D. empiricorum, D. laeve, D. panornimatum, D. reticulatum), Discus spp. (e.g. D. rotundatus), Euomphalia spp., Galba spp. (e.g. G. trunculata), Helicella spp. (e.g. H. itala, H. obvia), Helicigona spp. (e.g. H. arbustorum), Helicodiscus spp., Helix spp. (e.g. H. aperta, H. aspersa, H. pomatia), Limax spp. (e.g. Z. cinereoniger, L. flavus, L. marginatus, L. maximus, L. tenellus), Lymnaea spp. (e.g. L. stagnalis), Milax spp. (e.g. M. gagates, M. marginatus, M. sowerbyi, M. budapestensis), Opeas spp., Oxyloma spp. (e.g. O. pfeifferi), Pomacea spp. (e.g. P. canaliculata), Tandonia spp. (e.g. Jl. budapestensis, T. sowerbyi), Vallonia spp., and Zonitoides spp. (e.g. Z. nitidus). The molluscicide compositions, formulations, and methods disclosed herein can be used to control populations of Achatinidae snails (African giant snails), e.g., Giant African Snail (Achatina achatina), Giant East African Snail (Achatina fulica) or Giant West African Snail (Archachatina marginata). Also, the molluscicide compositions, formulations, and methods disclosed herein can be used to control populations of Ampullariidae snails (apple snails), e.g., snails from the genera Afropomus, Pila, Lanistes, Saulea, Marisa (e.g., Marisa cornuarietis, Marisa planogyra) and Pomacea (e.g., Pomacea canaliculata, Pomacea diffusa, etc.).

The molluscicide compositions, formulations, and methods disclosed herein can be used to treat, prevent, or ameliorate infestations caused the mollusks in plants, for example ornamental plants or crops (e.g., lettuce, cabbage, strawberries, beans, aromatic herbs, cauliflower, flowers such as Chrysanthemum, carnations or Alstromeria). Suitable target crops for control of gastropods using the compositions, formulations and methods disclosed herein include, for example cereals (such as wheat, barley, rye, oats, rice, maize or sorghum); beet (such as sugar or fodder beet); fruit (such as pome fruit, stone fruit, apples, pears, plums, peaches, almonds, cherries, strawberries, raspberries or blackberries); legumes (such as beans, lentils, peas or soya beans); oil crops (such as oil seed rape, mustard, poppies, olives, sunflowers, coconuts, castor, cacao or peanuts); marrows (such as pumpkins, cucumbers or melons); fiber plants (such as cotton, flax, hemp or jute); citrus fruits (such as oranges, lemons, grapefruits or tangerines); vegetables (such as spinach, lettuce, asparagus, cabbage species, carrots, onions, tomatoes, potatoes, or capsicums); laurels (such as avocado, Cinnamonium or camphor); and tobacco, nuts, coffee, egg plants, sugar cane, tea, pepper, grapevines, hops, the banana family, latex plants and ornamentals. In an embodiment pymetrozine is suitable for gastropod control in rice, oil seed rape, vegetables, wheat, barley, rye, oats, rice, maize or sorghum and ornamentals. For example the invention may be used on any of the following ornamental species: Ageratum, Alonsoa, Anemone spp., Anisodontea capsenisis, Anthemis, Antirrhinum, Rhododendron spp., Begonia spp. (e.g. B. elatior, B. semperflorens, B. tub\acute{ε}reux), Bougainvillea spp., Brachycome spp., Calceolaria, Capsicum annuum, Catharanthus roseus, Ornamental Brassica, Canna spp., Chrysanthemum, Cineraria spp. (C. maritime), Crassula coccinea, Cuphea ignea, Dicentra spectabilis, Dorotheantus, Eustoma grandiflorum, Forsythia, Fuchsia spp., Geranium Gnaphalium, Gomphrena globosa, Heliotropium, Helianthus, Hibiscus, Hortensia, Hosta, Hypoestes phyllostachya, Impatiens spp. (Walleriana), Iresines, Kalanchoe spp., Lantana camara, Lavatera trimestris, Leonotis leonurus, Lilium, Mesembryanthemum, Mimulus, Nemesia, Tagetes, Dianthus spp. (carnation), Canna, Oxalis, Bellis, Pelargonium spp. (P. peltatum, P. Zonale), Viola spp. (pansy), Petunia, Plecthranthus, Poinsettia, Parthenocissus spp. (P. Quinquefolia, P. Tricuspidata), Primula, Ranunculus, Rosa spp. (rose), Salvia, Scaevola aemola, Schizanthus wisetonensis, Solanum, Surβnia, Tagetes spp., Nicotinia, Verbena spp., Zinnia spp. and other bedding plants. Preferred within this class of ornamental crops are Viola, Petunia, Begonia, Impatiens, Geranium (including from seeds and cuttings), Chrysanthemum (including from cuttings), Rosa (including pot plants and from cuttings), Poinsettia, Ranunculus, Fuchsia, Salvia and Hortensia.

The molluscicide compositions, formulations and methods disclosed herein are also suitable for the protection of plant propagation material, for example seed, such as fruits, tubers or kernels, from gastropods. The propagation material can be treated with the composition prior to planting, for example by soaking, spraying or coating seed prior to sowing. Alternatively, the molluscicide compositions can be applied directly to the locus at which the propagation material is to be planted (for example onto the ground, into a seed furrow, or into pot plant growing media). The molluscicide compositions, formulations, and methods disclosed herein can also be used to protect stored products from gastropods.

See, e.g., US20070167492, US20070196517, US20070148203, US20070148203, US20030118625, U.S. Pat. No. 6,277,889, which are herein incorporated by reference in their entireties.

In some aspects, the molluscicide compositions and formulations disclosed herein can be applied by foliar spray. An exemplary application by foliar spray comprises diluting the composition in an appropriate amount of a solvent, e.g., water, for example at 5 to 10 grams per liter. The diluted composition would then be applied by foliar spraying according to a predetermined schedule, for example, on certain days (e.g., every two weeks), one or more times a day (e.g., once a day), and at the same time or different times during the day (e.g., early in the morning or the end of the day). The amount of molluscidide composition can vary depending on the incidence of the infestation. For example, if the infestation is high, the dosage can be scalated and/or the frequency can be increased (e.g., applying the composition weekly instead of biweekly).

In some aspects, the molluscicide compositions disclosed herein can be used for drench applications. Drench applications are particularly appropriate to control extremely high populations of mollusks. In these cases, the molluscicide compositions disclosed herein can be diluted in a suitable solvent and applied directly to the soil to capacity. In some aspects, drench applications can be complemented with foliar application.

In some aspects, the molluscicide compositions disclosed here are applied at about 0.1 kg/ha, about 0.2 kg/ha, about 0.3 kg/ha, about 0.4 kg/ha, about 0.5 kg/ha, about 0.6 kg/ha, about 0.7 kg/ha, about 0.8 kg/ha, about 0.9 kg/ha, about 1 kg/ha, about 1.1 kg/ha, about 1.2 kg/ha, about 1.3 kg/ha, about 1.4 kg/ha, about 1.5 kg/ha, about 1.6 kg/ha, about 1.7 kg/ha, about 1.8 kg/ha, about 1.9 kg/ha, about 2.0 kg/ha, about 2.1 kg. ha, about 2.2 kg/ha, about 2.3 kg/ha, about 2.4 kg/ha, about 2.5 kg/ha, about 2.6 kg/ha, about 2.7 kg/ha, about 2.8 kg/ha, about 2.9 kg/ha, about 3.0 kg/ha, about 3.1 kg. ha, about 3.2 kg/ha, about 3.3 kg/ha, about 3.4 kg/ha, about 3.5 kg/ha, about 3.6 kg/ha, about 3.7 kg/ha, about 3.8 kg/ha, about 3.9 kg/ha, about 4.0 kg/ha about 4.1 kg. ha, about 4.2 kg/ha, about 4.3 kg/ha, about 4.4 kg/ha, about 4.5 kg/ha, about 4.6 kg/ha, about 4.7 kg/ha, about 4.8 kg/ha, about 4.9 kg/ha, about 5.0 kg/ha about 5.1 kg. ha, about 5.2 kg/ha, about 5.3 kg/ha, about 5.4 kg/ha, about 5.5 kg/ha, about 5.6 kg/ha, about 5.7 kg/ha, about 5.8 kg/ha, about 5.9 kg/ha, or about 6.0 kg/ha. In some particular aspects, the molluscicide composition is applied at more than 6 kg/ha.

In specific aspects, the molluscicide compositions disclosed herein can be applied at 5 kg/Ha (4.5 lb/acre) every 2 weeks for low to medium pressure. In some aspects, the molluscicide compositions disclosed herein can be applied at 5 kg/Ha (4.5 lb/acre) every 4-5 days for higher pressure.

### 6. ARTICLES OF MANUFACTURE COMPRISING MOLLUSCICIDE COMPOSITIONS COMPRISING SAPONINS AND CAFFEINE

The disclosure also provides articles of manufacture comprising any one of the compositions disclosed herein, e.g., molluscicide compositions and formulations comprising a saponin obtained from a first source (e.g., a saponin-containing plant extract from a member of the Sapindacea family such as Sapindus. saponaria) and caffeine obtained from a second source (e.g., a caffeine-containing plant extract from a coffee plant), wherein the saponin and the caffeine act synergistically as molluscicides.

In a specific aspect, the molluscicide composition used in the articles of manufacture disclosed herein comprises:
(a) a saponin-containing plant extract from Sapindus saponaria, wherein the saponin-containing plant extract comprises hederagenin-derived saponins, and wherein the saponins are about 25% of the dry weight of the saponin-containing plant extract; and
(b) a caffeine-containing plant extract obtained from a coffee plant, wherein the coffee plant is a member of the genus Coffea, and wherein the caffeine content in the caffeine-containing plant extract is at least about 97% (i.e., it is at least about 97% pure),
wherein the saponin-containing plant extract and the caffeine-containing plant extract act synergistically as molluscicides.

In some aspects, the article of manufacture comprises:
(a) a first container with a composition contained therein, wherein the composition comprises saponin, for example, from plant origin (e.g., a saponin-containing plant extract from a member of the Sapindacea family such as Sapindus saponaria), synthetic saponin, semisynthetic saponin, or a combination thereof; and,
(b) a second container whit a composition contained therein, wherein the composition comprises caffeine, for example, from plant origin (e.g., a caffeine-containing plant extract from a coffee plant), synthetic caffeine, semisynthetic caffeine, or a combination thereof.

In some aspects, the article of manufacture further comprises a brochure, printed instructions, label, or package insert directing the user (e.g., a distributor or the final user) to combine the contents of the first container and the second container.

The article of manufacture can comprise a container comprising a concentrate composition comprising saponin, for example, from plant origin (e.g., a saponin-containing plant extract from a member of the Sapindacea family such as Sapindus saponaria), synthetic saponin, semisynthetic saponin, or a combination thereof; and, caffeine, for example, from plant origin (e.g., a caffeine-containing plant extract from a coffee plant), synthetic caffeine, semisynthetic caffeine, or a combination thereof.

In some aspects, the article of manufacture further comprises a brochure, printed instructions, label, or package insert directing the user (e.g., a distributor or the final user) to dilute the contents of the container comprising the concentrate disclosed above.

In some aspects, the article of manufacture comprises, for example, bottle(s), vial(s), cartridge(s), sprayer(s), mister(s), fogger(s), diffusor(s), box(es), gloves, spreader(s), sprinkler(s), syringe(s), or any combination thereof. In some aspect, the article of manufacture comprises one or more containers that can be formed from a variety of materials such as glass and/or plastic. In some aspects, the container holds a composition that can be effective for the control, treatment and/or prevention of mollusk infestation disclosed herein. In some aspects, the container holds at least one active ingredient of the compositions disclosed herein, for example, molluscicide compositions and formulations.

In some aspects, the article of manufacture comprising the compositions disclosed herein further comprises packaging material. In some aspects, the packaging material can contain, for example, plastic, packing peanuts, cardboard, paper, straw, hay, bubble wrap, biodegradable packing material, instructions of use, or any combination thereof. In some aspects, the packaging material contains, for example, printed instructions of use or administration of any of the compositions disclosed herein. In some aspects, the printed instructions further comprise a regimen for use, for example, for preventing, combating, exterminating mollusks, or any combination thereof. In some aspects, the article of manufacture comprising the compositions disclosed herein further comprises a label. In some aspects, the label refers to use or administration the compositions disclosed herein. In some aspects, the label suggests, for example, a regimen for use, a regimen for preventing, combating, exterminating mollusks or any combination thereof.

### 7. EMBODIMENTS

### Embodiment 1

A molluscicide composition comprising a saponin-containing plant extract and a caffeine-containing plant extract from a different plant, wherein the saponin-containing plant extract and a caffeine-containing plant extract act synergistically as molluscicides.

### Embodiment 2

The composition according to embodiment 1, wherein the saponin-containing plant extract is obtained from a Sapindaceae family plant.

### Embodiment 3

The composition according to embodiment 2, wherein the Sapindaceae family plant is a member of the genus Sapindus.

### Embodiment 4

The composition according to embodiment 3, wherein the member of the genus Sapindus is Sapindus saponaria.

### Embodiment 5

The composition according to embodiment 1, wherein the saponin-containing plant extract is obtained from tea (Camellia sinensis), lychee (Litchi chinensis), alfalfa (Medicago sativa), chickpeas (Cicer arietinum), soybeans (Glycine max), beans (Phaseolus vulgaris), quinoa (Chenopodium quinoa), alfombrilla (Drymaria arenaroides), Christmas rose (Helleborus niger), Horse Chestnut trees (Aesculus hippocastanum), Asparagus fern (Asparagus officinalis), licorice root (Glycyrrhiza leguminosae), soapberry (Shepherdia canadensis), soap nut (Sapindus mokorossi), Daisies (Bellis perennis), fique (Furcraea andina), agave (Agave sp.), Mojave yucca (Yucca schidigera), Quillay (Quillaja saponaria), Campions (Silene spp.), Ragged Robin (Lychnis flos-cuculi), Bracken (Pteridium aquilinum), Soap Lily (Chlorogalum pomeridianum), Ceanothus cuneatus, Yucca baccata, Yucca filamentosa, Yucca glauca, Yucca gloriosa, Yucca whipplei, Philadelphus lewisii, wild yam (Dioscorea villosa), Panax ginseng or Glycyrrhiza uralensis.

### Embodiment 6

The composition according to any one of embodiments 1 to 5, wherein the saponin-containing plant extract comprises saponins and free sugars.

### Embodiment 7

The composition according to any one of embodiments 1 to 6, wherein the saponin-containing plant extract comprises hederagenin-derived saponins.

### Embodiment 8

The composition according to any one of embodiments 1 to 7, wherein the saponin-containing plant extract is obtained using a water-alcohol extraction method.

### Embodiment 9

The composition according to embodiment 6, wherein saponins are at least 10% of the dry weight of the saponin-containing plant extract.

### Embodiment 10

The composition according to embodiment 9, wherein saponins are at least 20% of the dry weight of the saponin-containing plant extract.

### Embodiment 11

The composition according to embodiment 10, wherein saponins are about 25% of the dry weight of the saponin-containing plant extract.

### Embodiment 12

The composition according to embodiment 1, wherein the caffeine-containing plant extract is obtained from a coffee bean plant, a tea plant, a yerba mate plant, a cacao plant, a kola nut plant, a guarana plant, a guayusa plant, a yaupon holly plant, or a combination thereof.

### Embodiment 13

The composition according to embodiment 12, wherein the coffee bean plant is a member of the genus Coffea.

### Embodiment 14

The composition according to embodiment 13, wherein the member of the genus Coffea is Coffea arabica.

### Embodiment 15

The composition according to embodiment 12, wherein the caffeine-containing plant extract is obtained using a liquid-liquid extraction method.

### Embodiment 16

The composition according to embodiment 15, wherein the liquid-liquid extraction method comprises ethyl acetate.

### Embodiment 17

The composition according to embodiments 12 to 16, wherein the caffeine-containing plant extract is at least about 80% pure.

### Embodiment 18

The composition according to embodiment 17, wherein the caffeine-containing plant extract is at least about 90% pure.

### Embodiment 19

The composition according to embodiment 18, wherein the caffeine-containing plant extract is at about 97% pure.

### Embodiment 20

The composition according to embodiment 1, wherein the saponin-containing plant extract and the caffeine-containing plant extract are in solid form.

### Embodiment 21

The composition according to embodiment 20, wherein the solid form comprises powder, pellet or granule formulations.

### Embodiment 22

The composition according to embodiment 21, wherein the powder, pellet or granule formulations are dispersible.

### Embodiment 23

The composition according to embodiment 22, wherein the powder, pellet or granule formulations are water-dispersible.

### Embodiment 24

The composition according to embodiment 20, wherein the solid form comprises powder, dry flowable, bait, dust, nanoencapsulated, or microencapsulated formulations.

### Embodiment 25

The composition according to embodiment 24, wherein the powder formulations are wettable powder formulations.

### Embodiment 26

The composition according to embodiment 1, wherein the saponin-containing plant extract and the caffeine-containing plant extract are in liquid form.

### Embodiment 27

The composition according to embodiment 26, wherein the liquid form comprises liquid concentrate, emulsifiable concentrate, emulsion, suspension, liquid flowable, gel, ready-to-use, or aerosol formulations.

### Embodiment 28

The composition according to embodiment 27, wherein the liquid concentrate comprises ultra-low-volume concentrate formulations.

### Embodiment 29

The composition according to embodiment 1, wherein the molluscicide composition has a concentration between about 0.1 grams/liter to about 15 grams/liter of saponin-containing plant extract and a concentration between about 0.1 grams/liter to about 15 grams/liter of caffeine-containing plant extract.

### Embodiment 30

The composition according to embodiment 29, wherein the molluscicide composition has a concentration between about 2 grams/liter to about 12 grams/liter of saponin-containing plant extract and a concentration between about 2 grams/liter to about 12 grams/liter of caffeine-containing plant extract.

### Embodiment 31

The composition according to embodiment 30, wherein the molluscicide composition has a concentration between about 3 grams/liter to about 10 grams/liter of saponin-containing plant extract and a concentration between about 3 grams/liter to about 10 grams/liter of caffeine-containing plant extract.

### Embodiment 32

The composition according to embodiment 31, wherein the molluscicide composition has a concentration of about 7 grams/liter of saponin-containing plant extract and a concentration between about 7 grams/liter of caffeine-containing plant extract.

### Embodiment 33

The composition according to any one of embodiments 1 to 32, further comprising a carrier.

### Embodiment 34

The composition according to embodiment 33, wherein the carrier is a neutral carrier edible for mollusks.

### Embodiment 35

The composition according to embodiment 34, wherein the neutral carrier edible for mollusks is a composition of substances of vegetable and/or animal origin.

### Embodiment 36

The composition according to embodiment 35, wherein the neutral carrier comprises a mixture of dried vegetables, porky greaves, osseous meal, sugar, molasses, egg powder, plant grains, or any combination thereof.

### Embodiment 37

The composition according to embodiment 36, wherein the plant grains comprise wheaten bruised grain, whole grain, corn bruised grain, or any combination thereof.

### Embodiment 38

The composition according to any one of embodiments 1 to 37, further comprising a dye, a pigment, a safety additive agent, an attractant, an agent improving rain-resistance, or any combination thereof.

### Embodiment 39

The composition according to embodiment 1, wherein the molluscicide composition comprises (A) a saponin-containing plant extract and (B) a caffeine-containing plant extract in a weight ratio of (A):(B) between 20:1 to 1:20.

### Embodiment 40

The composition according to embodiment 39, wherein the molluscicide composition comprises (A) a saponin-containing plant extract and (B) a caffeine-containing plant extract in a weight ratio of (A):(B) between 15:1 to 1:15.

### Embodiment 41

The composition according to embodiment 40, wherein the molluscicide composition comprises (A) a saponin-containing plant extract and (B) a caffeine-containing plant extract in a weight ratio of (A):(B) about 1:14.

### Embodiment 42

An article of manufacture comprising a saponin-containing plant extract and a caffeine-containing plant extract according to any one of embodiments 1 to 41 and packaging material.

### Embodiment 43

A method for controlling mollusk damage to plants, comprising treating the plants or the locus surrounding the plants with a molluscicidally effective amount of the molluscicide composition according to any one of embodiments 1 to 41.

### Embodiment 44

A method for controlling gastropods, comprising exposing the gastropods to a composition comprising a molluscicidally effective amount of the molluscicide composition according to any one of embodiments 1 to 41.

### Embodiment 45

The method according to embodiment 44, wherein the gastropods are from the subclass Pulmonata.

### Embodiment 46

The method according to embodiment 43, wherein the gastropods are selected from the group consisting of Helix spp., Agriolimax spp., Limax spp., Milax spp., Anion spp., Pomacea spp., or Deroceras spp.

### Embodiment 47

A method for preventing mollusk infestation, comprising treating plants or the locus surrounding the plants with a molluscicidally effective amount of the molluscicide composition according to any one of embodiments 1 to 41.

### Embodiment 48

A method to treat a surface to prevent mollusk infestation with a molluscicidally effective amount of the molluscicide composition according to any one of embodiments 1 to 41.

### Embodiment 49

The method according to embodiment 48, wherein the surface is in an agricultural, a horticultural, a garden, or an aquatic environment.

### Embodiment 50

The method according to any one of embodiments 43 to 49, further comprising a dose regimen.

### Embodiment 51

The method according to embodiment 50, wherein the dose regimen comprises at least one daily dose.

### Embodiment 52

The method according to embodiment 50, wherein the dose regimen comprises at least one weekly dose.

### Embodiment 53

The method according to embodiment 50, wherein the dose regimen comprises at least one monthly dose.

### Embodiment 54

The method according to any one of embodiments 43 to 53, wherein the molluscicide composition concentration is between about 0.1 grams/liter to about 15 grams/liter of saponin-containing plant extract and a concentration between about 0.1 grams/liter to about 15 grams/liter of caffeine-containing plant extract.

### Embodiment 55

The method according to embodiment 54, wherein the molluscicide composition concentration is between about 2 grams/liter to about 12 grams/liter of saponin-containing plant extract and a concentration between about 2 grams/liter to about 12 grams/liter of caffeine-containing plant extract.

### Embodiment 56

The method according to embodiment 55, wherein the molluscicide composition concentration is between about 3 grams/liter to about 10 grams/liter of saponin-containing plant extract and a concentration between about 3 grams/liter to about 10 grams/liter of caffeine-containing plant extract.

### Embodiment 57

The method according to embodiment 56, wherein the molluscicide composition has a concentration of about 7 grams/liter of saponin-containing plant extract and a concentration of about 7 grams/liter of caffeine-containing plant extract.

### Embodiment 58

The method according to any one of embodiments 43 to 57, wherein the molluscicide composition comprises (A) a saponin-containing plant extract and (B) a caffeine-containing plant extract in a weight ratio of (A):(B) between 20:1 to 1:20.

### Embodiment 59

The method according to embodiment 58, wherein the molluscicide composition comprises (A) a saponin-containing plant extract and (B) a caffeine-containing plant extract in a weight ratio of (A):(B) between 15:1 to 1:15.

### Embodiment 60

The method according to embodiment 59, wherein the molluscicide composition comprises (A) a saponin-containing plant extract and (B) a caffeine-containing plant extract in a weight ratio of (A):(B) about 1:14.

The following examples are illustrative and non-limiting, of the compositions, products, and methods described herein. Suitable modifications and adaptions of the variety of conditions, formulations, and other parameters normally encountered in the field and which are obvious to those skilled in the art in view of this disclosure are within the spirit and scope of the disclosure.

### EXAMPLES

### Example 1

### Synergistic Effect of Combining Sapindus saponaria Extract and Caffeine Extract on Mollusk Mortality

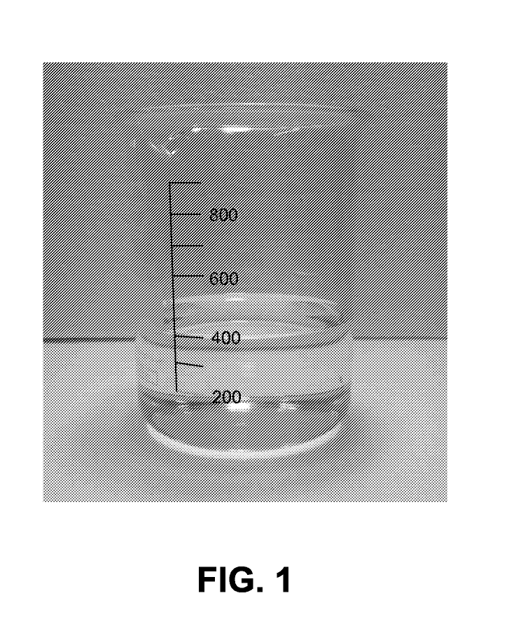

Tests were conducted in accord with the World Health Organization protocol for the assessment of molluscicides. See World Health Organization, “Molluscicidal screening and evaluation”, Bull World Health Organ. 1965; 33(4): 567-581, which is incorporated herein by reference in its entirety. A stock solution of caffeine extract at a concentration of 568.75 mg/mL was prepared using liquid-liquid extraction with ethyl acetate on roasted and ground beans from the Coffea arabica plant. See Heilmann W., “Decaffeination of coffee,” R. J. Clarke and O. G. Vitzthum (eds.), “Coffee-Recent Developments,” Oxford:Blackwell Science, (2001). High-performance liquid chromatography (“HPLC”) determined the purity of the caffeine was 97.6%. See L. R. Snyder, J. J. Kirkland, and J. W. Dolan, “Introduction to Modern Liquid Chromatography,” John Wiley & Sons, New York, (2009). Nuclear magnetic resonance (“NMR”) analysis revealed the remaining 2.4% of impurities were identified as phenolic acids, namely caffeic acid and protocatechuic. See e.g., Rabi, et al., Physical Review 53 (4): 318-327 (1938). Six different dilutions of the caffeine extract were prepared from the stock caffeine extract solution with a concentration of 568.75 mg/mL, using distilled water resulting in concentrations of 0.087 mg/mL, 0.218 mg/mL, 0.273 mg/mL, 0.328 mg/mL, 0.437 mg/mL, and 0.874 mg/mL. Similarly, variable concentrations of Sapindus saponaria extract test solutions were prepared. Sapindus saponaria extract was prepared as previously described in U.S. Pat. No. 8,298,590, which is herein incorporated by reference in its entirety. Five different Sapindus saponaria extract concentrations of 0.01 mg/mL, 0.02 mg/mL, 0.03 mg/mL, 0.04 mg/mL, and 0.05 mg/mL were prepared using distilled water. NMR identified each Sapindus saponaria extract solution contained three hederagenin-derived saponins, representing 62.3% of the extract, free sugars representing 20.5% of the extract, and 17.2% other metabolites. Each prepared caffeine and saponin solution was tested against an untreated control (“Control”). 400 mL of each prepared caffeine, saponin and control solutions were poured into individual flasks that had a minimum capacity of 1 L. A typical test container is shown in FIG. 1. Molluks, Deroceras reticulatum, (>300 mg in weight) were taken from a previously established breed, under controlled conditions. Ten mollusks (10) were added to each individual flask. All flasks contained the equivalent of 600 mL of air to allow the mollusks the ability to move about and prevent drowning. The individual flasks were sealed with a plastic film and arranged in a randomized design of three replicates per test solution.

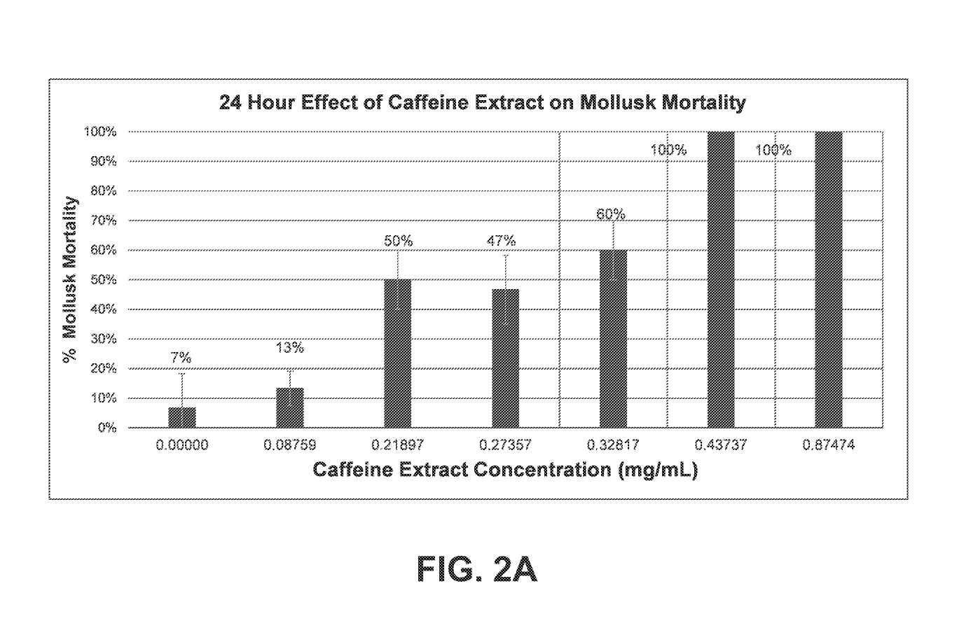

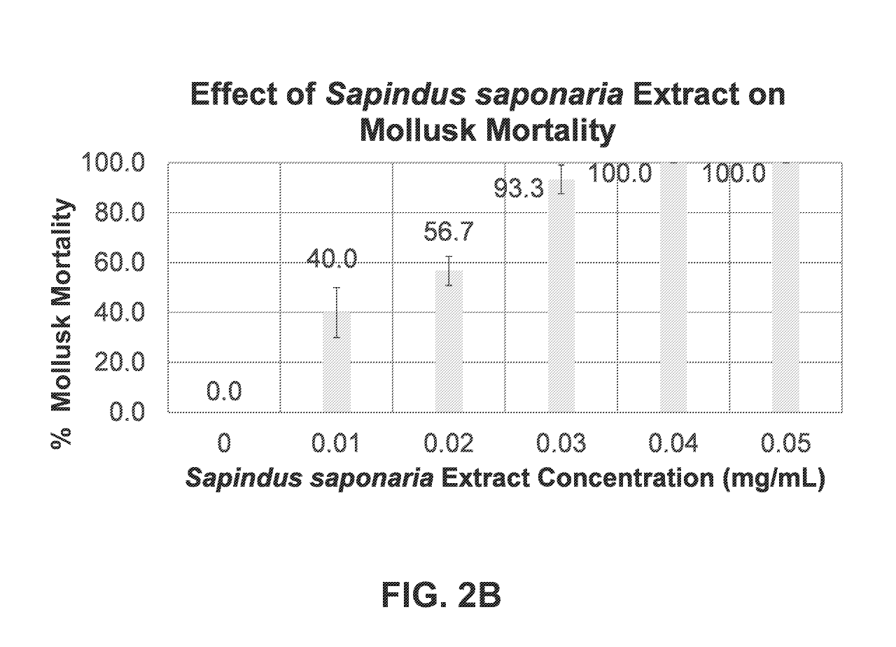

Evaluations were conducted 24 hours after the mollusks were placed in the flasks containing the test solutions. The plastic film was removed from each flask and the number of alive and dead mollusks was determined. A caffeine extract concentration of 0.218 mg/mL, resulted in 47% mollusk mortality compared to the control. At almost double that concentration, at 0.437 mg/mL caffeine extract, mollusk mortality was 100%. The complete list of results is found below in TABLE 10 and graphically represented in FIG. 2A.

TABLE 10
Percent Mollusk Mortality After 24
Hour Exposure to Caffeine Extract

| Concentration of Caffeine | | |
|---|---|---|
| Extract (mg/mL) | % mollusk mortality | Homogeneous groups |
| Control | 7.0% | A |
| 0.087 | 13.0% | A |
| 0.218 | 50.0% | B |
| 0.273 | 47.0% | B |
| 0.328 | 60.0% | B |
| 0.437 | 100.0% | C |
| 0.874 | 100.0% | C |

Sapindus saponaria extract at 0.01 mg/mL, produced 40% mollusk mortality compared to the control. Mollusk mortality reached 93.3%, at a Sapindus saponaria extract concentration of 0.03 mg/mL. The complete list of results is found below in TABLE 11 and graphically represented in FIG. 2B.

TABLE 11
Percent Mollusk Mortality After 24 Hour Exposure to
Sapindus saponaria extract

| Concentration of Sapindus | | |
|---|---|---|
| saponaria extract (mg/mL) | % mollusk mortality | Homogeneous groups |
| Control | 0.0% | A |
| 0.01 | 40.0% | B |
| 0.02 | 56.7% | C |
| 0.03 | 93.3% | D |
| 0.04 | 100.0% | E |
| 0.05 | 100.0% | E |

Statistical calculations were conducted, in accord with the formula below, to calculate the overall combined effect of the caffeine and Sapindus saponaria extracts. See Berenbaum, et al., Clin. Exp. Immunol. 28:1-18 (1977).

$$\frac{dose of A}{{A}_{e}} + \frac{dose of B}{{B}_{e}} + \frac{dose of C}{{C}_{e}} + … + \frac{dose of X}{{X}_{e}} = \{ \begin{matrix}< 1 for synergy \\ 1 for additivism \\ > 1 for antagonism\end{matrix} .$$

Expressed algebraically, experimentally calculated doses of A, B, C, or X that produce the same quantitative effect are represented by Aₑ, Bₑ, Cₑ, or Xₑ. Id. This statistical approach avoids the pitfall of non-linear dose-effects and enables a formulation of unequivocal definition of synergy, addictiveness, or antagonism. Id. at page 3. The effect is calculated by adding the actually observed dose that has been divided by the experimentally calculated dose for that compound. The relationship between the observed dose and the experimentally calculated dose is synergistic, if the result is less than 1. The relationship between the observed dose and the experimentally calculated dose is additive, if the result equals 1. Finally, the relationship between the observed dose and the experimentally calculated dose is antagonistic, if the result is greater than 1. As such, Probit analysis was conducted to determine the expected mollusk mortality rates at the different concentrations of caffeine extract and Sapindus saponaria extract alone. Expected results are found in TABLE 12 and TABLE 13, respectively.

TABLE 12
Percent Expected Mollusk Mortality for Different
Concentrations of Caffeine Extract

| Percent | | Conf. | Conf. |
|---|---|---|---|
| Expected | | Lower limit | Higher Limit |
| Mortality | Concentration | 95.0% | 95.0% |
| 0.1 | −0.162604 | −0.357086 | −0.0582366 |
| 0.5 | −0.0937732 | −0.0258163 | −0.00499646 |
| 1 | −0.0603914 | −0.210281 | 0.0209171 |
| 2 | −0.0239167 | −0.158062 | 0.0493318 |
| 3 | −0.000774797 | −0.125003 | 0.0674312 |
| 4 | 0.016634 | −0.10018 | 0.0810933 |
| 5 | 0.0307946 | −0.0800238 | 0.0922419 |
| 6 | 0.0428476 | −0.0628973 | 0.10176 |
| 7 | 0.0534157 | −0.047906 | 0.110132 |
| 8 | 0.0628782 | −0.034506 | 0.11765 |
| 9 | 0.071484 | −0.0223402 | 0.124509 |
| 10 | 0.0794056 | −0.0111612 | 0.130842 |
| 15 | 0.112203 | 0.0348728 | 0.157312 |
| 20 | 0.13827 | 0.0710662 | 0.178743 |
| 25 | 0.160633 | 0.101705 | 0.197541 |
| 30 | 0.180715 | 0.12876 | 0.214882 |
| 35 | 0.199325 | 0.153293 | 0.231489 |
| 40 | 0.216983 | 0.175933 | 0.247885 |
| 45 | 0.234068 | 0.197079 | 0.264508 |
| 50 | 0.250881 | 0.217007 | 0.281748 |
| 55 | 0.267694 | 0.235948 | 0.299975 |
| 60 | 0.284779 | 0.254151 | 0.319541 |
| 65 | 0.302438 | 0.271927 | 0.340802 |
| 70 | 0.21047 | 0.289684 | 0.364187 |
| 75 | 0.341129 | 0.307948 | 0.390316 |
| 80 | 0.363492 | 0.327482 | 0.420218 |
| 85 | 0.389559 | 0.349503 | 0.455822 |
| 90 | 0.422356 | 0.376455 | 0.501374 |
| 91 | 0.430278 | 0.382875 | 0.512466 |
| 92 | 0.438884 | 0.389818 | 0.524548 |
| 93 | 0.448346 | 0.397419 | 0.537865 |
| 94 | 0.458914 | 0.405872 | 0.552774 |
| 95 | 0.470967 | 0.415472 | 0.569819 |
| 96 | 0.485128 | 0.426703 | 0.589893 |
| 97 | 0.502537 | 0.44045 | 0.614631 |
| 98 | 0.525679 | 0.0458641 | 0.647599 |
| 99 | 0.562154 | 0.487165 | 0.699709 |
| 99.5 | 0.595535 | 0.513151 | 0.747519 |
| 99.9 | 0.664367 | 0.566492 | 0.84634 |

TABLE 13
Percent Expected Mollusk Mortality for Different
Concentrations of Sapindus saponaria extract

| Percent | | Conf. | Conf. |
|---|---|---|---|
| Expected | | Lower limit | Higher Limit |
| Mortality | Concentration | 95.0% | 95.0% |
| 0.1 | −0.013078 | −0.0240708 | −0.00648963 |
| 0.5 | −0.008231 | −0.0175707 | −0.00257539 |
| 1 | −0.005881 | −0.0144293 | −0.00066609 |
| 2 | −0.003313 | −0.0110083 | 0.00143166 |
| 3 | −0.001684 | −0.00884586 | 0.00277068 |
| 4 | −0.000458 | −0.00722432 | 0.00378315 |
| 5 | 0.0005386 | −0.0059092 | 0.00461058 |
| 6 | 0.0013871 | −0.00479296 | 0.00531799 |
| 7 | 0.0021312 | −0.00381692 | 0.00594093 |
| 8 | 0.0027974 | −0.00294535 | 0.00650107 |
| 9 | 0.0034032 | −0.00215484 | 0.00701263 |
| 10 | 0.003961 | −0.00142915 | 0.0074855 |
| 15 | 0.00627 | 0.00155134 | 0.0094674 |
| 20 | 0.0081052 | 0.00388472 | 0.011078 |
| 25 | 0.0096797 | 0.00585299 | 0.0124933 |
| 30 | 0.0110935 | 000758686 | 0.0137979 |
| 35 | 0.0124037 | 0.00915873 | 0.0150417 |
| 40 | 0.0136469 | 0.0106138 | 0.0162584 |
| 45 | 0.0148498 | 0.0119834 | 0.0174738 |
| 50 | 0.0160335 | 0.0132912 | 0.0187098 |
| 55 | 0.0172172 | 0.0145579 | 0.019987 |
| 60 | 0.01842 | 0.0158032 | 0.0213268 |
| 65 | 0.0196632 | 0.017048 | 0.0227537 |
| 70 | 0.0209734 | 0.0183178 | 0.0242995 |
| 75 | 0.0223873 | 0.0196461 | 0.0260098 |
| 80 | 0.0239617 | 0.0210826 | 0.0279568 |
| 85 | 0.0257969 | 0.0227123 | 0.0302712 |
| 90 | 0.028106 | 0.0247115 | 0.0332343 |
| 91 | 0.0286637 | 0.0251878 | 0.03395666 |
| 92 | 0.0292696 | 0.0257027 | 0.0347438 |
| 93 | 0.0299358 | 0.0262661 | 0.035612 |
| 94 | 0.0306798 | 0.0268924 | 0.0365847 |
| 95 | 0.0315284 | 0.0276033 | 0.0376975 |
| 96 | 0.0325253 | 0.0284342 | 0.0390091 |
| 97 | 0.033751 | 0.0294504 | 0.0406269 |
| 98 | 0.0353803 | 0.0307936 | 0.0427852 |
| 99 | 0.0379482 | 0.0328963 | 0.0462012 |

According to TABLES 10 and 11, the recorded mollusk mortality percentage was close to 100% at 0.437 mg/mL caffeine extract and 0.03 mg/mL Sapindus saponaria extract, respectively. Based on the above concentrations, forty percent (40%) of each extract was calculated and determined to equal 0.1749475 mg/mL caffeine extract and 0.012 mg/mL Sapindus saponaria extract. Based on the expected mollusk mortality rates, calculated in TABLE 12, a caffeine extract concentration of 0.1749475 mg/mL would equate to an expected mollusk mortality rate of ˜30%. Similarly, a 0.012 mg/mL concentration of Sapindus saponaria extract would equate to an expected mollusk mortality rate of ˜35%, as shown in TABLE 13. Under additive effects of combining the two solutions, the maximum expected mollusk mortality would be ˜65%. However, using Berenbaum's formula, shown above, the outcome is 0.8 indicating a synergistic effect upon combining the caffeine and Sapindus saponaria extracts. In order to verify the calculated synergistic effect of Sapindus saponaria and caffeine, a combined solution containing 0.175 mg/mL caffeine extract and 0.012 mg/mL Sapindus saponaria extract was prepared, as described above and tested against the control. 400 mL of the combined solution and control were poured into individual flasks that had a minimum capacity of 1 L. Ten (10) mollusks were added to each individual flask. All flasks contained an equivalent of 600 mL of air to allow the mollusks the ability to move about and prevent drowning. The individual flasks were sealed with a plastic film. Evaluations conducted 24 hours after the mollusks were placed in the flasks indicated mollusk mortality was 100% for the combined solution relative to the untreated control, as shown in TABLE 14. (n=3) These results confirm the experimentally calculated synergistic effect of Sapindus saponaria extracts and caffeine on mollusks.

TABLE 14
Percent Mollusk Mortality After 24 Hour Exposure to a
Combined Solution containing Sapindus saponaria and
Caffeine Extracts

| Repetition | Percent Observed Mortality |
|---|---|
| 1 | 100% |
| 2 | 100% |
| 3 | 100% |

### Example 2

### Effects of the Combined Solution Containing Sapindus saponaria and Caffeine Extracts at Varying Concentrations on Mollusk Health

Adult mollusks, Deroceras reticulatum, (>300 mg in weight) were field-collected from an irrigated plot of mixed herbage and maintained in a plastic box lined with moist, unbleached, absorbent paper, under controlled environmental conditions, that included a 12 hour photoperiod, 15° C., and 90% relative humidity. Adult mollusks were fed ad lib. on mixed foliage for a period up to, but not exceeding, one week prior to testing. Prior to testing, adult mollusks were pre-starved for a period of 48 hours. Individual adult mollusks were weighed and anaesthetized using carbon dioxide (CO₂) for a period of approximately 10 minutes before injection.

A caffeine extract was prepared using liquid-liquid extraction with ethyl acetate on roasted and ground beans from the Coffea arabica plant. High-performance liquid chromatography (“HPLC”) determined that the caffeine content in the extract was 97.6% (i.e., the purity of the caffeine was 97.6%). Nuclear magnetic resonance (“NMR”) analysis revealed that the remaining 2.4% of impurities were phenolic acids, namely caffeic acid and protocatechuic acid. Sapindus saponaria extracts were prepared as described in U.S. Pat. No. 8,298,590, which is herein incorporated by reference in its entirety. NMR experiments determined that each Sapindus saponaria extract solution contained three hederagenin-derived saponins, representing 62.3% of the extract, free sugars representing 20.5% of the extract, and 17.2% other metabolites. The caffeine and Sapindus saponaria extract dilutions were combined to create four different test blends, “compound A”, “compound B”, “compound C”, and “Control (caffeine extract formulation)”. Compound A contained 33.0% caffeine extract, 61.2% calcium lignosulphonate, 3.0% carboxymethyl cellulose, 2.0% sodium chloride and 0.5% Sapindus saponaria extract. Compound B contained 32.5% caffeine extract, 59.8% calcium lignosulphonate, 2.9% carboxymethyl cellulose, 2.4% sodium chloride and 2.3% Sapindus saponaria extract. Compound C contained 32.5% caffeine extract, 59.8% calcium lignosulphonate, 2.9% carboxymethyl cellulose, 0.0% sodium chloride and 4.8% Sapindus saponaria extract. Compounds were tested against an untreated control (“Control (untreated)”) and (“Control (caffeine extract formulation)”) contained 33.0% caffeine extract, 61.2% calcium lignosulphonate, 3.0% carboxymethyl cellulose, 2.5% sodium chloride and no Sapindus saponaria extract in all trials. Aliquots of test compounds (20 μl) at concentrations of 12.5 g/L, 9.375 g/L, 6.25 g/L, 3.125 g/L, 2.34 g/L, and 1.56 g/L were injected directly into the buccal cavity of the adult mollusk using a fine micro syringe. Twenty (20) adult mollusks per each compound were examined. Individual mollusks were then placed into Petri dishes (each Petri dish: 9 cm diameter) lined with a moist, unbleached, absorbent paper and containing a small leave disc (5 cm diameter), cut from lettuce. Each Petri dish was maintained under controlled environment conditions that included a 12 hour photoperiod, 15° C., and 90% relative humidity.

Mollusk health evaluations were conducted on 1, 2, 3, 4, and 5 days after treatment (“DAT”). Adult mollusks were observed and classified into one of three categories: 1. Healthy (“H”) indicating no symptoms; 2. Affected (“A”) indicating some symptoms of poisoning, excessive mucus production and/or deformity; 3. Morbid/Dead (“D”) indicating severe symptoms of poisoning, paralyzed and/or unable to move in response to gentle prodding.

The results for all compounds are shown in TABLE 15.

TABLE 15
Mollusk Health Assessment 1, 2, 3, 4, and 5 Days Following Forced
Ingestion

| | Conc | DAT 1 | | | DAT 2 | | | DAT 3 | | | DAT 4 | | | DAT 5 | | |
|---|---|---|---|---|---|---|---|---|---|---|---|---|---|---|---|---|
| Treatment | (g/l) | H | A | D | H | A | D | H | A | D | H | A | D | H | A | D |
| | 1.56 | 20 | 0 | 0 | 20 | 0 | 0 | 20 | 0 | 0 | 20 | 0 | 0 | 20 | 0 | 0 |
| Control (caffeine | 12.5 | 0 | 8 | 12 | 0 | 6 | 14 | 0 | 4 | 16 | 0 | 2 | 18 | 0 | 0 | 20 |
| extract | 6.25 | 7 | 7 | 6 | 9 | 4 | 7 | 10 | 3 | 7 | 10 | 2 | 8 | 10 | 2 | 8 |
| formulation) | 3.125 | 15 | 1 | 4 | 15 | 1 | 4 | 15 | 0 | 5 | 15 | 0 | 5 | 15 | 0 | 5 |
| Compound A | 12.5 | 0 | 0 | 20 | 0 | 0 | 20 | 0 | 0 | 20 | 0 | 0 | 20 | 0 | 0 | 20 |
| | 9.375 | 0 | 1 | 19 | 0 | 0 | 20 | 0 | 0 | 20 | 0 | 0 | 20 | 0 | 0 | 20 |
| | 6.25 | 0 | 4 | 16 | 1 | 3 | 16 | 3 | 1 | 16 | 3 | 1 | 16 | 3 | 1 | 16 |
| | 3.125 | 16 | 4 | 0 | 18 | 1 | 1 | 19 | 0 | 1 | 18 | 1 | 1 | 18 | 0 | 2 |
| | 2.34 | 10 | 1 | 9 | 10 | 1 | 9 | 10 | 0 | 10 | 10 | 0 | 10 | 6 | 4 | 10 |
| | 1.56 | 20 | 0 | 0 | 20 | 0 | 0 | 20 | 0 | 0 | 20 | 0 | 0 | 20 | 0 | 0 |
| Compound B | 12.5 | 0 | 1 | 19 | 0 | 1 | 19 | 0 | 1 | 19 | 0 | 1 | 19 | 0 | 0 | 20 |
| | 9.375 | 0 | 1 | 19 | 0 | 1 | 19 | 0 | 0 | 20 | 0 | 0 | 20 | 0 | 0 | 20 |
| | 6.25 | 2 | 9 | 9 | 3 | 6 | 11 | 8 | 0 | 12 | 8 | 0 | 12 | 8 | 0 | 12 |
| | 3.125 | 8 | 4 | 8 | 9 | 1 | 10 | 9 | 1 | 10 | 10 | 0 | 10 | 10 | 0 | 10 |
| | 2.34 | 9 | 6 | 5 | 9 | 5 | 6 | 9 | 2 | 9 | 11 | 0 | 9 | 9 | 2 | 9 |
| Compound C | 12.5 | 0 | 0 | 20 | 0 | 0 | 20 | 0 | 0 | 20 | 0 | 0 | 20 | 0 | 0 | 20 |
| | 6.25 | 1 | 9 | 1 | 2 | 8 | 10 | 3 | 7 | 10 | 4 | 6 | 10 | 6 | 4 | 10 |
| | 3.125 | 15 | 5 | 1 | 17 | 2 | 1 | 18 | 1 | 1 | 19 | 0 | 1 | 19 | 0 | 1 |
| | 1.56 | 18 | 2 | 0 | 19 | 1 | 0 | 20 | 0 | 0 | 20 | 0 | 0 | 20 | 0 | 0 |

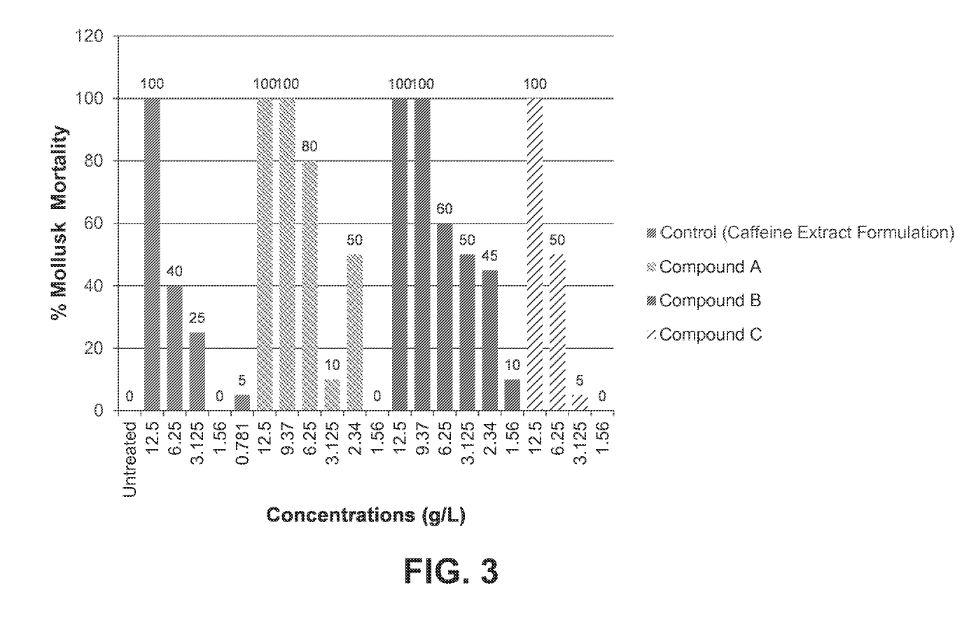

After only one day (“DAT 1”) following forced ingestion, at the highest concentration of 12.5 g/L, compounds A and C induced 100% mollusk mortality, while compound B achieved nearly the same percent mortality at 95% compared to the untreated control. At the same concentration, 12.5 g/L, the Control (caffeine extract formulation) induced only 90% mollusk mortality four days (“DAT 4”) following forced ingested and 100% mollusk mortality five days following forced ingestion. At the lower concentration of 6.25 g/L, molluscicidal efficacy varied between all compounds one day following forced ingestion (“DAT 1”), affording the highest mortality (80%) to compound A and the second highest mortality (60%) to compound B. The expressed cumulative percent mollusk mortality for each compound five days following forced ingestion is shown in FIG. 3.

The LD₅₀ (lethal dose required to kill 50% of the test mollusk population five days following forced ingestion) and LD₉₀ (lethal dose required to kill 90% of the test mollusk population five days following forced ingestion) were estimated by Probit analysis for each compound. See e.g., Bliss, Science 79 (2037): 38-39 (1934). This statistical analysis was performed with Minitab (version 16). Probit analysis confirmed the most efficacious treatment compounds were A and B, affording the lowest LD₅₀ at average concentration values of 4.3 g/l and 3.9 g/l, respectively, as shown in TABLE 16.

TABLE 16
Probit Analysis of LD₅₀ and LD₉₀ Following Forced
Ingestion of Compounds A, B, C

| | | Average | Lower | Upper |
|---|---|---|---|---|
| Treatment | | Concentration (g/L) | Limit | Limit |
| Control (caffeine extract | LD₅₀ | 6.3 | 5.2 | 7.9 |
| formulation) | LD₉₀ | 9.9 | 8.2 | 13.5 |
| Compound A | LD₅₀ | 4.3 | 3.6 | 5.1 |
| | LD₉₀ | 7.1 | 6.0 | 9.1 |
| Compound B | LD₅₀ | 3.9 | 3.0 | 4.9 |
| | LD₉₀ | 8.0 | 6.7 | 10.6 |
| Compound C | LD₅₀ | 6.2 | 5.4 | 7.7 |
| | LD₉₀ | 8.5 | 7.2 | 12.3 |

### Example 3

### Effects of the Combined Solution Containing Sapindus saponaria and Caffeine Extracts Varying Concentrations on Mollusk Feeding Activity

Adult mollusks, Deroceras reticulatum, (>300 mg in weight) were field-collected from an irrigated plot of mixed herbage and maintained in a plastic box lined with moist, unbleached, absorbent paper, under controlled environmental conditions, that included a 12 hour photoperiod, 15° C., and 90% relative humidity. Adult mollusks were fed ad lib. on mixed foliage for a period up to, but not exceeding, one week prior to testing. Prior to testing, adult mollusks were pre-starved for a period of 48 hours. Individual adult mollusks were weighed and anaesthetized using carbon dioxide (“CO₂”) for a period of approximately 10 minutes prior to injection.

A caffeine extract was prepared using liquid-liquid extraction with ethyl acetate on roasted and ground beans from the Coffea arabica plant. HPLC determined that caffeine content was 97.6% (i.e., the purity of the caffeine extract was 97.6%). Nuclear magnetic resonance (“NMR”) analysis revealed that the remaining 2.4% of impurities were phenolic acids, namely caffeic acid and protocatechuic acid. Sapindus saponaria extract was prepared as described in U.S. Pat. No. 8,298,590, which is herein incorporated by reference in its entirety. NMR experiments determined that each Sapindus saponaria extract solution contained three hederagenin-derived saponins, representing 62.3% of the extract, free sugars representing 20.5% of the extract, and 17.2% other metabolites. The caffeine and Sapindus saponaria extract dilutions were combined to create four different test blends, “compound A”, “compound B”, “compound C”, and “Control (caffeine extract formulation)”. Compound A contained 33.0% caffeine extract, 61.2% calcium lignosulphonate, 3.0% carboxymethyl cellulose, 2.0% sodium chloride and 0.5% Sapindus saponaria extract. Compound B contained 32.5% caffeine extract, 59.8% calcium lignosulphonate, 2.9% carboxymethyl cellulose, 2.4% sodium chloride and 2.3% Sapindus saponaria extract. Compound C contained 32.5% caffeine extract, 59.8% calcium lignosulphonate, 2.9% carboxymethyl cellulose, 0.0% sodium chloride and 4.8% Sapindus saponaria extract. Compounds were tested against an untreated control (“Control (untreated)”) and Control (caffeine extract formulation) contained 33.0% caffeine extract, 61.2% calcium lignosulphonate, 3.0% carboxymethyl cellulose, 2.5% sodium chloride and no Sapindus saponaria extract. Aliquots of test compounds (20 μl) at concentrations of 12.5 g/L, 9.375 g/L, 6.25 g/L, 3.125 g/L, 2.34 g/L, and 1.56 g/L were injected directly into the buccal cavity of the adult mollusk using a fine micro syringe. Twenty (20) adult mollusks per each test compound concentration were examined. Individual mollusks were then placed into Petri dishes (each Petri dish 9 cm diameter) lined with a moist, unbleached, absorbent paper and containing a small leave disc (5 cm diameter), cut from lettuce. Each Petri dish was maintained under controlled environment conditions that included a 12 hour photoperiod, 15° C., and 90% relative humidity.

Mollusk feeding damage evaluations were conducted on 1, 2, 3, 4, and 5 days after treatment (“DAT”) of the test compounds. Feeding damages was visually assessed by recording the visual percentage of the leaf disc consumed by the mollusk each day at the time of assessment.

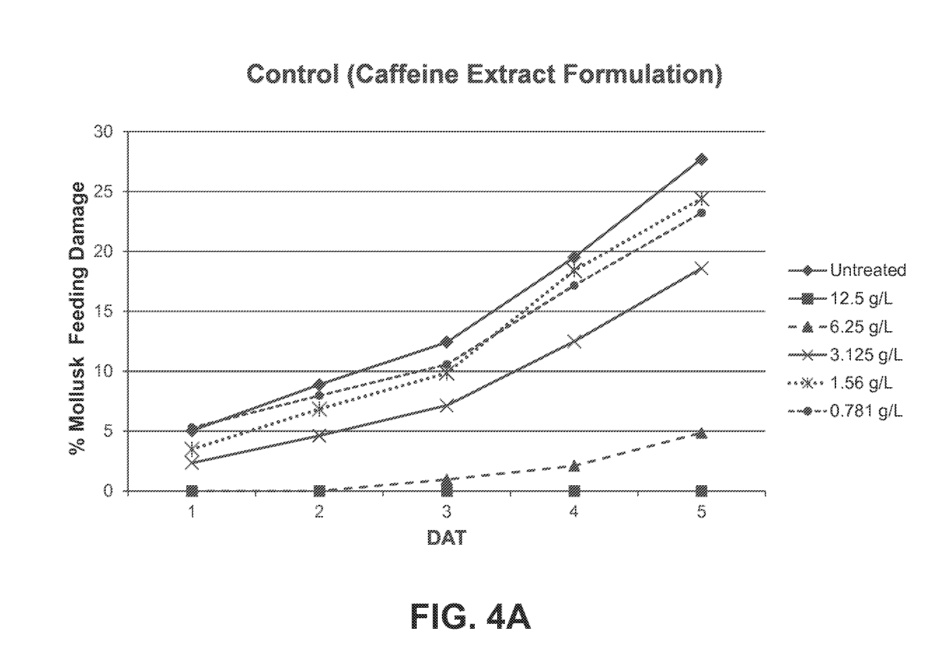

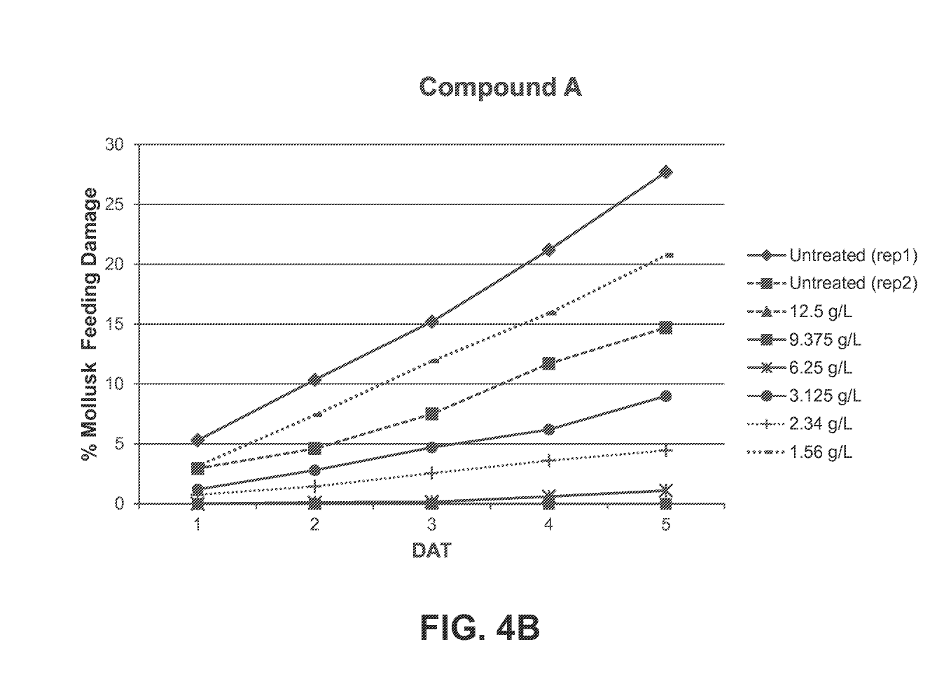

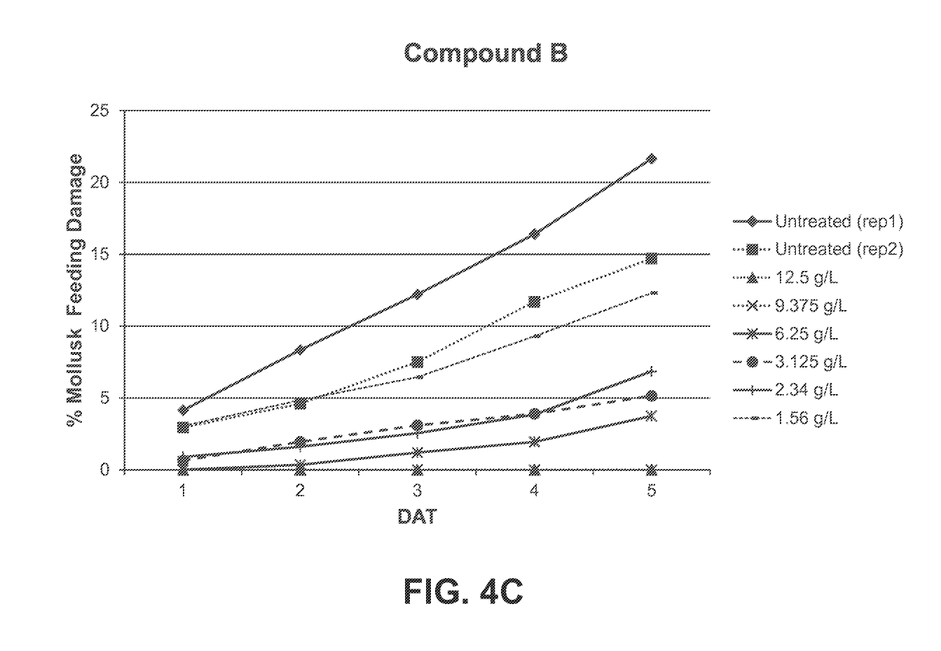

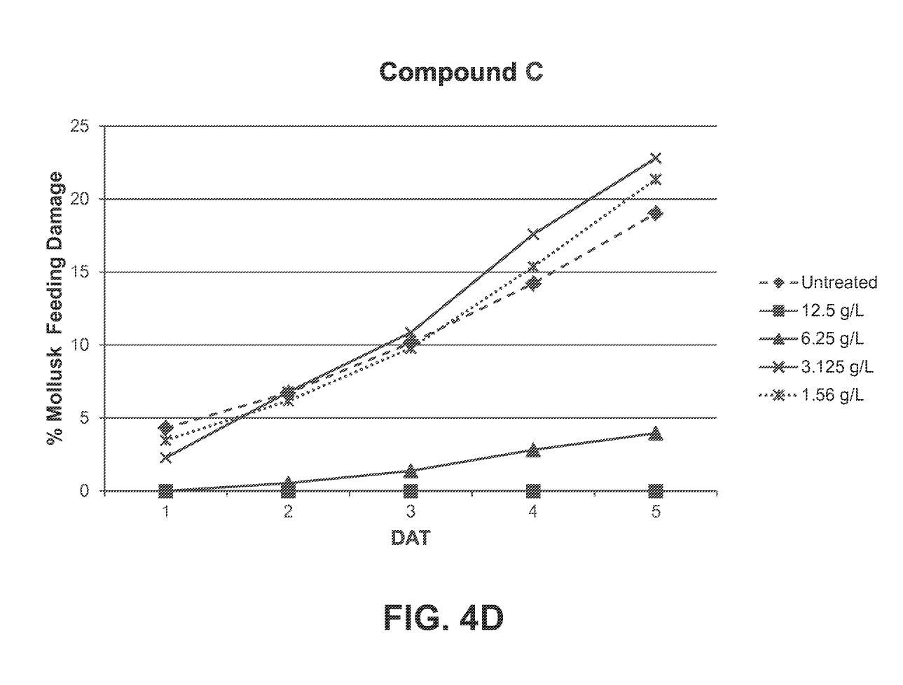

Control (caffeine extract formulation), failed to sustain reduced mollusk feeding following forced ingestion for concentrations of 0.78 g/L, 1.56 g/L, and 3.125 g/L as shown in FIG. 4A. However, at concentrations 6.25 g/L and 12.5 g/L Control (caffeine extract formulation), suppressed mollusk feeding only one day (“DAT 1”) following forced ingestion and continued to suppress mollusk feeding relative to the untreated control through day five (“DAT 5”) as shown in FIG. 4A.

After one day following forced ingestion (“DAT 1”) compound A suppressed mollusk feeding at concentrations of 2.34 g/L and higher, including 3.125 g/L, 6.25 g/L, 9.375 g/L and 12.5 g/L as shown in FIG. 4B. Compound A, at concentrations 6.25 g/L and higher, including 9.375 g/L and 12.5 g/L, consistently provided exceptional levels of feeding suppression beginning on day 1 (“DAT 1”) following forced ingestion and maintained that level of suppression, with only slight variability, through day 5 (“DAT 5”) as show in FIG. 4B.

Two days (“DAT 2”) following forced ingestion, compound B, provided significant levels of mollusk feeding suppression over all concentrations including 12.5 g/L, 9.375 g/L, 6.25 g/L, 3.125 g/L, 2.34 g/L, and 1.56 g/L relative to the untreated control as shown in FIG. 4C. This trend in mollusk feeding suppression continued through day five (“DAT 5”) following forced ingestion.

Following forced ingestion of compound C, significant levels of feeding suppression relative to the untreated control were only observed at concentrations of 6.25 g/L and 12.5 g/L, as shown in FIG. 4D.

Mollusk feeding consumption data from each day after treatment was subject to an Analysis of Variance (“ANOVA”) with the treatment as a factor. See e.g., Belle, G. V. “Statistical rules of thumb,” (2^{nd} ed.) Hoboken, N.J.: Wiley (2008). Due to the fact that the trials were performed as a series of batches with independent untreated controls, ANOVAs were restricted to data obtained over the standard four concentrations performed for all compounds, A, B, C, and Control (caffeine extract formulation). Tukey honestly significant difference (“HSD”) tests were used to distinguish between means, where appropriate, as described by Bell. G. V. “Statistical rules of thumb,” (2^{nd} ed.) Hoboken, N.J.: Wiley (2008). Analysis data was checked to ensure that the assumptions of the statistical model held. Where applicable, the ANOVA was performed on the transformed data set. Transformations were not always possible for some data sets and analyses for these were performed on the untransformed data. For all analyses, the probability of no significant differences occurring between treatments was calculated as the F probability value (p (F)). All tests were undertaken at the 95% confidence interval.

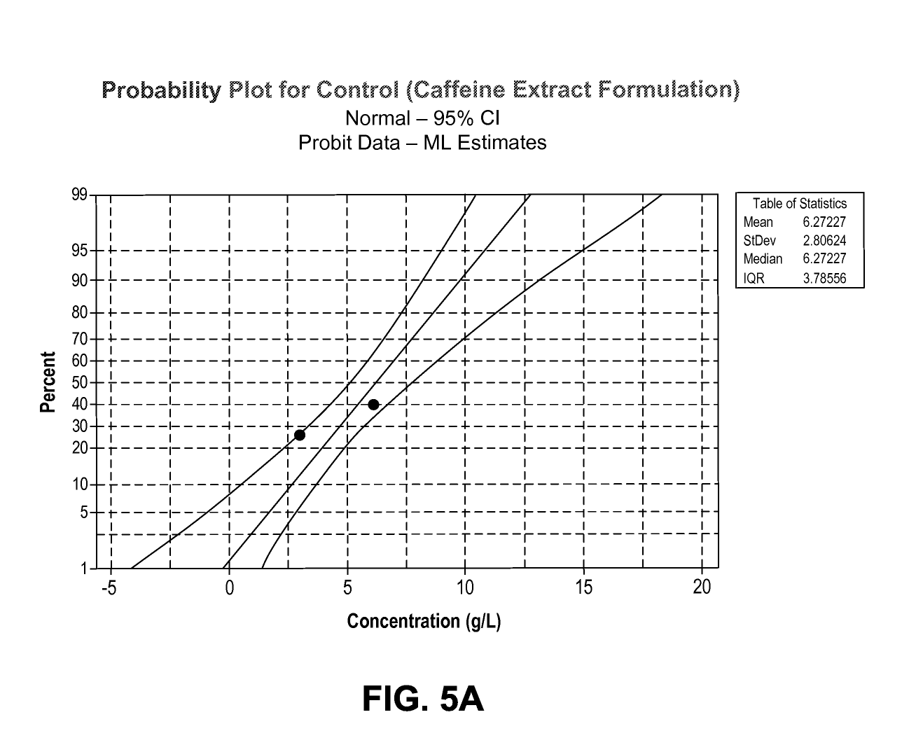

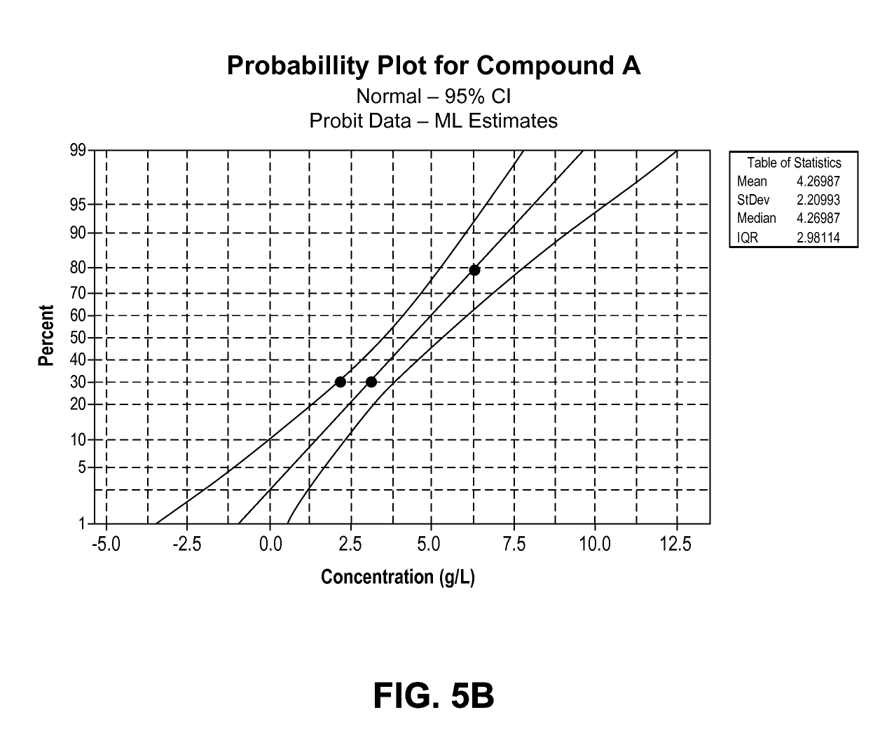

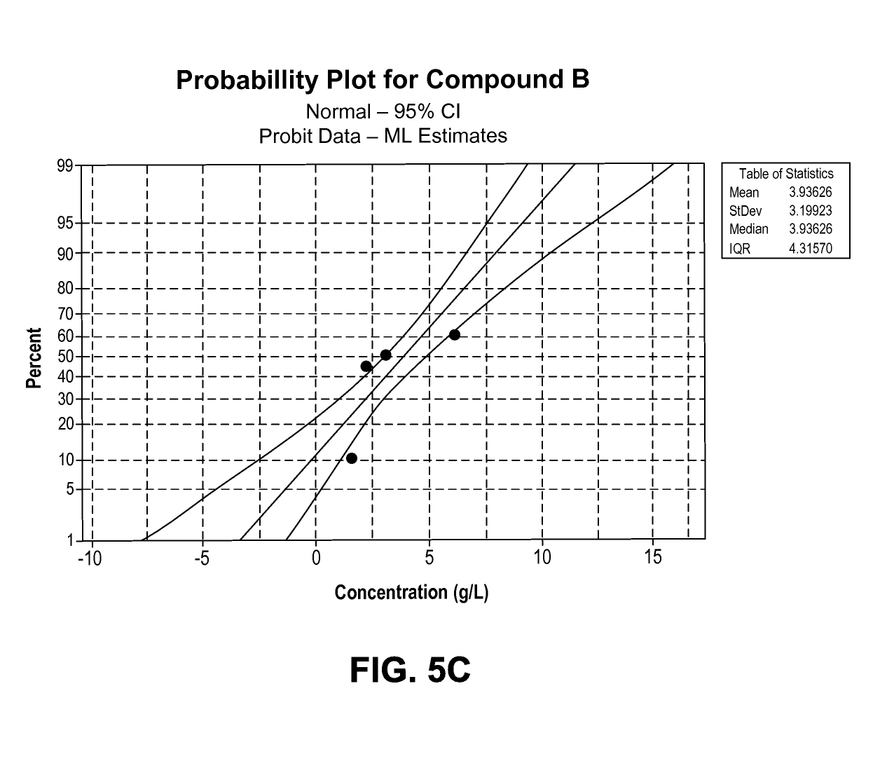

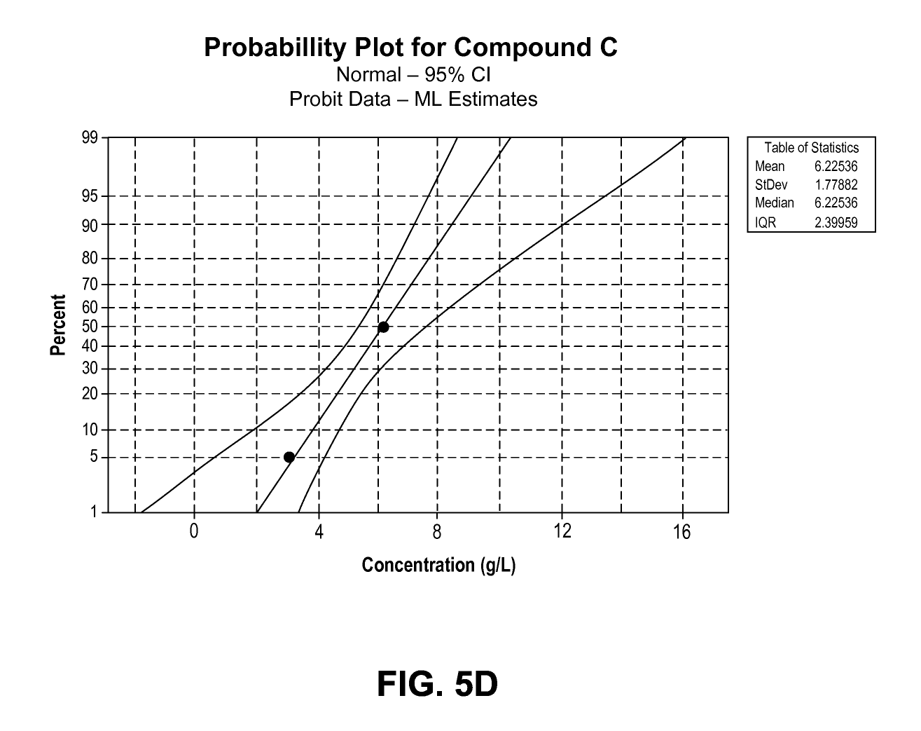

Statistical analysis revealed Control (caffeine extract formulation) demonstrated mollusk feeding suppression only at concentrations of 6.25 g/L and 12.5 g/L as shown in TABLE 17A and FIG. 5A. Further, compound A had the highest mollusk feeding reduction, at a concentration of 6.25 g/L or higher as shown in TABLE 17B and FIG. 5B. Similarly, statistical analysis showed compound B had the highest levels of suppressing mollusk feedings at concentrations of 6.25 g/L and 12.5 g/L as shown in TABLE 17C and FIG. 5C. Of note, due to the limitations of the trial, compound B's reduced concentration of 2.34 g/L was not included in the ANOVA analysis. Statistical analysis also established compound C suppression capabilities were limited to concentrations of 6.25 g/L and 12.5 g/L, respectively as shown in TABLE 17D and FIG. 5D.

TABLE 17A
Statistical Analysis of Cumulative Leaf Disc Consumption
Following Caffeine Alone Forced Ingestion

| Treatment | DAT 1 | DAT 2 | DAT 3 | DAT 4 | DAT 5 |
|---|---|---|---|---|---|
| Control (Untreated) | 4.2 | 7.4 | 10.4 | 16.3 | 23.1 |
| Control (Caffeine | 0.0 | 0.0 | 0.0 | 0.0 | 0.0 |
| extract formulation) | | | | | |
| (12.5 g/l) | | | | | |
| Control (Caffeine | 0.0 | 0.0 | 0.8 | 1.8 | 4.1 |
| extract formulation) | | | | | |
| (6.25 g/l) | | | | | |
| Control (Caffeine | 2.0 | 3.9 | 6.0 | 10.4 | 15.5 |
| extract formulation) | | | | | |
| (3.125 g/l) | | | | | |
| Control (Caffeine | 2.9 | 5.7 | 8.2 | 15.4 | 20.4 |
| extract formulation) | | | | | |
| (1.56 g/l) | | | | | |

ANALYSES

| | | | | | |
|---|---|---|---|---|---|
| Standard Deviation | 2.276 | 3.690 | 4.895 | 6.808 | 9.478 |
| P (Bartlett's X²) | 0.074 | 0.177 | 0.000 | 0.000 | 0.143 |
| Transformation | None | None | Not | Not | None |
| | | | possible | possible | |
| Treatment F | 13.01 | 16.38 | 17.19 | 24.61 | 22.85 |
| Treatment Prob (F) | <0.001 | <0.001 | <0.001 | <0.001 | <0.001 |

(Where mean values followed by the same letter do not significantly differ (P = 0.05, Tukey Kramer HSD). Where transformations were required, data values listed in the table refer to untransformed means.

TABLE 17B
Statistical Analysis of Cumulative Leaf Disc Consumption
Following Compound A Forced Ingestion

| Treatment | DAT 1 | DAT 2 | DAT 3 | DAT 4 | DAT 5 |
|---|---|---|---|---|---|
| Control (Untreated) | 5.3 | 10.4 | 15.2 | 21.2 | 27.7 |
| Compound A (12.5 g/l) | 0.0 | 0.0 | 0.0 | 0.0 | 0.0 |
| Compound A (6.25 g/l) | 0.0 | 0.0 | 0.2 | 0.6 | 1.1 |
| Compound A | 1.2 | 2.8 | 4.7 | 6.2 | 9.0 |
| (3.125 g/l) | | | | | |
| Compound A (1.56 g/l) | 3.2 | 7.4 | 11.9 | 15.9 | 20.8 |

ANALYSES

| | | | | | |
|---|---|---|---|---|---|
| Standard Deviation | 2.436 | 4.650 | 6.833 | 8.497 | 10.38 |
| P (Bartlett's X²) | 0.905 | 0.000 | 0.000 | 0.026 | 0.166 |
| Transformation | SQRT | Not | Not | SQRT | SQRT |
| | | possible | possible | | |
| Treatment F | 39.95 | 19.53 | 20.41 | 58.92 | 65.02 |
| Treatment Prob (F) | <0.001 | <0.001 | <0.001 | <0.001 | <0.001 |

(Where mean values followed by the same letter do not significantly differ (P = 0.05, Tukey Kramer HSD). Where transformations were required, data values listed in the table refer to untransformed means.

TABLE 17C
Statistical Analysis of Cumulative Leaf Disc Consumption
Following Compound B Forced Ingestion

| Treatment | DAT 1 | DAT 2 | DAT 3 | DAT 4 | DAT 5 |
|---|---|---|---|---|---|
| Control (Untreated) | 4.2 | 8.4 | 12.2 | 16.4 | 21.7 |
| Compound B (12.5 g/l) | 0.0 | 0.0 | 0.0 | 0.0 | 0.0 |
| Compound B (6.25 g/l) | 0.0 | 0.4 | 1.2 | 2.0 | 3.8 |
| Compound B (3.125 g/l) | 0.7 | 2.0 | 3.1 | 3.9 | 5.2 |
| Compound B (1.56 g/l) | 3.1 | 4.9 | 6.5 | 9.3 | 12.3 |

ANALYSES

| | | | | | |
|---|---|---|---|---|---|
| Standard Deviation | 2.313 | 3.531 | 4.887 | 6.348 | 7.699 |
| P (Bartlett's X²) | 0.153 | 0.000 | 0.116 | 0.077 | 0.092 |
| Transformation | SQRT | Not | SQRT | SQRT | None |
| | | possible | | | |
| Treatment F | 22.21 | 19.70 | 28.13 | 29.84 | 24.75 |
| Treatment Prob (F) | <0.001 | <0.001 | <0.001 | <0.001 | <0.001 |

(Where mean values followed by the same letter do not significantly differ (P = 0.05, Tukey Kramer HSD). Where transformations were required, data values listed in the table refer to untransformed means.

TABLE 17D
Statistical Analysis of Cumulative Leaf Disc Consumption
Following Compound C Forced Ingestion

| Treatment | DAT 1 | DAT 2 | DAT 3 | DAT 4 | DAT 5 |
|---|---|---|---|---|---|
| Control (Untreated) | 3.6 | 5.6 | 8.5 | 11.9 | 15.9 |
| Compound C (12.5 g/l) | 0.0 | 0.0 | 0.0 | 0.0 | 0.0 |
| Compound C (6.25 g/l) | 0.0 | 0.5 | 1.2 | 2.4 | 3.3 |
| Compound C | 1.9 | 5.7 | 9.1 | 14.7 | 19.0 |
| (3.125 g/l) | | | | | |
| Compound C (1.56 g/l) | 2.9 | 5.2 | 8.2 | 12.8 | 17.8 |

ANALYSES

| Standard Deviation | 2.073 | 4.074 | 6.027 | 8.908 | 11.93 |
|---|---|---|---|---|---|
| P (Bartlett's X²) | 0.986 | 0.000 | 0.000 | 0.000 | 0.000 |
| Transformation | None | Not possible | | | |
| Treatment F | 12.64 | 10.01 | 10.65 | 11.18 | 11.03 |
| Treatment Prob (F) | <0.001 | <0.001 | <0.001 | <0.001 | <0.001 |

(Where mean values followed by the same letter do not significantly differ (P = 0.05, Tukey Kramer HSD). Where transformations were required, data values listed in the table refer to untransformed means.

The percent reduction feeding damage intensity following forced ingestion was calculated for each assessment day using the following equation:

R=100((Ū−T̅)/U̅)
Where: R=percentage reduction in feeding damage; T=mean percentage damage to lettuce discs recorded in treated arenas; U=mean % damage to lettuce discs recorded in control arenas.

After one day following treatment (“DAT 1”) by forced ingestion, both compounds A and C achieved ≧69% reduction in mollusk feeding damage, at the reduced concentration of 2.34 g/L, as shown in TABLE 18. However, at concentrations of 6.25 g/L or higher, all four compounds, A, B, C, and Control (Caffeine extract formulation), demonstrated a reduction in mollusk feeding damage after only one day (“DAT 1”) following treatment by forced ingestion, relative to the untreated control, as shown in TABLE 18. (A negative value indicated an increase in feeding damage compared to control.) In an attempt to differentiate between the two best performing compounds, A and B, two-sample t-tests were used to compare each compound against the untreated control at 2.34 g/L. Analysis revealed there was a statistically significant difference for both compounds A and B compared to untreated control two days after treatment (“DAT 2”) through five days after treatment (“DAT 5”) as shown in TABLE 19. (DAT 2 p<0.005).

TABLE 18
Percent Reduction in Severity of Mollusk Feeding
Damage for Compounds A, B, C, and Caffeine Alone

| | | DAT | DAT | DAT | DAT | |
|---|---|---|---|---|---|---|
| Treatment | Concentration | 1 | 2 | 3 | 4 | DAT 5 |
| Control | 12.5 g/l | 100 | 100 | 100 | 100 | 100 |
| (Caffeine extract | 6.25 g/l | 100 | 100 | 92 | 89 | 82 |
| formulation) | 3.125 g/l | 54 | 48 | 43 | 36 | 33 |
| | 1.56 g/l | 31 | 23 | 21 | 6 | 12 |
| | 0.781 g/l | −5 | 10 | 15 | 12 | 16 |
| Compound A | 12.5 g/l | 100 | 100 | 100 | 100 | 100 |
| | 9.375 g/l | 100 | 100 | 100 | 100 | 100 |
| | 6.25 g/l | 100 | 99 | 99 | 97 | 96 |
| | 3.125 g/l | 77 | 73 | 69 | 71 | 68 |
| | 2.34 g/l | 75 | 68 | 66 | 69 | 70 |
| | 1.56 g/l | 41 | 29 | 22 | 25 | 25 |
| Compound B | 12.5 g/l | 100 | 100 | 100 | 100 | 100 |
| | 9.375 g/l | 100 | 100 | 100 | 100 | 100 |
| | 6.25 g/l | 100 | 93 | 86 | 84 | 76 |
| | 3.125 g/l | 85 | 77 | 75 | 76 | 76 |
| | 2.34 g/l | 69 | 65 | 66 | 67 | 53 |
| | 1.56 g/l | 27 | 42 | 47 | 43 | 43 |
| Compound C | 12.5 g/l | 100 | 100 | 100 | 100 | 100 |
| | 6.25 g/l | 100 | 93 | 91 | 88 | 89 |
| | 3.125 g/l | 47 | −2 | −7 | −24 | −19 |
| | 1.56 g/l | 19 | 7 | 4 | −8 | −12 |

TABLE 19
Two-Sample t-Test Between Compounds A, B and Untreated Control

| | DAT 1 | | | DAT 2 | | | DAT 3 | | | DAT 4 | | | DAT 5 | | |
|---|---|---|---|---|---|---|---|---|---|---|---|---|---|---|---|
| Treatment | T | P | DF | T | P | DF | T | P | DF | T | P | DF | T | P | DF |
| Compound A | −3.76 | ≦0.001 | 36 | <3.33 | <0.005 | 32 | −3.50 | ≦0.001 | 37 | −4.28 | ≦0.001 | 37 | −4.02 | ≦0.001 | 32 |
| (2.45 g/l) | | | | | | | | | | | | | | | |
| Compound B | −2.88 | ≦0.001 | 32 | −3.21 | ≦0.005 | 32 | −3.66 | ≦0.001 | 35 | −4.27 | ≦0.001 | 36 | −2.67 | ≦0.05 | 37 |
| (2.34 g/l) | | | | | | | | | | | | | | | |

### Example 4

### Effects of Combined Solution Containing Sapindus saponaria and Caffeine Extracts in an Aquatic Environment

Adult aquatic mollusks, Pomacea spp. (approximately 1-1.5 inch shell height) were commercially sourced from a local aquatic pet store and maintained in tanks filled with dechlorinated water under appropriate environmental conditions (28° C. and a 16 hr. light photoperiod) prior to the experiment. Prior to testing, adult mollusks were pre-starved for a period of 48 hours.

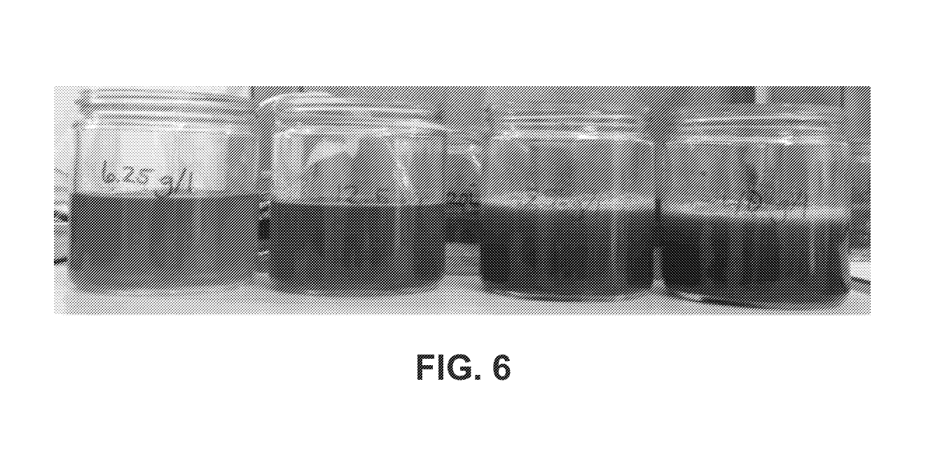

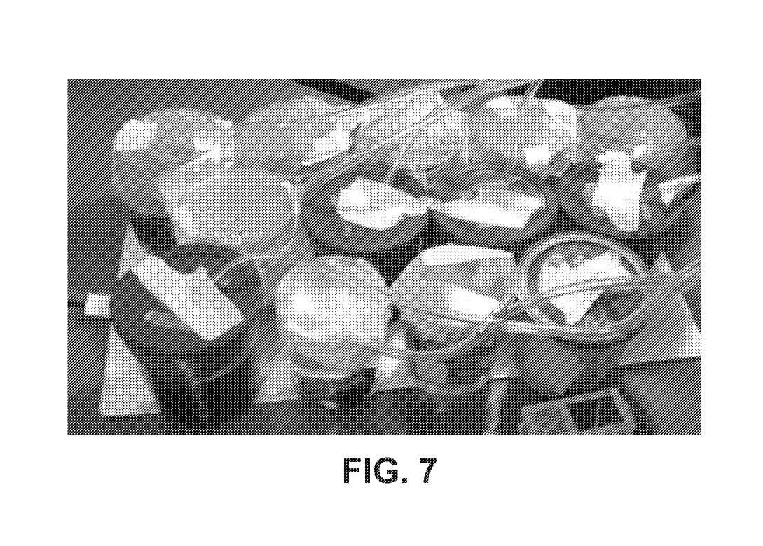

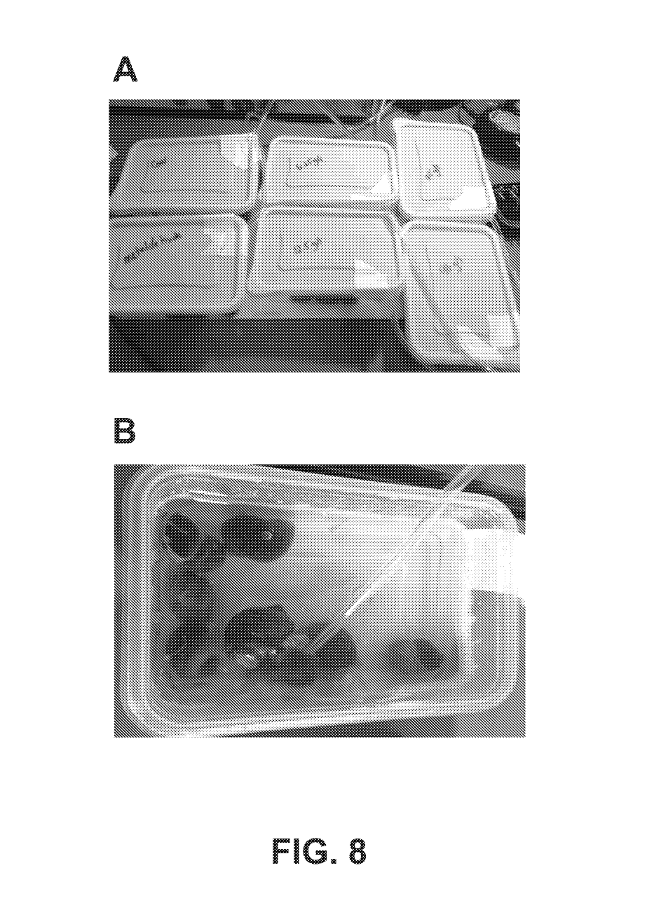

A caffeine extract was prepared using liquid-liquid extraction with ethyl acetate on roasted and ground beans from the Coffea arabica plant. HPLC experiments determined the purity of the caffeine was 97.6%. NMR analysis revealed the remaining 2.4% of impurities were identified as phenolic acids, namely caffeic acid and protocatechuic acid. Sapindus saponaria extract was prepared, as previously described herein and in U.S. Pat. No. 8,298,590, which is herein incorporated by reference in its entirety. NMR experiments determined that each Sapindus saponaria extract solution contained three hederagenin-derived saponins, representing 62.3% of the extract, free sugars representing 20.5% of the extract, and 17.2% other metabolites. The Sapindus saponaria extract and caffeine dilutions were combined to create “compound A.” Compound A contained 33.0% caffeine extract, 61.2% calcium lignosulphonate, 3.0% carboxymethyl cellulose, 2.0% sodium chloride and 0.5% Sapindus saponaria extract. Dilutions of compound A at 6.25 g/L, 12.5 g/L, 25 g/L and 40 g/L were prepared using distilled water and added to test containers as shown in FIG. 6. Compounds were tested against an untreated control (“Untreated Control”) and a known molluscicide (“Positive Control”) in all trials. All test containers contained 200 mL of a single control or test solution. Five mollusks (5) were added to each individual test container and the container was covered with a plastic film. All test containers were aerated with standard tubing and tank air pump and placed on an aquarium heating pad to provide a 28° C. environment as shown in FIG. 7. After a 48 hour exposure to the test solutions, mollusks were transferred to clean water tanks that were also aerated with standard tubing and tank air pump. Also, all clean water tanks were placed on an aquarium heating pad to provide a 28° C. environment. A typical clean water tank is shown in FIGS. 8A and 8B.

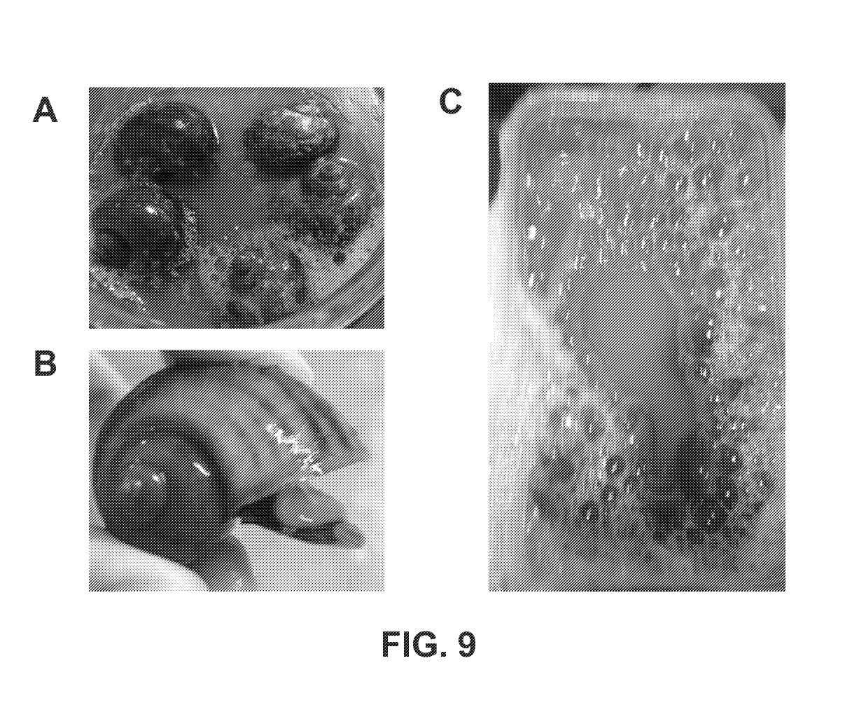

Mollusk mortality was assessed by mechanical stimulation during the mollusk's transfer to the clean water tank and again 24 hours after transfer. Dead mollusks were evidenced by a lack of movement following mechanical stimulation, floating on the surface of the test solution, as show in FIG. 9A, and/or sagging of the mollusk's operculum, as shown in FIG. 9B. Compound A at a concentration of 40 g/L provided a higher efficacy than the positive control following a 48 hour exposure. 72 hours following exposure, compound A at both 25 g/L and 40 g/L indicated a higher efficacy than the positive control. A complete list of the results is found below in TABLE 20.

TABLE 20
Mollusk Mortality Following Exposure to Compound A in
an Aquatic Environment

Number of Mollusks
Affected/Dead

| Treatment | 48 Hours | 72 Hours |
|---|---|---|
| Untreated Control | 1 | 1 |
| Positive Control | 6 | 7 |
| Compound A, | 2 | 5 |
| 6.25 g/L | | |
| Compound A, | 4 | 7 |
| 12.5 g/L | | |
| Compound A, | 6 | 9 |
| 25 g/L | | |
| Compound A, | 8 | 10 |
| 40 g/L | | |

### Example 5

### Molecular Characterization of Caffeine Extract

Caffeine is the main alkaloid of coffee and its main sources are plants of the genus Coffea (Rubiacea family). Caffeine purification was carried out from an aqueous coffee extract produced from roasted and ground Coffea arabica coffee beans. The extract was subjected to liquid-liquid extraction with ethyl acetate. The organic solvent was then evaporated to obtain the purified caffeine. Caffeine extracts used in the methods disclosed in the present application had an average moisture of 11.5% (data obtained by drying the caffeine extract in an oven at 110° C. and with drying agent at room temperature under reduced pressure, besides determining by humidity balance). The caffeine product had a dark brown color because the coffee roasting process and preparation of the extract generated a series of brown compounds and Maillard reactions.

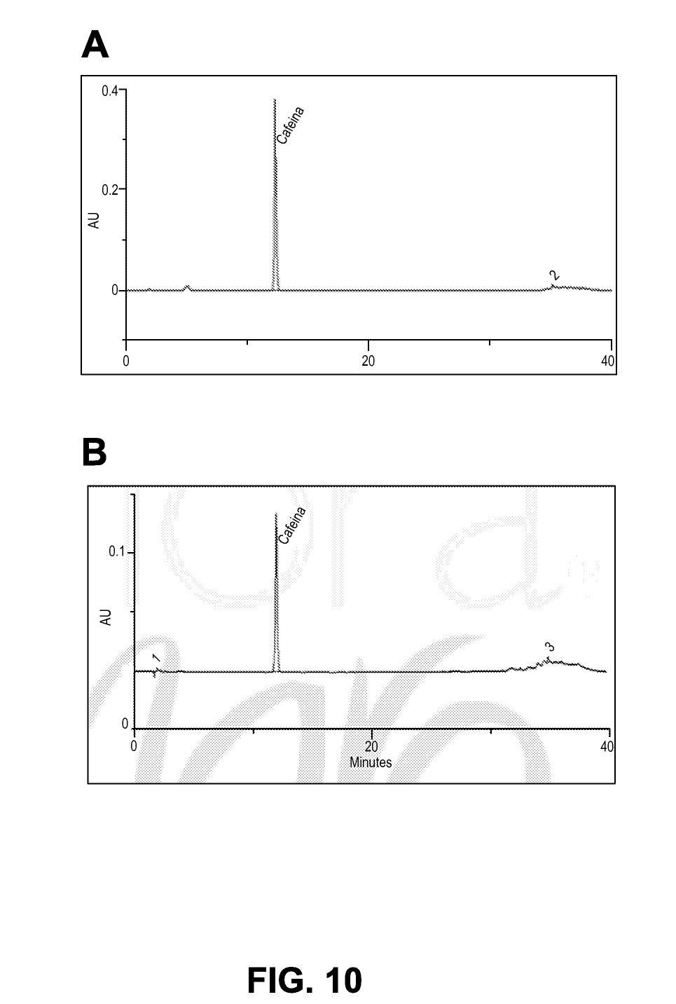

The purity of the caffeine extract samples was determined by HPLC and NMR. To determine caffeine purity by HPLC, an HPLC apparatus with diode array detector (Gilson) and an Eclipse XDB-C18 column, 4.6×150 mm, 5 μm were used. A solved gradient was applied. The gradient started with 90% solvent A (0.5% acetic acid), reaching 50% in 30 minutes, and ending at 33 minutes with 90% solvent B (acetonitrile). 90% solvent B was maintained for 2 minutes and then returned to initial conditions. Elution was monitored at a wavelength of 254 nm. Retention times of pure caffeine (control) and caffeine extract were compared. The elution times were identical, and both samples exhibited the same absorbance maximum in the UV-Vis spectrum (FIG. 10).

A calibration curve was prepared with caffeine 99.9% (Sigma-Aldrich). The curve contained 4 points, and was prepared by serial dilution from 62.5 ppm to 7.81 ppm. A caffeine extract was prepared (1200 mg/ml) and diluted 1:30 before injection into the HPLC apparatus. The purity of the caffeine extract was 97.6% (11172.73 mg of pure caffeine per ml).

¹H and ¹³C nuclear magnetic resonance (NMR) was also used to characterize the caffeine extracts. 30 mg of caffeine extract were dissolved in 0.6 mL of CDCl₃-d₁. Samples were analyzed by NMR using a Bruker 300 MHz apparatus with Fourier transform. The NMR spectra demonstrated that the caffeine extract sample contained almost exclusively caffeine. The spectra showed three singlets with 3 protons each, corresponding to the three methyls bound to nitrogens in the caffeine molecule, and a low field proton at 7.5 ppm corresponding to the CH double bond. Similarly, the ¹³C spectrum showed the characteristic carbons of caffeine, leaving no doubt regarding the chemical identity of the substance and its purity. No impurities were observed.

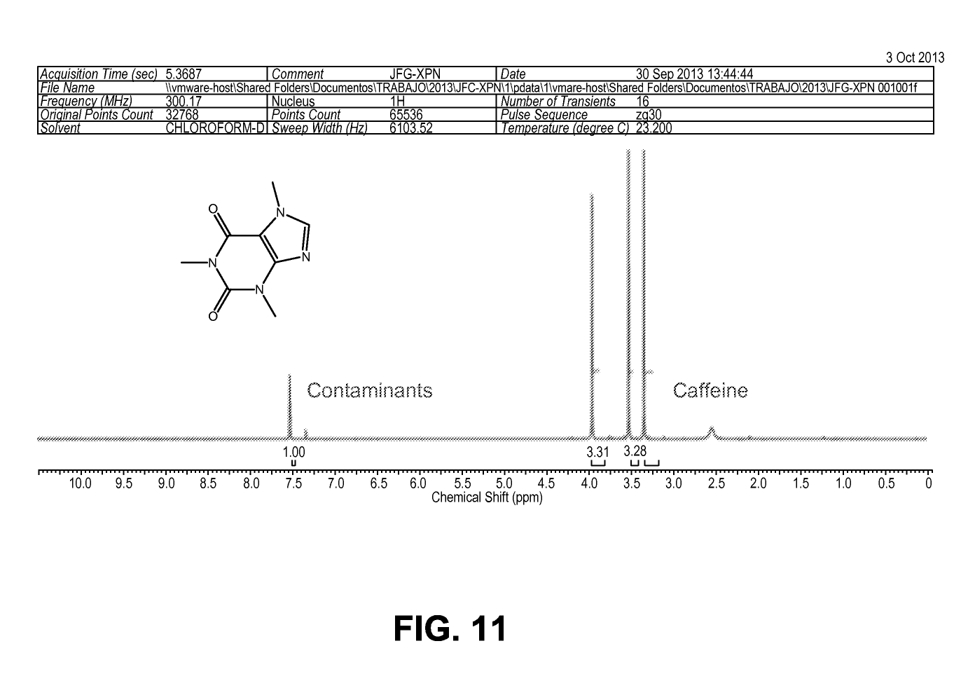

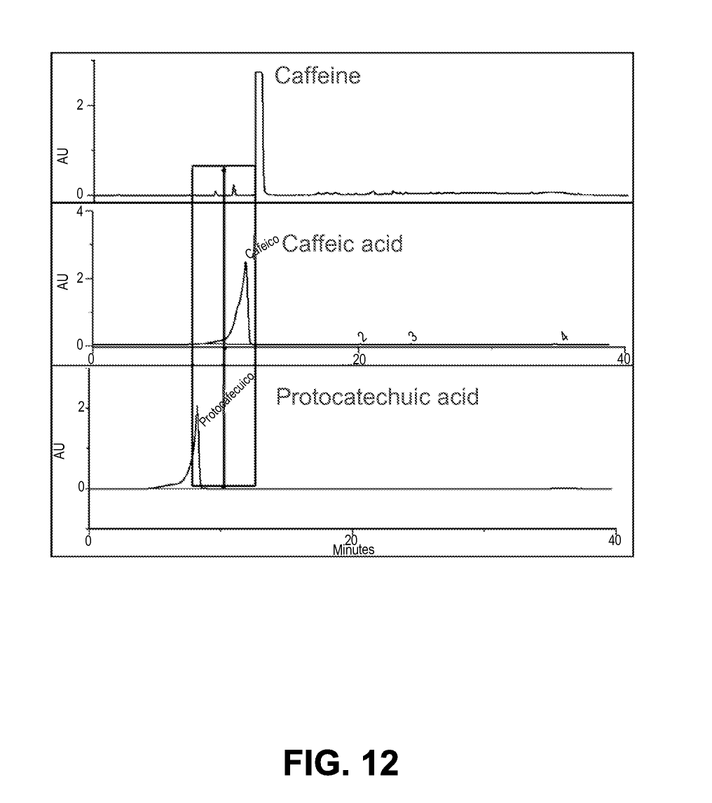

For the determination of compounds other than caffeine in the caffeine extracts, caffeine was removed in order to concentrate the additional substances to a level that would allow their identification. To achieve this, 100 grams of caffeine extract were dried and dissolved in dichloromethane. The solution was filtered using a PTFE filter with a 0.45 μm pore size. The filtration step was followed by drying, leaving 93.5 g of a white substance (pure caffeine). The residue was dissolved this time with methanol and filtered again. The remaining residue, 300 mg of insoluble material, was determined to be vegetal residue by microscopy. The residue contains small toasted coffee grain particles which are incorporated as impurities during the preparation of the caffeine extract. The methanolic filtrate was dried, yielding 6.4 g. Of those, 50 mg were dissolved in DMSO-d₆ and analyzed by ¹H and ¹³C NMR and HPLC. NMR results showed that the sample consisted mostly of caffeine, plus some compounds having aromatic hydrogens with displacements between 6.5 ppm and 8 ppm (FIG. 11). These protons are characteristic of phenolic acids, which are abundant in coffee. The HPLC profile showed that the main component was caffeine, but small amounts of other molecules were also observed, in particular protocatechuic acid and caffeic acid (FIG. 12). Other peaks at times of major and minor retention belonged to a series of polyphenols that are abundant in coffee.

Considering the need to remove as moisture as possible from the caffeine extracts in the shortest possible time, a thermal stability analysis was performed. The caffeine extracts were dried at four temperatures: 25° C., 110° C., 160° C. and 200° C., for one hour and then weighed to determine the amount of material lost due to thermal decomposition. Caffeine was also quantitated by HPLC to determine the thermal stability of the molecule. The results showed that caffeine was stable even at 160° C. and suffered no thermal decomposition. Pyrolysis and caffeine sublimation were observed at 200° C.

Based on these characterization experiments, the caffeine-containing plant extracts used in the instant application had the properties shown in TABLE 21.

TABLE 21
Properties of caffeine-containing plant extracts

| Parameter | Value |
|---|---|
| Humidity | 11.5% |
| Purity (dry base) | 97.6% |
| Color (dry base) | Light brown |
| Phenolic acids | 1.7% |
| Other soluble compounds | 0.3% |
| No identifiable | 0.4% |
| Maximum drying temperature | 160° C. |

### Example 6

### Molecular Characterization of Sapindus saponaria Extract

The fruits of the Sapindus saponaria tree, traditionally known as soap nut, jaboncillo or soap soldier, have been used in remote villages in Latin America as a soap substitute because its pericarp possesses surfactant capabilities and generates foam due to the large amount of saponins present. Saponins are triterpene molecules that have one or more sugar molecules attached. In Sapindus saponaria, the most abundant saponins are derived from the hederagenine sapogenin.

Sapindus saponaria extracts were obtained from a hydroalcoholic extract using seedless fruit from Sapindus saponaria. The extract was concentrated to remove the ethanol and dried using a spray drying process that yielded a highly hygroscopic yellowish powder. The Sapindus saponaria extract contains many saponins, which constitute a large percentage of its weight. The extract comprises also many sugars. Accordingly, both the saponin content and the sugar content were characterized.

To determine the major saponins present in the extract, sugars were separated using XAD7 amberlite exchange resin. The resin was added to the extract suspended in water, and saponins (due to the acid group in the hederagenin aglycone) were incorporated to the resin, leaving free sugars in solution. The sugarless Sapindus saponaria extract was recovered by adding alcohol.

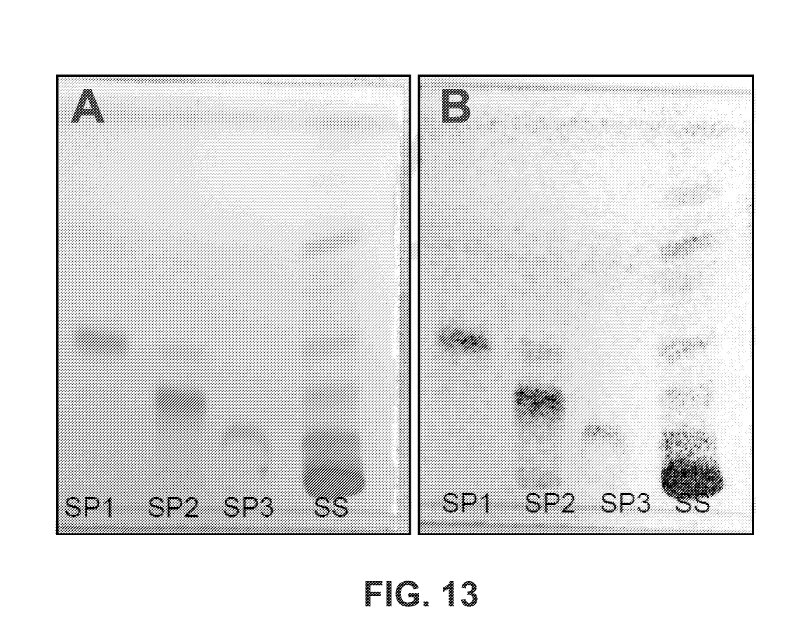

The alcoholic extract was dried under reduced pressure and subjected to chromatographic separation with Sephadex LH-20 using methanol as eluting solvent. Three fractions were obtained. Two fractions contained saponins, as determined by thin layer chromatography using vanillin as developing reagent, followed by heating. Positive fractions were re-chromatographed on silica gel using dichloromethane (DCM):Methanol (MeOH) 9:1 v/v as eluting solvent. Fifteen fractions were obtained, and their compositions monitored by TLC. Three saponin compounds were identified when the samples were separated using TLC and developed with vanillin (FIG. 13). These saponin compounds were designated SP1, SP2 and SP3.

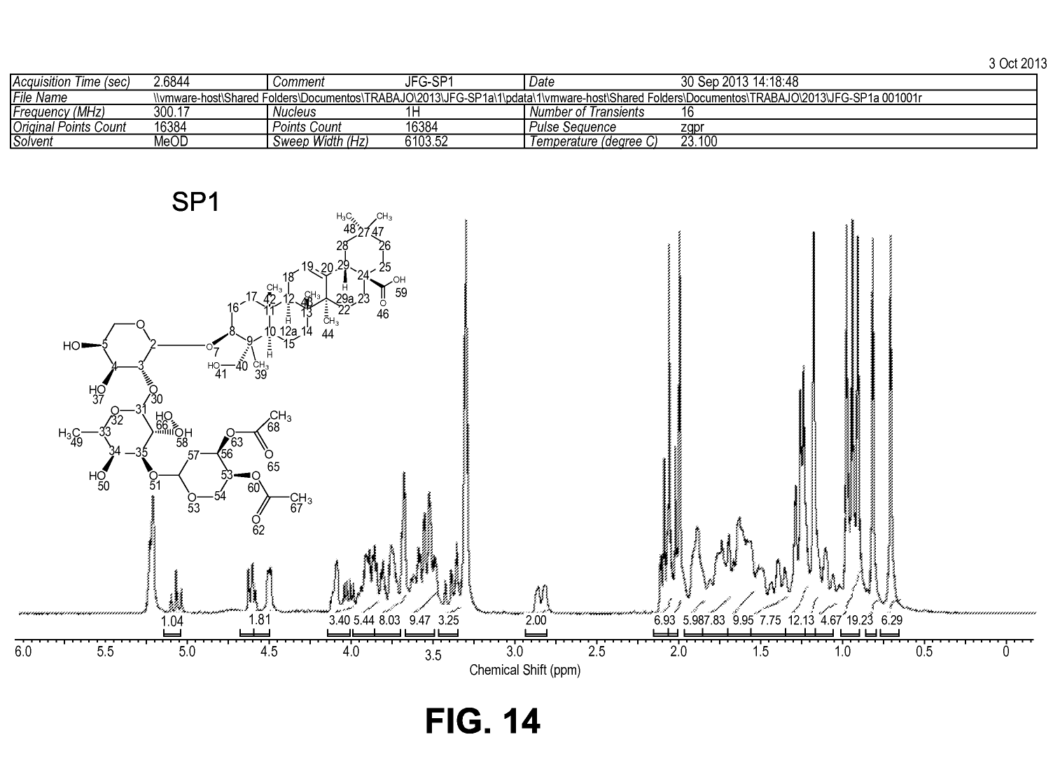

The isolated saponins were characterized using 1D and 2D NMR. For this, 50 mg of each sample were dissolved in 0.6 mL of MeOD-d₄ and analyzed using a Bruker 300 MHz nuclear magnetic resonance apparatus. The ¹H spectrum corresponding to SP1 is shown in FIG. 14. Signals belonging to the aglycone portion of saponins show up as abundant methyl and methylene groups, and a double bond with an offset about 5 ppm, which are signals characteristic of triterpenes. Additionally, the spectrum show sugar signals between 3 and 4 ppm and signals corresponding to 2 methyl acetate groups.

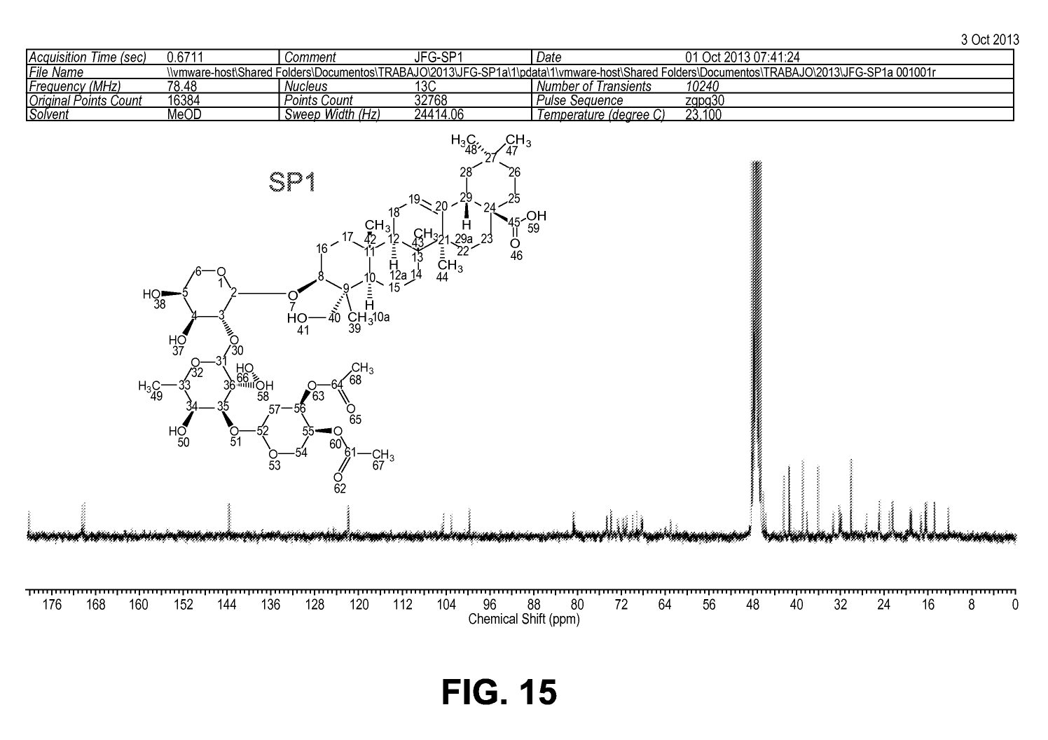

FIG. 15 shows a ¹³C NMR spectrum presenting a similar triterpene profile, with abundance of methyl and methylene groups, coupled with the presence of three carbonyl groups, one of them with a 180 ppm low displacement field corresponding to a carboxyl group. This carboxyl signal would correspond to the free acid group of the hederagenine aglycone. The remaining two carbonyls at 170 ppm correspond to the carbonyl groups of acetate, belonging to the sugar moiety of the saponin.

This experimental data, together with data available from the literature (Murgu et al., Journal of the Brazilian Chemical Society 17: 1281-1290, 2006; Ribeiro et al., Pharmaceutical Biology 33:177-180, 1995) identified SP1 as a saponin derivative of hederagenin with a sugar moiety comprising 3 monosaccharides (arabinose, rhamnose, and xylose, the latter with 2 acetylated hydroxyls). This compound is known as hederagenin-3-O-(3,4-O-diacetyl-beta-D-xylapyranosyl-(1→3)-alpha-L-rhamnopyranosyl-(1→2)-alpha-L-arabinopyranoside.

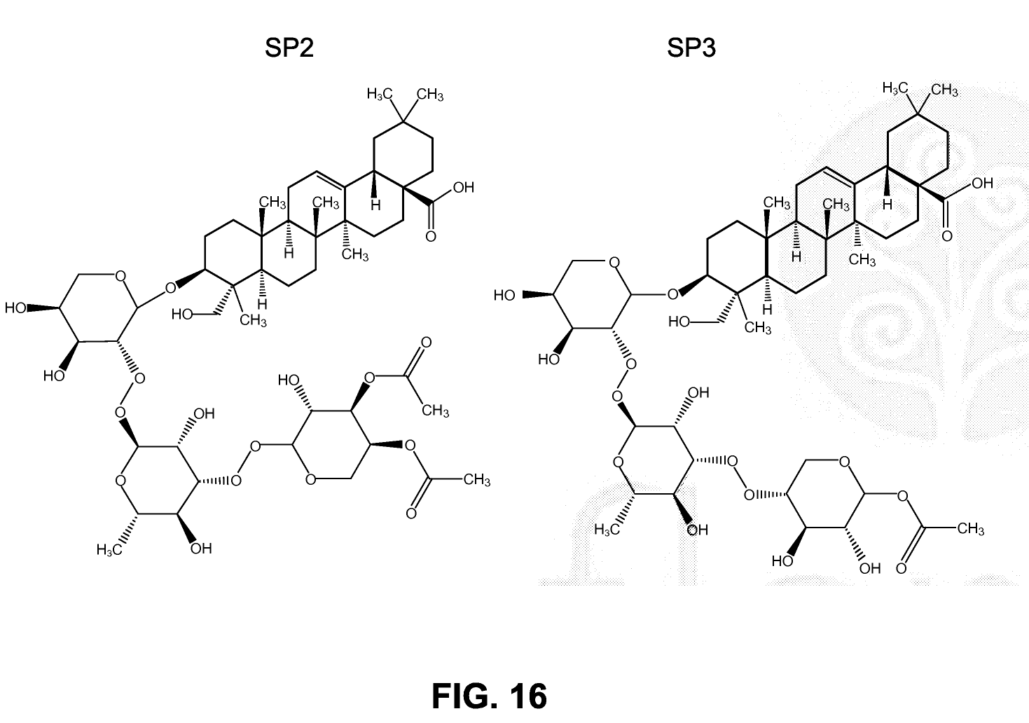

Likewise, when ¹H and ¹³C NMR spectra for SP2 and SP3 samples were analyzed, the data indicated that the structures also corresponded to hederagenin derivatives, but with differences in the sugar moiety. SP2 is hederagenin-3-O-(3,4-O-diacetyl-alpha-D-arabinopyranosyl)-(1→3)-alpha-L-rhamnopyranosyl-(1→2)-alpha-L-arabinopyranoside. SP3 is hederagenin-3-O-(4-O-acetyl-beta-D-xylopyranosyl)-(1→3)-alpha-L-rhamnopyranosyl-(1→2)-alpha-L-arabinopyranoside. See FIG. 16.

The major isolated saponins present in the Sapindus saponaria extracts (SP1, SP2, and SP3) were quantified to determine the amount of the compounds in the extracts used in the molluscicide compositions disclosed in the present application. HPLC-DAD (HPLC with diode array detector) is routinely used for this purpose. In most cases the technique cannot be applied to evaluate saponins because most of them lack chromophores and their maximum absorbance is not in the ultraviolet region of the spectrum. Using refractive index detection is also inadequate because the use of specific solvent mixtures and gradients causes problems in subsequent chromatographic steps. However, some saponins are exceptions to the rule because they contain chromophores that make possible their UV detection at low wavelengths. This is the case of the saponins from Sapindus saponaria. Since the hederagenin aglycone has a free acid which absorbs between 203 nm and 206 nm, it is possible the use the HPLC-DAD technique for quantification (Murgu et al., Journal of the Brazilian Chemical Society 17: 1281-1290, 2006; Oleszek, Journal of Chromatography A 967:147-162, 2002).

Saponins in Sapindus saponaria extracts were quantified using a Gilson HPLC apparatus equipped with a diode array detector and an Eclipse XDB-C₁₈, 4.6×150 mm, 5 μm C₁₈ column. The solvent gradient started with 70% solvent A (0.05% trifluoroacetic acid) to 39% solvent A in 29 minutes, and then to 80% solvent B (acetonitrile) in 32 minutes. The gradient was maintained at 80% solvent B for 2 minutes and then returned to initial conditions. 20 μL of sample were injected and monitoring took place at a wavelength of 203 nm.

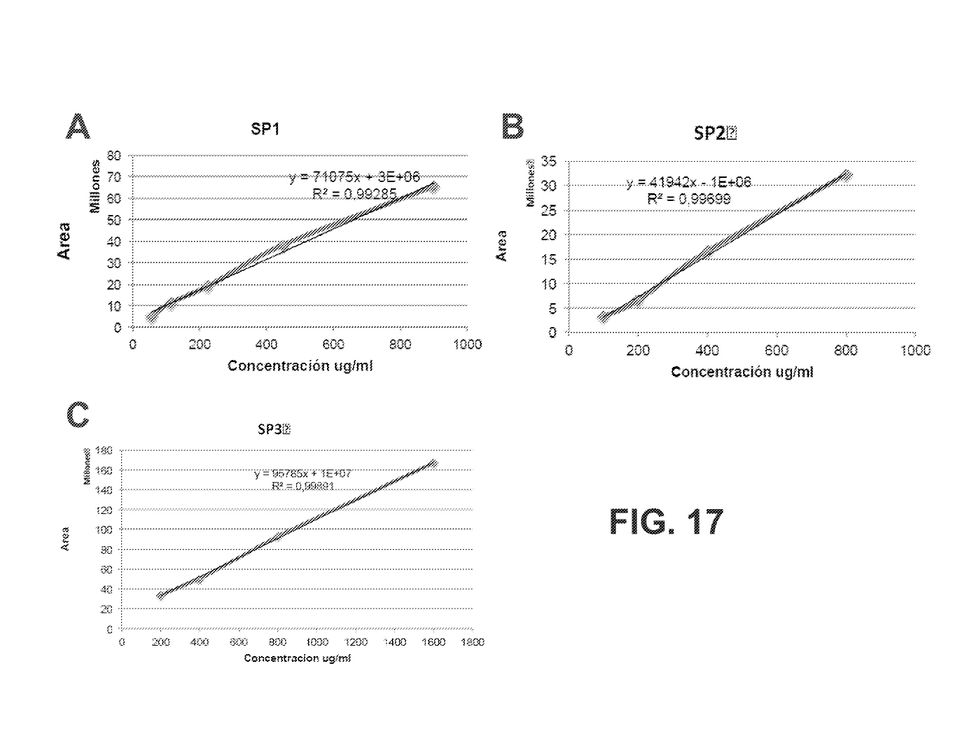

Two peaks were observed in the chromatogram for SP2. When the compounds in the two peaks were analyzed using HPLC-MS to determine their respective molecular weights, the molecular weights were the same and both compounds had the same fragmentation profile. This observed coincides with observations in Murgu et al (2006) indicating that the two peaks corresponded to two molecular isomers of the same compound. The difference between these two SP2 compounds is the position of acetyl groups on the last unit of the carbohydrate moiety (arabinose). On one isomer, carbons 3 and 4 are acetylated. In the other isomer, carbons beta and 5 are acetylated. In a molecule with 50 carbons, a slight change in the positions of functional groups does not cause a change in polarity sufficient to isolated each compound. Even NMR at 300 MHz could not differentiate both molecules. Therefore, the quantification of SP2 was done by adding the areas of the two analyzed peaks, reported as micrograms/ml of SP2. The same happened with SP3, which also showed two peaks, one smaller than the other. According to the HPLC-MS data, both peaks would correspond to isomers of SP3. The calibration curves for SP1, SP2 and SP3 are shown in FIG. 17.

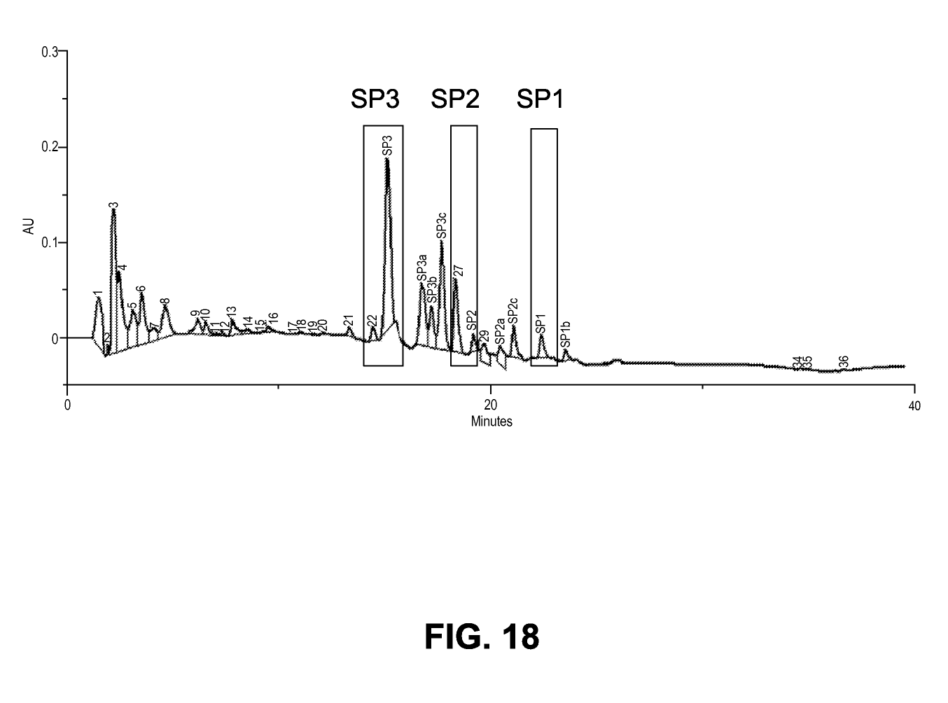

The SAP fraction of the extract (saponin fraction without sugars) was diluted 1:15, and 20 microliters were taken and injected into the HPLC. SP1, SP2, and SP3 were analyzed in the chromatogram. See FIG. 18.

TABLE 22 shows the calculations conducted to determine the amount of each saponin in the Sapindus saponaria extract. The amounts are reported as mg per mg of extract. The total amount of SP1, SP2 and SP3 was 261 mg per mg of extract.

TABLE 22
Quantification of saponins in Sapindus saponaria extract

| | | Concentration | | mg of |
|---|---|---|---|---|
| | | in saponin | Concentration | saponin |
| | Concentration in | fraction | of each | per |
| | diluted sample | (SAP) | compound in | gram of |
| Saponin | (micrograms/ml) | (mg/ml) | SAP (mg) | extract |
| SP1 | 78.3 | 1.17 | 58.7 | 12.5 |
| SP2 | 462.7 | 6.49 | 347.0 | 73.8 |
| SP3 | 1094.9 | 16.43 | 821.17 | 174.7 |

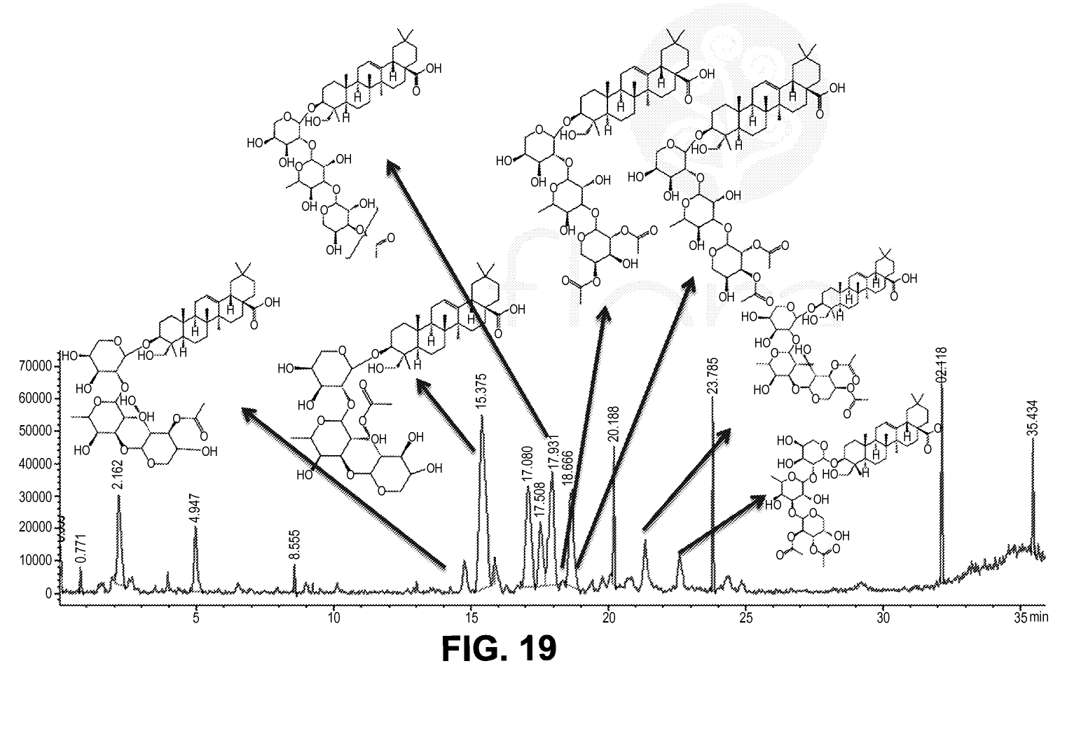

There are more three major saponins in the pericarp of the fruit of the soap nut tree (Sapindus saponaria), SP1, SP2, and SP3. For this reason, it was decided to obtain a mass profile of the saponins presents in the Sapindus saponaria extract used to manufacture the molluscicide compositions disclosed herein, e.g., compound A and compound B. A chromatographic run was performed under the same conditions described above for the quantification of saponin, but eluates were analyzed using a mass detector with ionizer electrospray, which was operated in negative mode with an ionization voltage of 3500 V. Total ion counts in the mass chromatogram where compared with data available in the literature in order to identify the products present in the sample. See FIG. 19. The mass chromatogram identified the presence of SP3, hederagenin-ara-rhamn-xyl-3-OAce, smaller amounts of hederagenin-ara-rhamn-xyl-4-OAce, two isomers of SP1 (hederagenin-ara-rhamn-xyl-3,4-OAce and hederagenin-ara-rhamn-xyl-3,5-OAce, two isomers of SP2 (hederagenin-ara-rhamn-are-3,4-OAce and hederagenin-ara-rhamn-ara-3,5-OAce).

Next, we quantified saponins and total sugars. Saponins have carbohydrate units, which behave as sugars and result in overquantification when the sugars (free sugars) present in Sapindus Saponaria extracts. For this reason, it was necessary to separate free sugar from saponin-bound sugar in the extract samples. Solid Phase Extraction (SPE) using octadecylsilane cartridges was used to separate saponins and free sugars. Octadecylsilane cartridges retain free sugar but no saponins. A cartridge containing 5 grams of octadecylsilane in distilled water was prepared. 4.7 grams of Sapindus saponaria dry extract were resuspended in 10 ml of water:methanol 8:2 (v/v) and added to the cartridge. The cartridge was washed with 30 ml of water, with a 4 ml/min flow, and the fraction of free sugars without saponins was collected and metered using a 50 ml volumetric flask. As much water as possible was removed from the cartridge using vacuum and rinsed with 100 ml of methanol, also with a 4 ml/min flow. The eluted fraction contained the saponins Methanol was removed from the saponin fraction under reduced pressure.

To quantify the fraction of total sugars, the sugars not bound to saponins (free sugars), sugars in the saponin fraction (SAP), and sugars in the crude Sapindus saponaria extract were analyzed. The total sugar content was determined using UV-Vis spectrophotometry.

TABLE 23
Total content of sugars in the free sugar fraction, saponin fraction,
and crude Sapindus saponaria extract.

| | | Grams of | mg of | |
|---|---|---|---|---|
| | Total | Sugars in | sugar/g | % sugar in |
| Sample | sugar (%) | solution | of extract | extract |
| Free sugar | 1.93 | 0.965 | 205 | 20.5 |
| fraction | | | | |
| Saponin | 4.53 | 2.265 | 481 | 48.1 |
| fraction | | | | |
| Crude | 4.68 | 2.348 | 634 | 63.4 |
| Extract | | | | |

TABLE 23 shows the total amount of sugars presents in Sapindus saponaria extract (63.4%). However, this total amount contains both free sugars and sugars in saponins Sugars in saponin are 48.1% of the total amount of sugar in the extract, i.e., 75.8% of the total sugar was in saponins. Accordingly, the amount of free sugar would be 20.5% of the total sugar in the extract.

Total saponin content was also determined. The major saponins in the Sapindus saponaria extract are known, but there are number of components similar to the major saponins, which there are expected to have similar biological activity. Several spectrophotometric techniques can be used to quantify total saponins, all of which are based on the use of vanillin (3-methoxy-4-hydroxybenhaldehide), which acts and a chromophore and allow the saponins in the solution to take a purple color that can be analyzed in a spectrophotometer. The methods used were based on the methods disclosed in Li et al. (Proceedings of 2012 International Conference on Mechanical Engineering and Material Science, MEMS 2012, 451-465), Madland (Extraction, Isolation and Structure Elucidation of Saponins from Herniaria incana. Norwegian University of Science and Technology, 2013); and, Zhang et al. (Pratacultural Science 8:28, 2009) with some modifications.

A standard solution of SP2 saponin at 800 micrograms/ml was prepared. Dilutions at 640, 400, 320, and 160 micrograms/ml were prepared. 0.5 ml of each dilution were added to test tubes, 0.5 ml of vanillin reagent (8% vanillin in acetic acid) and 5 ml of 77% sulfuric acid were added to each tube. The tubes were heated at 60° C. for 20 minutes. Tubes were cooled at room temperature and the absorbance was measured on a Shimazu spectrophotometer at 550 nm.

The saponin fraction sample from the sugars separation was dilute 1:100. Vanillin reagent and sulfuric acid were added to 0.5 ml of this sample under conditions identical to the calibration conditions described above. A standard curve was also generated as shown in TABLE 24. Absorbance values for the samples with respect to the standard curve were used to calculate the amounts of saponins in the sample. See TABLE 24, sample column.

TABLE 24
Standard absorbance results to construct a calibration
curve for determining the total concentration of
saponins in the Sapindus saponaria extract.

| | Point 1 | Point 2 | Point 3 | Point 4 | Point 5 | Sample |
|---|---|---|---|---|---|---|
| Concentration | 160 | 320 | 400 | 640 | 800 | |
| Absorbance | 0.057 | 0.190 | 0.240 | 0.426 | 0.523 | 0.394 |
| S.D. | 0.001 | 0.001 | 0.004 | 0.002 | 0.002 | 0.001 |

The Sapindus saponaria extract contained 623 mg of total saponins per gram of crude extract, which include 261 mg of the three major saponins (SP1, SP2 and SP4). Thus, SP1, SP2 and SP3 are 41.3% of the total saponin content. See TABLE 25.

TABLE 25
Absorbance signal in Sapindus saponaria extract (SS) and calculations for
determination of total saponins in extract

| | | Concentration in | | | |
|---|---|---|---|---|---|
| | Sample | Saponin fraction | Concentration | Saponins | Saponins |
| Absorbance | concentration | (SAP) (1:00) | in SAP | in 50 ml | in SS |
| of sample | (micrograms/ml) | (micrograms/ml) | (mg/ml) | (grams) | (mg/g) |
| 0.394 | 584.28 | 58400 | 58.4 | 2.93 | 623 |

Based on these characterization experiments, the saponin-containing plant extracts used in the instant application had the properties shown in TABLE 26.

TABLE 26
Technical data for Sapindus saponaria extract

| Component | Amount in Extract (%) |
|---|---|
| Total saponins | 62.3 |
| Total sugars | 20.5 |
| Other compounds | 17.2 |

### Example 7

### Molluscicide Compositions Comprising Caffeine and Sapindus saponaria Extracts to Control Pests in Banana Plants

The compound test was “Compound A.” Compound A contained 33.0% caffeine extract, 61.2% calcium lignosulphonate, 3.0% carboxymethyl cellulose, 2.0% sodium chloride and 0.5% Sapindus saponaria extract. The experiments were conducted in a shade house. Plastic plates and baskets for cover were used to keep the snails in contact with the products. Live snails were obtained by collection/pick up in a banana plantation. Approximately 250 snails were captured early in the morning, the time of day when they are still found in large numbers on the leaves and trunks of banana plants.

The following treatments were carried out: (T0) control, 20 ml water/plate; (T1) Compound A, 20 g/L. 20 mL/plate; (T2) Compound A, 30 g/L, 20 mL/plate; (T3) Compound A, 40 g/L, 20 mL/plate; (T4) BROMOREX® 9.37 EC 10 ml/L, 20 mL/plate; (T5) BROMOREX® 9.37 EC 10 ml/L, 30 mL/plate; (T6) BROMOREX® 9.37 EC 40 ml/L, 20 mL/plate; and (T7) methaldehyde, 2 g/plate. BROMOREX® 9.37 is a liquid formulation comprising capsicum extract and mustard essential oil. metaldehyde is a chemical molluscicide.

Four plates per treatment were randomly arranged on a shelf in the shade house. At the bottom of each plate small portions of banana leaves, papaya, and two slices of ripe bananas were placed. 20 mL of each sample was poured into each plate. Eight live snails of the same morphology and size were placed on each plate. Each treatment was repeated 4 times. The plates were covered with baskets that promoted good ventilation and prevented the snails from escaping. The treatments were carried out in late afternoon.

Treatment effects were observed in the following periods after treatment: 1 hour, 3 hours, 24 hours, 48 hours, 5 days and 7 days. The behavior of snails in contact with the products as well as the mortality of the snails were recorded and interpreted. The data on the mortality of snails to 5 days after application of the products were statistically analyzed using the R software version 3.0.1. The separation of averages for significant effects was made using the Newman-Keuls test at 5% significant level.

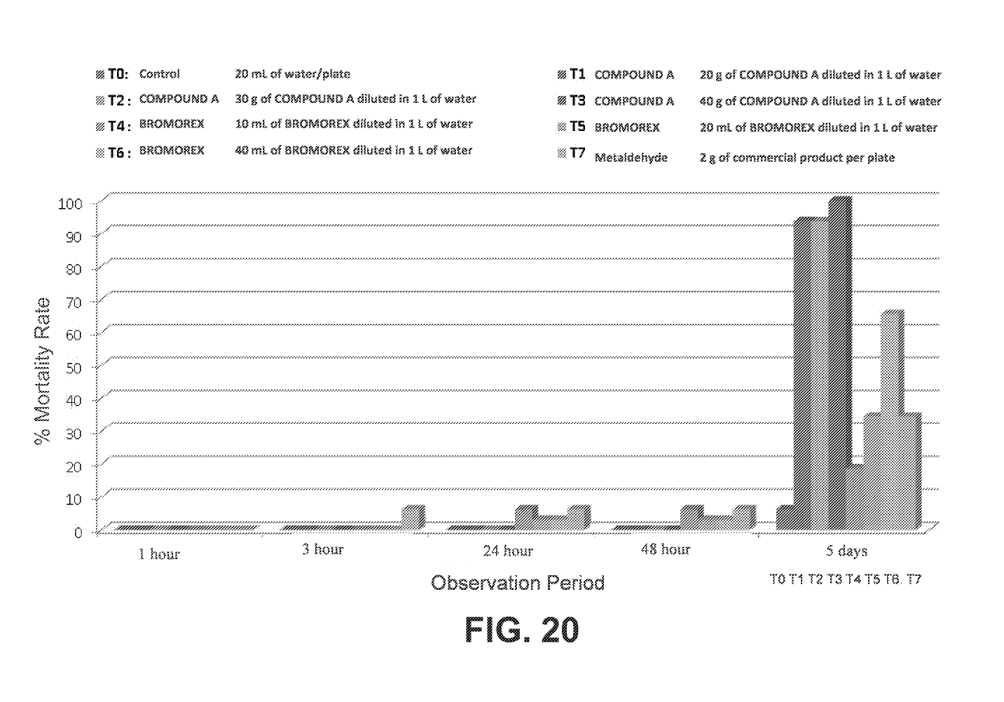

The results are shown in FIG. 20. After one hour of any treatment, the snails at first tended to move away from the products and clinged to the basket that served as a cover. Forty eight hours later the trend was reversed. Most snails, especially those treated with Compound A, were found at the bottom of the plate. Snails under control conditions consumed leaves and slices of banana that were in the plate. Up to 48 hours, no dead snails were recorded on treatments based on Compound A, and visible signs of consumption of bananas and leaves was negligible compared to the other treatments. This behavior was probably due to the antipalatable nature of Compound A. Note that up to 48 hours after treatment, there were no records of dead snails regardless of the concentrations of Compound A used. In contrast, there was a 6.25% mortality rate for snails treated with metaldehyde only 3 hours after treatment. The effect of BROMOREX® 9.37 EC, although relatively low (mortality rates of 3.12%, 3.12%, and 6.25% for the three concentrations used) were visible from 24 hours. The rates of dead snails for treatments with Compound A were observed from the 5^{th} day, and they were 93.75%, 93.75%, and 100%, for samples T1, T2, and T3, respectively. The mortality rate after 5 days for the controls was just 6%. After 5 days, the highest mortality rate for BROMOREX®-treated snails (T6, 65%) and for snails treated with metaldehyde (T7, 34%) was significantly lower than the mortality rate observed with snails treated with Compound A (T3, 100%).

### Example 8

### Toxicity and Feeding Supression of Molluscicide Compositions Comprising Caffeine and Sapindus saponaria Extracts in Multiple Experimental Systems

The toxicity and feeding suppression of molluscicide compositions disclosed herein, and in particular Compounds A and B, was evaluated in multiple plants systems, formulations, methods of administration, and target mollusks. Compound A contained 33.0% caffeine extract, 61.2% calcium lignosulphonate, 3.0% carboxymethyl cellulose, 2.0% sodium chloride and 0.5% Sapindus saponaria extract. Compound B contained 32.5% caffeine extract, 59.8% calcium lignosulphonate, 2.9% carboxymethyl cellulose, 2.4% sodium chloride and 2.3% Sapindus saponaria extract.

(1) Evaluation of the Relative Palatability and Toxicity when Incorporated into Standard Tests Baits:

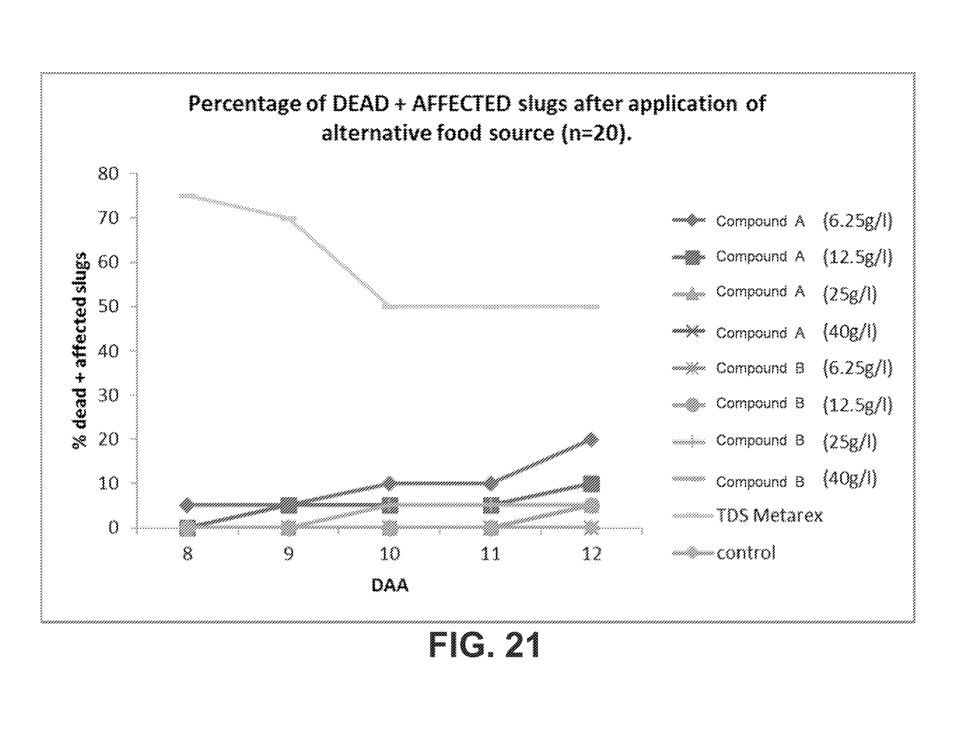

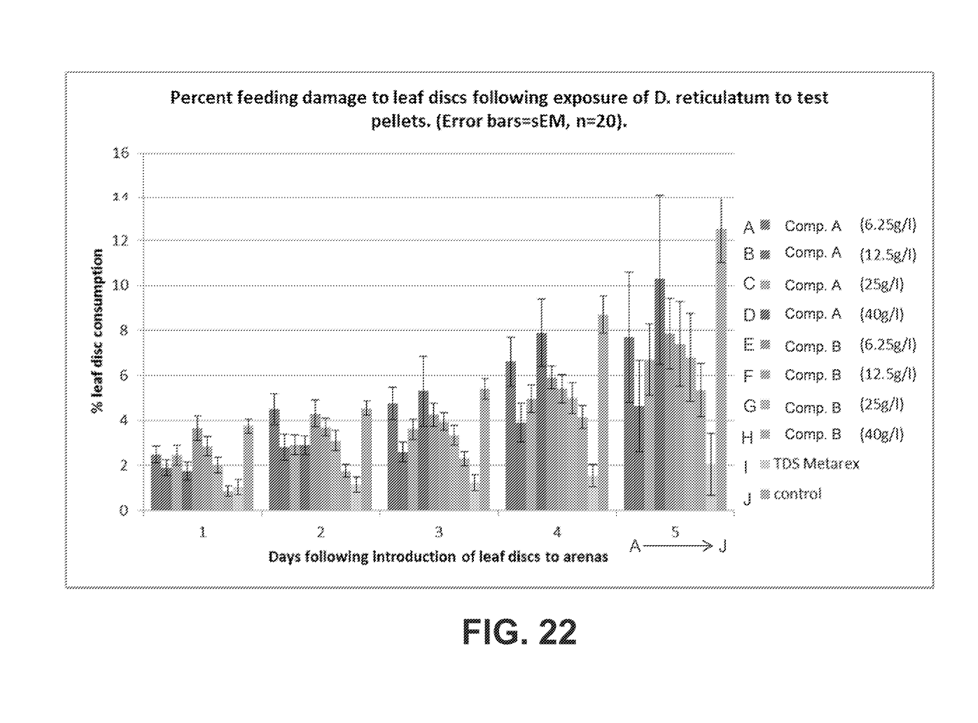

FIG. 21 shows the percentage of dead and affected slugs after application of alternative food source (bait pellets) containing Compound A, Compound B, or metarex. FIG. 22 shows the percentage of feeding damage to leaf disks following exposure of D. reticulatum to test pellets containing Compound A, Compound B, or METAREX®. In terms of bait consumption, the results showed that inclusion of either Compound A or Compound B to test pellets at a concentration of 0.25 g/L or higher induced strong antifeedant effects which suppressed consumption of the test pellet. The lowest consumption of test pellet was recorded for the formulated reference pellet (TDS METAREX® Amba). This was probably due to the mode of action of metadehyde, in that ingestion of the product can lead to immediate symptoms of poisoning in the form of excess mucus production and paralysis, including paralysis of mouthparts.

(2) Compound A as a Slug Feeding Suppressant:

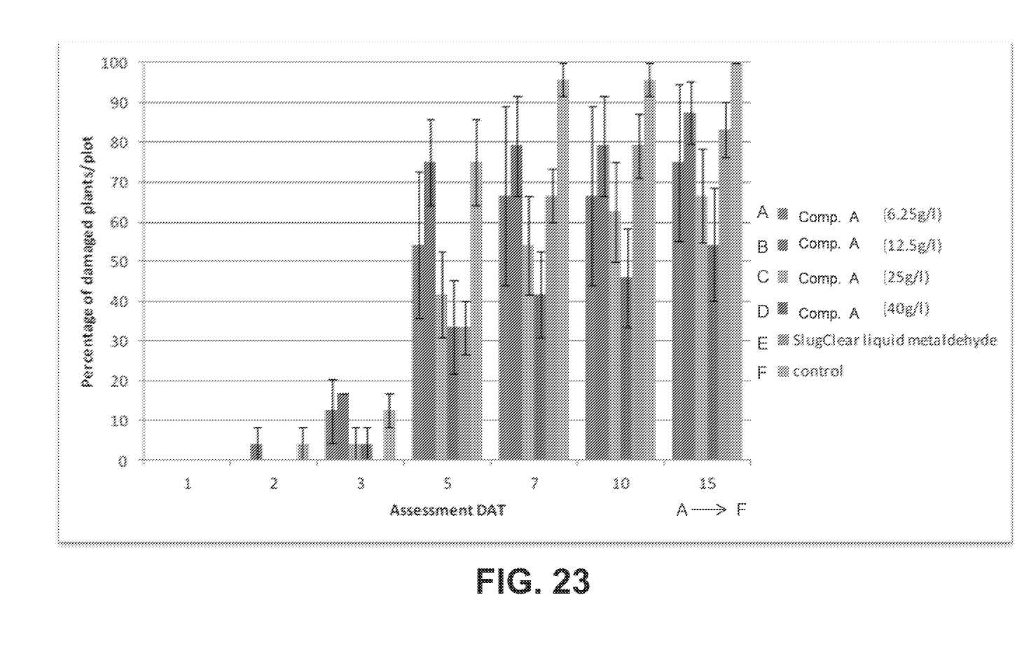

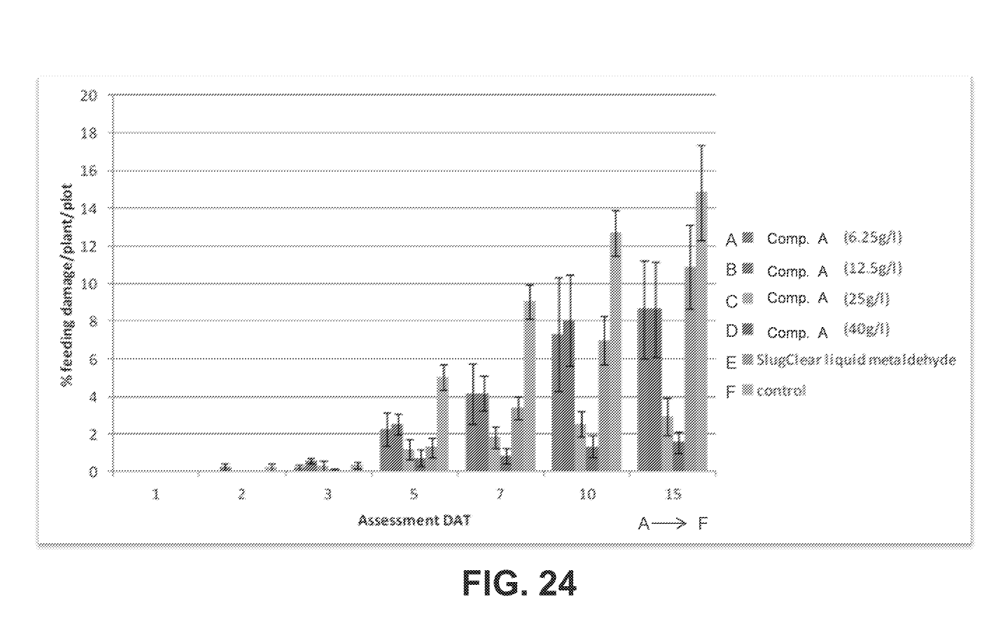

FIG. 23 shows the percentage of damaged plants after slugs were fed Compound A at 4 different concentrations (6.5 g/L, 12.5 g/L. 25 g/L, and 40 g/L). The plants (Lactuca sativa lettuce seedlings) were kept in rigid caged arenas. FIG. 24 shows the mean percentage feeding damage per plant per plot using the same experimental system used in FIG. 23, i.e., the same concentrations of Compound A, and the same rigid caged arena system with lettuce seedlings.

TABLE 26 shows individual one-way ANOVA's on the average percentage feeding damage per plant by slugs using Tukey HSD test (mean values followed by the same letter do not significantly differ, P=0.05, Tukey Kramer HSD)

| Treatment | DAT1 | DAT2 | DAT3 | DAT5 | DAT7 | DAT10 | DAT15 |
|---|---|---|---|---|---|---|---|
| Compound A (6.25 g/l) | 0.0a | 0.0a | 0.2a | 2.3ab | 4.1b | 7.3ab | 8.6ab |
| Compound A (12.5 g/l) | 0.0a | 0.2a | 0.6a | 2.5b | 4.2b | 8.0ab | 8.6ab |
| Compound A (25 g/l) | 0.0a | 0.0a | 0.3a | 1.2b | 1.8b | 2.5b | 2.9b |
| Compound A (40 g/l) | 0.0a | 0.0a | 0.1a | 0.7b | 0.8b | 1.3b | 1.5b |
| Slugclear | 0.0a | 0.0a | 0.0a | 1.3b | 3.4b | 7.0ab | 10.8ab |
| Untreated Control | 0.0a | 0.2a | 0.3a | 5.0a | 9.0a | 12.7a | 14.8a |
| Standard Deviation | * | 0.2406 | 0.3368 | 1.214 | 1.841 | 3.550 | 4.164 |
| P (Bartlett's X²) | * | 1.000 | 0.401 | 0.891 | 0.279 | 0.060 | 0.197 |
| Transformation | | | | | | | |
| Treatment F | * | 0.8 | 1.49 | 6.55 | 9.55 | 5.36 | 5.69 |
| Treatment Prob (F) | * | >0.05 | >0.05 | <0.001 | <0.001 | <0.005 | <0.005 |

A significant effect of treatment was observed 5 days following treatment application with all treatments. From DAT (Day After Treatment) 10 through the end of the trial (DAT 15), Compound A treatments delivered at an application rate of 25 g/L or higher were shown to provide continued crop protection when compared to the untreated control.

(3) Relative Toxicity of Compound A Against Pomacea Spp.:

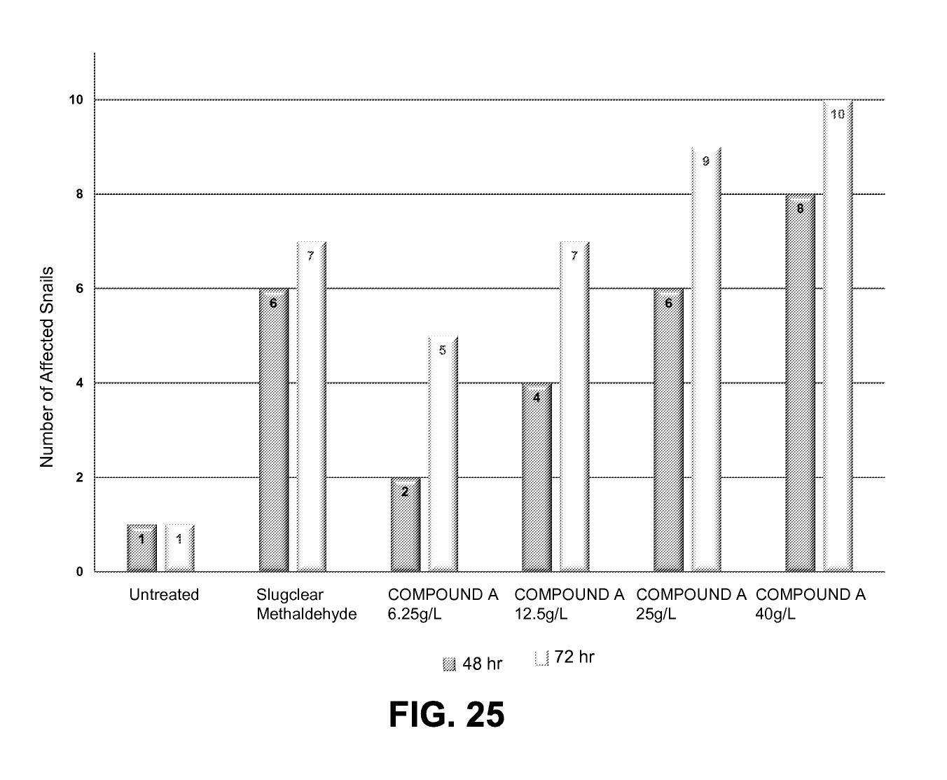

FIG. 25 shows the effect (measured as number of affected/dead snails) when snails were treated with Compound A at four different concentrations (6.5 g/L, 12.5 g/L, 25 g/L, and 40 g/L). A dose response was observed, with a higher effect 72 h after treatment compared to 48 h after treatment.

(4) Compound A Slug Control on Alstroemeria:

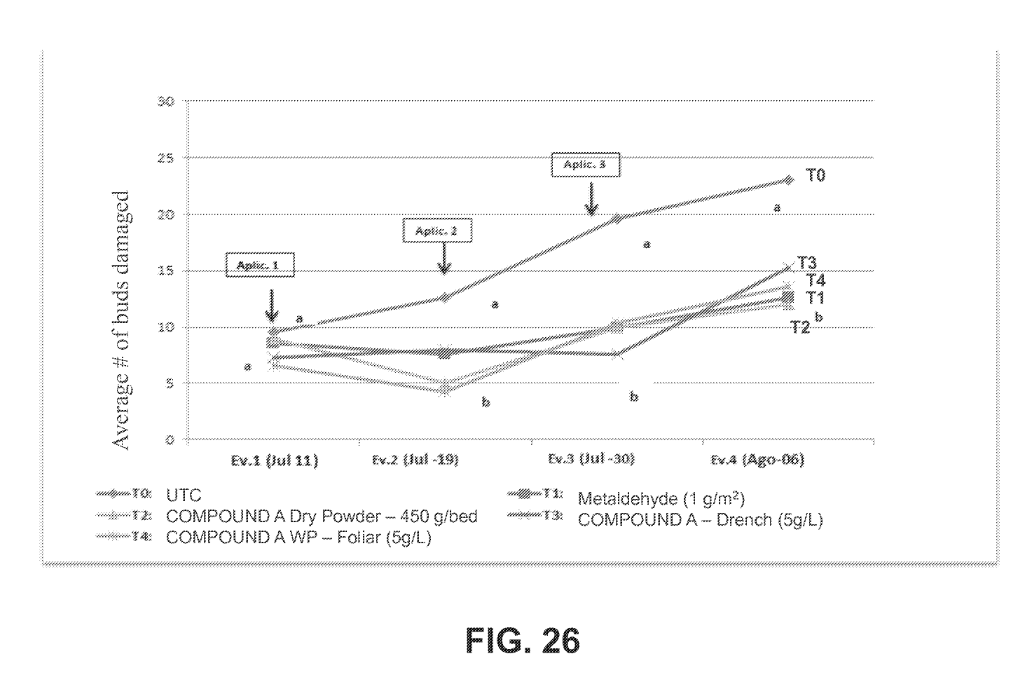

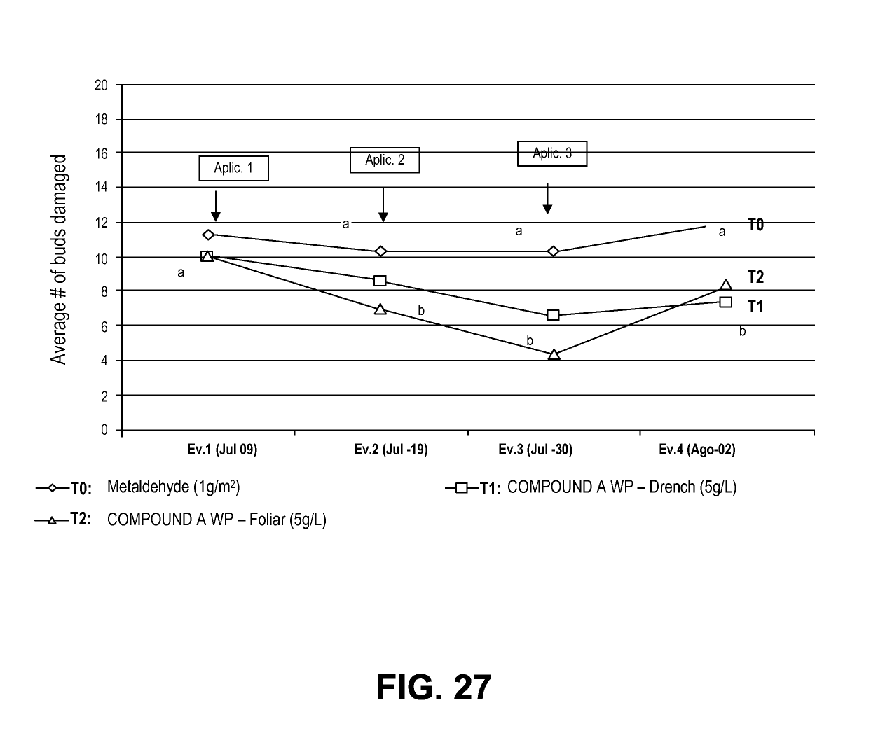

FIG. 26 shows the treatment of Alstroemeria with Compound A using three different methods (i) application of dry powder at 450 g/bed, (ii) WP (wettable powder) foliar spray application at 5 g/L, and (iii) WP drench application at 5 g/L. The average pest incidence per treatment (numbers of bugs damaged) was similar for the 3 treatment strategies. FIG. 27 shows also the effects of the treatments of Alstroemeria using the same experimental conditions used in FIG. 26, but one WP foliar and WP drench applications. Again, it shows that a lower number of seeds was damaged when plants were treated with Compound A.

(5) Compound A Control of Slugs on Lettuce:

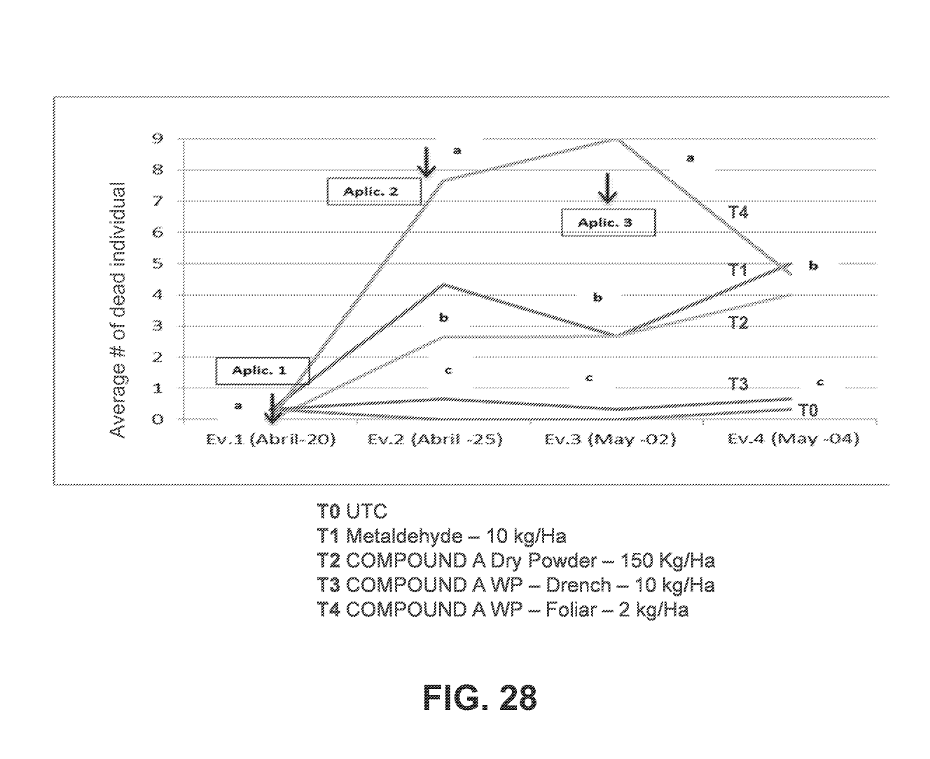

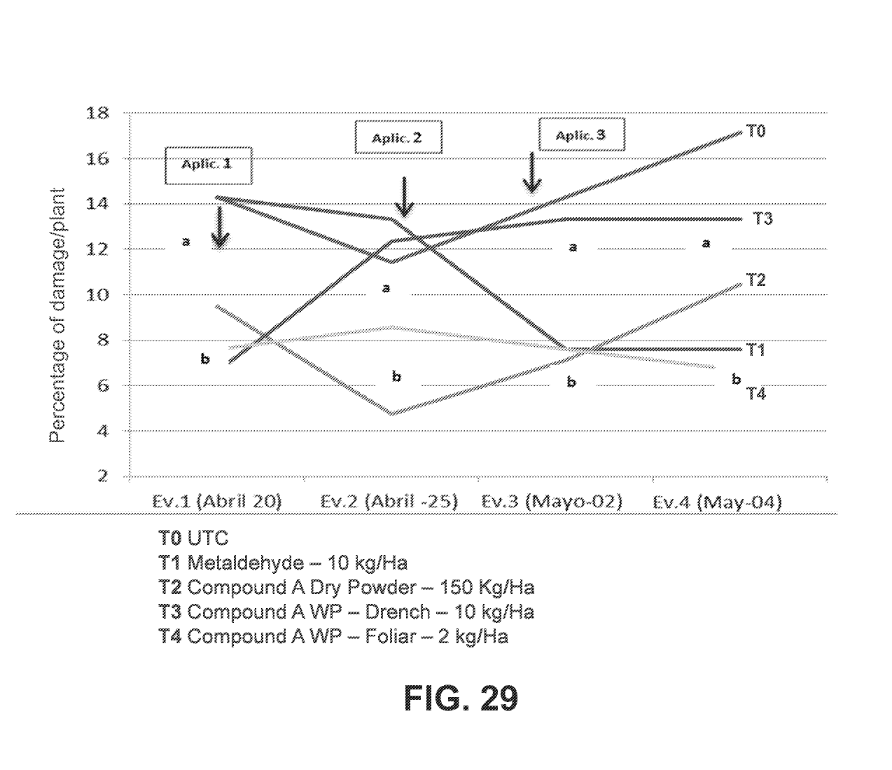

FIG. 28 shows the average number of dead individual slugs after foliar and drench application of Compound A in dry powder or wettable powder (WP) form. Dry power applications were conducted at 150 kg/Ha. WP drench applications were conducted at 10 kg/Ha. WP foliar applications were conducted at 2 kg/Ha. FIG. 29 shows the percentage of damage per plant caused by slugs using the same experimental conditions described for FIG. 28. Compound A application increased slug mortality and decreased the amount of damage to plants compared to control conditions.

It is to be appreciated that the Detailed Description section, and not the Summary and Abstract sections, is intended to be used to interpret the claims. The Summary and Abstract sections sets forth one or more but not all exemplary aspects of the present disclosure as contemplated by the inventor(s), and thus, are not intended to limit the present disclosure and the appended claims in any way.

The present disclosure has been described above with the aid of functional building blocks illustrating the implementation of specified functions and relationships thereof. The boundaries of these functional building blocks have been arbitrarily defined herein for the convenience of the description. Alternate boundaries can be defined so long as the specified functions and relationships thereof are appropriately performed.

The foregoing description of the specific aspects will so fully reveal the general nature of the disclosure that others can, by applying knowledge within the skill of the art, readily modify and/or adapt for various applications such specific aspects, without undue experimentation, without departing from the general concept of the present disclosure. Therefore, such adaptations and modifications are intended to be within the meaning and range of equivalents of the disclosed aspects, based on the teaching and guidance presented herein. It is to be understood that the phraseology or terminology herein is for the purpose of description and not of limitation, such that the terminology or phraseology of the present specification is to be interpreted by the skilled artisan in light of the teachings and guidance.

The breadth and scope of the present disclosure should not be limited by any of the above-described exemplary aspects, but should be defined only in accordance with the following claims and their equivalents.

What is claimed is:

1. A molluscicide composition comprising a saponin-containing plant extract and a caffeine-containing plant extract from a different plant, wherein the saponin-containing plant extract and a caffeine-containing plant extract act synergistically as molluscicides.

2. The composition according to claim 1, wherein the member of the genus Sapindus is Sapindus saponaria.

3. The composition according to claim 1, wherein the caffeine-containing plant extract is obtained from a coffee bean plant, a tea plant, a yerba mate plant, a cacao plant, a kola nut plant, a guarana plant, a guayusa plant, a yaupon holly plant, or a combination thereof.

4. The composition according to claim 1, wherein the saponin-containing plant extract and the caffeine-containing plant extract are in solid form.

5. The composition according to claim 4, wherein the solid form comprises powder, pellet or granule formulations.

6. The composition according to claim 1, wherein the saponin-containing plant extract and the caffeine-containing plant extract are in liquid form.

7. The composition according to claim 6, wherein the liquid form comprises liquid concentrate, emulsifiable concentrate, emulsion, suspension, liquid flowable, gel, ready-to-use, or aerosol formulations.

8. The composition according to claim 1, wherein the molluscicide composition comprises (A) a saponin-containing plant extract and (B) a caffeine-containing plant extract in a weight ratio of (A):(B) between 20:1 to 1:20.

9. A method for controlling or preventing mollusk infestation and/or mollusk damage to plants, comprising treating the plants or the locus surrounding the plants with a molluscicidally effective amount of a molluscicide composition comprising a saponin-containing plant extract and a caffeine-containing plant extract from a different plant, wherein the saponin-containing plant extract and a caffeine-containing plant extract act synergistically as molluscicides.

10. The method according to claim 9, wherein the gastropods are from the subclass Pulmonata.

11. A method to treat a surface to prevent mollusk infestation with a molluscicidally effective amount of the molluscicide composition comprising a saponin-containing plant extract and a caffeine-containing plant extract from a different plant, wherein the saponin-containing plant extract and a caffeine-containing plant extract act synergistically as molluscicides.

12. The method according to claim 12, wherein the surface is in an agricultural, a horticultural, a garden, or an aquatic environment.

13. The method according to claim 11, further comprising a dose regimen.

14. The method according to claim 13, wherein the dose regimen comprises at least one daily dose.

15. The method according to claim 14, wherein the dose regimen comprises at least one weekly dose.

16. The method according to claim 11, wherein the molluscicide composition concentration is between about 0.1 grams/liter to about 15 grams/liter of saponin-containing plant extract and a concentration between about 0.1 grams/liter to about 15 grams/liter of caffeine-containing plant extract.

17. The method according to claim 16, wherein the molluscicide composition has a concentration of about 7 grams/liter of saponin-containing plant extract and a concentration of about 7 grams/liter of caffeine-containing plant extract.

18. The method according to claim 11, wherein the molluscicide composition comprises (A) a saponin-containing plant extract and (B) a caffeine-containing plant extract in a weight ratio of (A):(B) between 20:1 to 1:20.

19. The method according to claim 11, wherein the molluscicide composition comprises (A) a saponin-containing plant extract and (B) a caffeine-containing plant extract in a weight ratio of (A):(B) between 15:1 to 1:15.

20. The method according to claim 11, wherein the molluscicide composition comprises (A) a saponin-containing plant extract and (B) a caffeine-containing plant extract in a weight ratio of (A):(B) about 1:14.
